(19) United States
(12) Patent Application Publication
(10) Pub. No.: US 2025/0277699 A1
(43) Pub. Date: Sep. 4, 2025

(54) RAMAN SPECTROSCOPY SYSTEM WITH BALANCED DETECTION

(71) Applicant: Haemanthus, Inc., Austin, TX (US)

(72) Inventors: Joseph G. LaChapelle, Philomath, OR (US); Roger S. Cannon, Oviedo, FL (US)

(21) Appl. No.: 18/774,723

(22) Filed: Jul. 16, 2024

Related U.S. Application Data
(63) Continuation-in-part of application No. 18/762,412, filed on Jul. 2, 2024, now Pat. No. 12,203,862.
(60) Provisional application No. 63/560,521, filed on Mar. 1, 2024.

(51) Int. Cl. G01J 3/02; G01J 3/10; G01J 3/44

(52) U.S. Cl. CPC G01J 3/0275; G01J 3/0213; G01J 3/0216; G01J 3/0245; G01J 3/10; G01J 3/4412; G01J 2003/102

(57) ABSTRACT

In one embodiment, a system includes a pump light source configured to produce a pump beam of light at a pump frequency, and a Stokes light source configured to produce: (i) a Stokes beam of light at a Stokes frequency, where the pump and Stokes frequencies are offset by a frequency offset Ω and (ii) a Stokes reference beam of light. The system also includes one or more optical elements configured to: direct the pump and Stokes beams of light to a sample, and collect (i) a Raman signal produced by the sample in response to the pump and Stokes beams of light and (ii) residual light from the Stokes beam of light after the Stokes beam of light has interacted with the sample. The system further includes an optical receiver configured to detect the Raman signal, where the optical receiver includes a probe light source.

### CROSS-REFERENCE TO RELATED APPLICATIONS

This application is a continuation-in-part of U.S. patent application Ser. No. 18/762,412, filed 2 Jul. 2024, which claims the benefit, under 35 U.S.C. § 119(e), of U.S. Provisional Patent Application No. 63/560,521, filed 1 Mar. 2024, the entireties of which are incorporated by reference herein.

### TECHNICAL FIELD

This disclosure generally relates to Raman spectroscopy systems and methods that use Raman scattering.

### BACKGROUND

Raman spectroscopy is an optical measurement technique that can be applied to the study of molecular dynamics (e.g., to investigate vibrational and rotational states of molecules). Molecules typically exhibit molecular vibrations with frequencies ranging from less than 10 terahertz (THz) to approximately 100 THz, which corresponds to wavenumbers of approximately 300 cm⁻¹ to 3000 cm⁻¹ and wavelengths of approximately 30 to 3 micrometers (μm). Raman spectroscopy is based on the inelastic scattering of photons (referred to as Raman scattering) that occurs when light interacts with molecular vibrations or phonons in a sample. Raman scattering causes the energy (or equivalently, the frequency) of scattered light to be shifted, and this shift in energy can provide information about the vibrational modes of molecules in the sample.

Raman spectroscopy can be used in various chemical sensing applications to identify molecular components in a sample. Since many molecules exhibit a unique Raman scattering spectrum, the spectrum of Raman-scattered light produced when light interacts with a sample can serve as a fingerprint to sense or identify various molecular species within the sample. A sample illuminated with light may produce Raman scattered light at different wavelengths from the illumination light, and measurement of the spectrum of the Raman scattered light is typically performed in the optical domain. For example, the spectrum of Raman scattered light can be measured using an optical spectrometer which separates the Raman scattered light into its optical frequency components using a diffractive element, such as a diffraction grating.

### BRIEF DESCRIPTION OF THE DRAWINGS

FIGS. 1-2 each illustrates an example Raman spectroscopy system.

FIGS. 3-4 each illustrates an example Raman signal produced by coherent Raman scattering.

FIG. 5 illustrates the example Raman signal of FIG. 4 along with a probe beam.

FIG. 6 illustrates an expanded view of a portion of the Raman signal of FIG. 5.

FIG. 7 illustrates an expanded view of a portion of the Raman signal of FIG. 6.

FIGS. 8-10 illustrate time-domain and frequency-domain plots of an example electronic signal resulting from coherent mixing of the Raman signal and probe beam of FIG. 7.

FIG. 11 illustrates an example Raman signal that is measured at multiple probe frequencies.

FIG. 12 illustrates an example Raman spectrum corresponding to the Raman signal of FIG. 11.

FIG. 13 illustrates another example Raman signal that is measured at multiple probe frequencies.

FIGS. 14-15 each illustrates a second example Raman signal obtained by changing the frequency offset between a pump beam and a Stokes beam.

FIG. 16 illustrates an example Raman signal along with two probe beams of light.

FIG. 17 illustrates an example optical receiver for measuring the Raman signal and pump beam of light from FIG. 16.

FIG. 18 illustrates an example Raman spectroscopy system for measuring a Raman signal produced by spontaneous Raman scattering.

FIG. 19 illustrates an example Raman signal produced by the Raman spectroscopy system of FIG. 18.

FIG. 20 illustrates an example laser diode that produces a free-space beam of light.

FIG. 21 illustrates an example laser diode that produces seed light that is amplified by a semiconductor optical amplifier (SOA).

FIG. 22 illustrates an example laser diode that produces seed light that is amplified by a fiber-optic amplifier.

FIG. 23 illustrates an example sampled-grating distributed Bragg reflector (SG-DBR) laser.

FIG. 24 illustrates an example light source with multiple laser diodes and an optical multiplexer that combines light produced by the laser diodes into a single output beam of light.

FIG. 25 illustrates an example pump laser and Stokes laser with a fiber-optic combiner that produces a combined pump-Stokes beam coupled into an optical fiber.

FIG. 26 illustrates an example laser diode coupled to a waveguide of a photonic integrated circuit (PIC).

FIG. 27 illustrates an example pump laser and Stokes laser with a photonic integrated circuit (PIC) that produces a combined pump-Stokes beam coupled into an optical waveguide of the PIC.

FIG. 28 illustrates an example fiber-optic combiner that combines a Raman signal with a probe beam.

FIG. 29 illustrates an example photonic integrated circuit (PIC) with a waveguide combiner that combines a Raman signal with a probe beam.

FIGS. 30-35 each illustrates example frequency ranges of a pump beam and a Stokes beam.

FIG. 36 illustrates an example optical receiver with two detectors.

FIG. 37 illustrates an example optical receiver configured for polarization-sensitive detection of a Raman signal.

FIG. 38 illustrates an example optical receiver configured to detect in-phase and quadrature components of a Raman signal.

FIG. 39 illustrates an example optical receiver configured to detect polarization as well as in-phase and quadrature components of a Raman signal.

FIG. 40 illustrates an example Raman spectroscopy system with balanced detection.

FIG. 41 illustrates an example light source with an optical splitter that produces an output beam and a reference beam.

FIG. 42 illustrates an example reference beam that is emitted from the back facet of a laser diode.

FIGS. 43-45 each illustrates an example optical receiver of a Raman spectroscopy system with balanced detection.

FIG. 46 illustrates the example Raman spectroscopy system of FIG. 40 operating in a calibration mode.

FIGS. 47-48 illustrate example plots of optical power, photocurrent, and voltage before (FIG. 47) and after (FIG. 48) an amplitude calibration has been performed.

FIGS. 49-50 illustrate example plots of optical power, photocurrent, and voltage before (FIG. 49) and after (FIG. 50) a temporal calibration has been performed.

FIG. 51 illustrates example signals produced by an optical receiver without balanced detection.

FIGS. 52-53 illustrate example signals produced by an optical receiver with balanced detection before (FIG. 52) and after (FIG. 53) a calibration has been performed.

FIG. 54 illustrates an example optical receiver of a Raman spectroscopy system with balanced detection and configured for polarization-sensitive detection of a Raman signal.

FIG. 55 illustrates an example method for measuring a Raman signal.

FIG. 56 illustrates an example method for measuring a Raman signal using balanced detection.

FIG. 57 illustrates an example method for performing an amplitude calibration.

FIG. 58 illustrates an example method for performing a temporal calibration.

FIG. 59 illustrates an example computer system.

### DETAILED DESCRIPTION

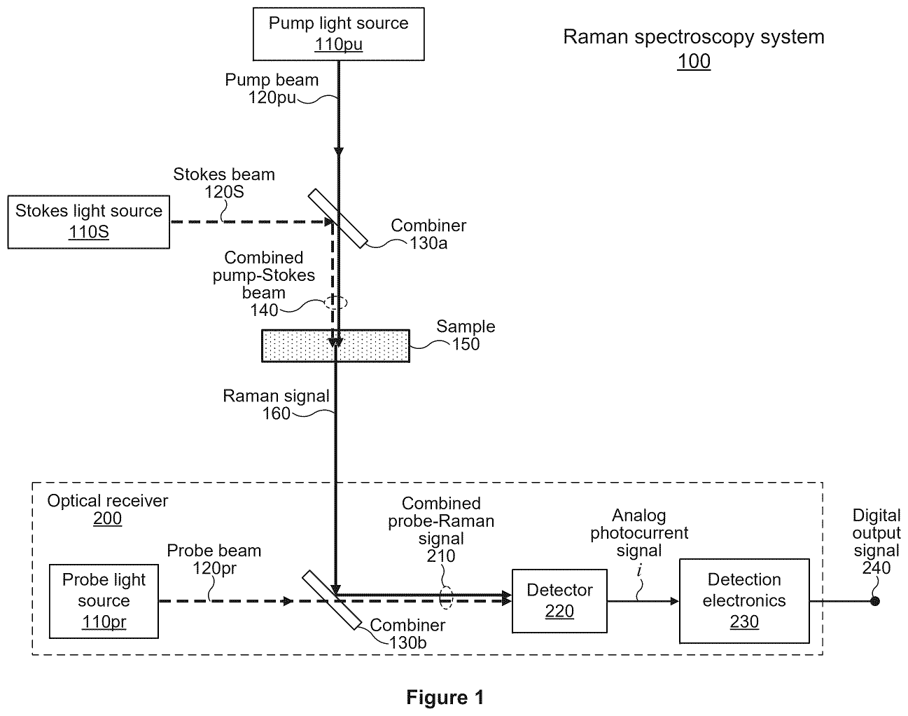

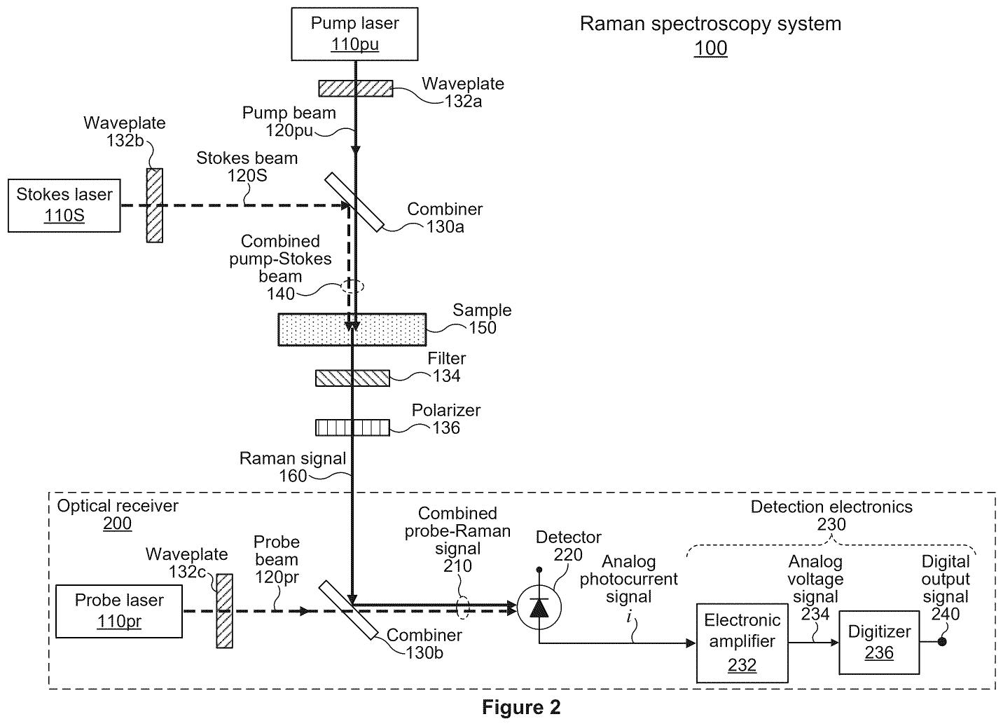

FIGS. 1-2 each illustrates an example Raman spectroscopy system 100. The Raman spectroscopy system 100 in each of FIGS. 1-2 may detect a Raman signal 160 by coherently mixing the Raman signal 160 with a probe beam of light 120pr produced by a probe light source 110pr. The Raman spectroscopy system 100 in each of FIGS. 1-2 may be referred to as a coherent Raman spectroscopy system, a coherent Raman spectroscopy system with heterodyne detection, or a high-resolution coherent Raman spectroscopy system. One or more of the systems or methods described herein may be applied to any suitable form of coherent Raman spectroscopy or coherent Raman scattering (CRS), such as for example, coherent anti-Stokes Raman scattering (CARS), stimulated Raman scattering (SRS), or Raman-induced Kerr effect (RIKE).

The Raman spectroscopy system 100 in FIG. 1 includes a pump light source 110pu that produces a pump beam of light 120pu and a Stokes light source 110S that produces a Stokes beam of light 120S. The pump light source 110pu produces the pump beam of light 120pu at a pump frequency, which may be referred to as a first frequency and may be represented by v₁, vₚᵤ, ω₁, or ωₚᵤ. The pump light source 110pu may be referred to as a first light source, and the pump beam of light 120pu may be referred to as a first beam of light. The Stokes light source 110S produces the Stokes beam of light 120S at a Stokes frequency, which may be referred to as a second frequency and may be represented by v₂, v_{S}, ω₂, or ω_{S}. The Stokes light source 110S may be referred to as a second light source, and the Stokes beam of light 120S may be referred to as a second beam of light. The pump and Stokes frequencies may be offset by a frequency offset Ω, where Ω equals vₚᵤ−v_{S} (or equivalently, Ω=v₁−v₂). Generally, the pump frequency vₚᵤ is greater than the Stokes frequency v_{S}, and the frequency offset Ω is a positive value. The pump and Stokes light sources in FIG. 1 may each include a laser. For example, the Raman spectroscopy system 100 in FIG. 2 includes a pump laser 110pu that produces a pump beam of light 120pu and a Stokes laser 110S that produces a Stokes beam of light 120S.

In FIGS. 1-2, the pump beam 120pu and the Stokes beam 120S are directed to a sample 150, and the sample 150 produces a Raman signal 160 in response to the pump and Stokes beams. For example, the Raman signal 160 may be produced by coherent Raman scattering of the pump and Stokes beams within the sample 150. A Raman spectroscopy system may include one or more optical elements that direct the pump beam 120pu and the Stokes beam 120S to a sample 150. Additionally, the optical elements may collect the Raman signal 160 produced by the sample 150 in response to the pump beam 120pu and Stokes beam 120S and may direct the Raman signal 160 to an optical receiver 200. The optical elements may include free-space optics, fiber-optic components, waveguide-based optics, metamaterials, or any combination thereof. For example, the optical elements may include a mirror, lens, optical combiner (e.g., beamsplitter), optical fiber, photonic integrated circuit (PIC), optical waveguide, or metamaterial-based optic. As another example, the optical combiner 130a in each of FIGS. 1-2 may be a free-space dichroic beamsplitter that transmits light at the pump-beam wavelength and reflects light at the Stokes-beam wavelength. The combiner 130a may combine the pump beam 120pu and the Stokes beam 120S to produce a combined pump-Stokes beam 140 that is directed to the sample 150. The pump and Stokes beams may be combined so that they are substantially overlapped with one another and propagate in the same direction along approximately the same optical axis. Alternatively, a Raman spectroscopy system 100 may not include a pump-Stokes optical combiner 130a, and the pump beam 120pu and the Stokes beam 120S may be directed to a sample 150 as separate beams (e.g., the pump and Stokes beams may be overlapped or combined at the sample rather than being combined earlier). In this embodiment, the pump and Stokes beams may enter the sample 150 from opposite sides (e.g., the pump and Stokes beams may propagate to the sample in opposite directions along approximately the same optical axis). As another example, the optical elements may include a lens (not illustrated in FIGS. 1-2) that focuses the pump-Stokes beam 140 onto the sample 150. Additionally, the optical elements may include a lens (not illustrated in FIGS. 1-2) that collects the Raman signal 160 to produce a Raman-signal beam that is directed to the optical receiver 200.

In FIGS. 1-2 the combined pump-Stokes beam 140 is directed to one side of the sample 150, and the Raman signal 160 is emitted from the opposite side of the sample. A Raman signal 160 that is collected and directed to an optical receiver 200 may be emitted from a sample 150 in any suitable direction. For example, a Raman signal 160 that is sent to an optical receiver 200 may be emitted from a sample 150 in a forward-scattered direction (e.g., as illustrated in FIGS. 1-2), in a backward-scattered direction (e.g., back towards the pump or Stokes beam), or in a sideways-scattered direction (e.g., in a direction approximately orthogonal to the combined pump-Stokes beam 140 in FIGS. 1-2).

The Raman spectroscopy system 100 in each of FIGS. 1-2 includes an optical receiver 200 that detects the Raman signal 160 produced by the sample 150. The optical receiver 200 (which may be referred to as a heterodyne optical receiver or a high-resolution optical receiver) may detect the Raman signal 160 using an optical heterodyne technique in which the Raman signal 160 is coherently mixed with a probe beam of light 120pr. The optical receiver 200 in FIG. 1 includes a probe light source 110pr that produces a probe beam of light 120pr at a probe frequency. The probe light source 110pr may be referred to as a third light source, and the probe beam of light 120pr may be referred to as a third beam of light. The probe frequency may be referred to as a third frequency and may be represented by v₃, vₚᵣ, ω₃, or ωₚᵣ. The probe light source 110pr in FIG. 1 may include a laser. For example, the optical receiver 200 in FIG. 2 includes a probe laser 110pr that produces a probe beam of light 120pr.

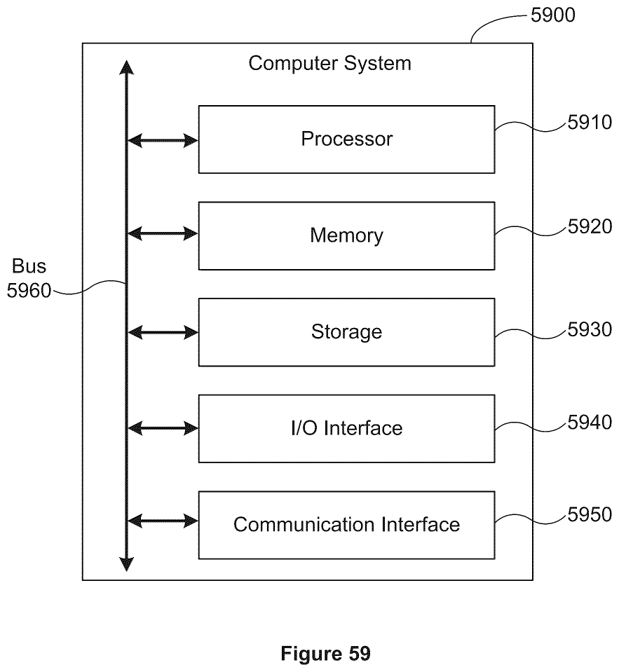

The optical combiner 130b in each of FIGS. 1-2 may be a dichroic or a non-dichroic beamsplitter that combines the Raman signal 160 and the probe beam 120pr to produce a combined probe-Raman signal 210 that is directed to a detector 220. An optical receiver 200 may include one or more optical detectors 220, where each detector is configured to coherently mix a portion of a Raman signal 160 with at least a portion of a probe beam 120pr to produce an electronic signal. Each of the optical receivers 200 in FIGS. 1-2 includes one detector 220 that receives the combined probe-Raman signal 210. The Raman signal 160 and the probe beam 120pr are coherently mixed at the detector 220, and this heterodyne mixing process produces an electronic signal, which in FIGS. 1-2 is indicated as analog photocurrent signal i. In FIGS. 1-2, the detection electronics 230 receives the photocurrent signal i and produces a digital output signal 240 that corresponds to the photocurrent signal. The digital output signal 240 may be sent to a processor, and the processor may determine a characteristic of the analog photocurrent signal i based on the digital output signal 240. For example, the characteristic of the analog photocurrent signal (or the characteristic of an analog voltage signal that corresponds to the photocurrent signal) determined by the processor may include one or more of: a peak amplitude, an average amplitude, an amplitude at a particular frequency, an amplitude at a particular time, an amplitude at a frequency center, an amplitude at a temporal center, an area, a frequency, a phase, and a polarization. An analog photocurrent signal may be referred to as a photocurrent, a photocurrent signal, or a current signal, and an analog voltage signal may be referred to as a voltage signal. A processor of a Raman spectroscopy system 100 may include or may be referred to as a computer system, a controller, a computing device, a computing system, a computer, or a data-processing apparatus. A processor may be similar to the computer system 5900 illustrated in FIG. 59 and described herein.

In FIGS. 1-2, the probe beam 120pr does not travel through the sample 150, and the probe beam is combined with the Raman signal 160 after the Raman signal has exited the sample 150. In other embodiments, a Raman spectroscopy system 100 may include a probe laser 110pr that produces a probe beam 120pr that is directed through the sample 150. For example, the probe beam 120pr may be combined with the pump beam 120pu and the Stokes beam 120S, and all three beams may be directed to the sample 150. The probe beam 120pr may travel through the sample 150 and may exit the sample along with the Raman signal 160. The optical receiver 200 may not include a combiner 130b, since the probe beam 120pr and the Raman signal 160 may already be combined after they exit the sample 150. The probe beam 120pr and the Raman signal 160 may be directed to a detector 220 without being transmitted or reflected by an optical combiner 130b.

The detection electronics 230 in FIG. 2 includes an electronic amplifier 232 and a digitizer 236. The electronic amplifier 232 may include a transimpedance amplifier that amplifies the photocurrent signal i to produce an analog voltage signal 234 that corresponds to the photocurrent signal i (e.g., the photocurrent signal i and the analog voltage signal 234 may have similar temporal shapes or may include similar electronic frequency components). The electronic amplifier 232 may include an additional gain stage that further amplifies an intermediate voltage signal produced by the transimpedance amplifier to produce the voltage signal 234. Additionally, the electronic amplifier 232 may include an electronic filter (e.g., a low-pass, high-pass, or band-pass filter) that filters the photocurrent signal or voltage signal. For example, the electronic amplifier 232 may include (i) a high-pass filter that removes a DC offset and low-frequency components (e.g., frequency components below 10 MHz) from the photocurrent signal or (ii) a band-pass filter that removes the DC and low-frequency components as well as high-frequency components (e.g., frequency components above 5 GHz). Herein, an electronic signal produced in response to coherent mixing may refer to a current signal (e.g., a photocurrent i produced by a detector 220) or may refer to a corresponding voltage signal (e.g., a voltage signal 234 produced by an electronic amplifier that amplifies a photocurrent produced by a detector to produce the voltage signal). In FIG. 2, the digitizer 236 receives the voltage signal 234 and produces a digital output signal 240 that includes a digital representation of the voltage signal 234. The digital output signal 240 may be a time-domain digital representation of the voltage signal 234. The digital output signal 240 may be referred to as corresponding to or representing the voltage signal 234 or the photocurrent signal i. The digitizer 236 may include an analog-to-digital converter (ADC) that produces a digital version of the voltage signal 234. Additionally or alternatively, the digitizer 236 may include a peak detector that determines a peak value of the voltage signal 234.

A Raman spectroscopy system 100 may include one or more optical detectors 220. An optical detector 220 (which may be referred to as a detector, photodetector, or photodiode) may include a PN photodiode, PIN photodiode, avalanche photodiode (APD), single-photon avalanche diode (SPAD), silicon photomultiplier (SiPM), or photomultiplier tube (PMT). A PN photodiode refers to a photodiode structure formed by a p-doped semiconductor and an n-doped semiconductor, where the PN acronym refers to the structure having p-doped and n-doped regions. A PIN photodiode refers to a photodiode structure formed by an undoped intrinsic semiconductor region located between p-doped and n-doped regions, where the PIN acronym refers to the structure having p-doped, intrinsic, and n-doped regions.

A PN photodiode, PIN photodiode, APD, or SPAD may include any suitable semiconductor material, such as for example: silicon, germanium, gallium arsenide (GaAs), indium phosphide (InP), indium arsenide (InAs), aluminum arsenide (AlAs), indium antimonide (InSb), aluminum antimonide (AlSb), gallium antimonide (GaSb), aluminum gallium arsenide (AlGaAs), indium gallium arsenide (InGaAs), indium aluminum arsenide (InAlAs), indium arsenide antimonide (InAsSb), aluminum arsenide antimonide (AlAsSb), aluminum gallium antimonide (AlGaSb), gallium arsenide antimonide (GaAsSb), aluminum indium arsenide antimonide (AlInAsSb), indium gallium arsenide antimonide (InGaAsSb), indium gallium aluminum arsenide (InGaAlAs), aluminum gallium arsenide antimonide (AlGaAsSb), or silicon germanium (SiGe). For example, the Raman signal 160 and the probe beam 120pr in FIGS. 1-2 may each have a wavelength in the 400-1100 nanometer (nm) range, and the detector 220 may include a silicon PIN photodiode. As another example, the Raman and probe beams in FIGS. 1-2 may each have a wavelength in the 1000-1700 nm range, and the detector 220 may include an InGaAs PIN photodiode. As another example, a detector 220 may include an APD that includes a semiconductor material with antimonide (e.g., InSb, AlSb, GaSb, InAsSb, AlAsSb, AlGaSb, GaAsSb, AlInAsSb, InGaAsSb, or AlGaAsSb).

In order for a detector 220 to detect an optical signal, the wavelength of the optical signal must be within the detector's wavelength range of responsivity (e.g., approximately 400-1100 nm for a silicon detector, and approximately 1000-1700 nm for an InGaAs detector) and a frequency of an amplitude modulation of the optical signal must be within the electronic bandwidth of the detector. The electronic bandwidth (Δf) of a detector 220 refers to the range of electronic modulation frequencies over which a detector may detect an optical signal, where detection of the optical signal refers to (i) the detector producing a photocurrent signal i that corresponds to the optical signal and (ii) an electronic amplifier 232 producing a voltage signal 234 that corresponds to the photocurrent signal. If a silicon detector 220 has an electronic bandwidth that extends from 100 MHz to 5 GHz, then the detector may detect optical signals with (i) wavelengths between approximately 400 nm and 1100 nm and (ii) amplitude modulation between 100 MHz and 5 GHz. For example, a 900-nm optical signal with an amplitude modulation at a frequency between 100 MHz and 5 GHz may be detected by the silicon detector 220. The silicon detector 220 may not detect a continuous-wave or substantially constant portion of a 900-nm optical signal (e.g., the substantially constant portion of the optical signal may produce a DC current in the detector that may be electronically filtered out), and the silicon detector 220 may not detect a portion of the optical signal with an amplitude modulation greater than approximately 5 GHz. Herein, reference to the electronic bandwidth (Δf) of a detector 220 may refer to (i) the electronic bandwidth of just the detector or (ii) the overall bandwidth of the detector in combination with an electronic amplifier 232.

A detector 220 may have an electronic bandwidth Δf between approximately 100 MHz and approximately 50 GHz. For example, the detector 220 in each of FIGS. 1-2 may have an electronic bandwidth between 100 MHz and 10 GHz. As another example, the detector 220 in each of FIGS. 1-2 may have an electronic bandwidth that extends from a low-frequency cutoff to a high-frequency cutoff. The low-frequency cutoff may be approximately DC (i.e., zero hertz), 1 MHz, 10 MHz, 50 MHz, or 100 MHz, and the high-frequency cutoff may be approximately 500 MHz, 1 GHz, 2 GHz, 5 GHz, 10 GHz, 20 GHz, or 50 GHz. The electronic bandwidth of a detector 220 may refer to the bandwidth of only the detector 220. For example, a detector 220 may have an electronic bandwidth that extends from DC to 10 GHz, and the detector may be referred to as having a 10-GHz bandwidth that extends from DC to 10 GHz. Alternatively, the electronic bandwidth of a detector 220 may refer to the overall bandwidth of the detector in combination with an electronic amplifier 232 that amplifies the photocurrent signal i produced by the detector. An electronic amplifier 232 may have a low-frequency cutoff (e.g., DC, 1 MHz, 10 MHz, 50 MHz, or 100 MHz) and a high-frequency cutoff (e.g., 500 MHz, 1 GHz, 2 GHz, 5 GHz, 10 GHz, 20 GHz, or 50 GHz), and a detector-amplifier combination may be referred to as having an electronic bandwidth that extends from the low-frequency cutoff to the high-frequency cutoff. For example, if the detector bandwidth extends from DC to 10 GHz, and the electronic amplifier bandwidth extends from DC to 5 GHz, then the detector (or, the detector-amplifier combination) may be referred to as having an electronic bandwidth of 5 GHz that extends from DC to 5 GHz. As another example, if the detector bandwidth extends from DC to 10 GHz, and the electronic amplifier bandwidth extends from 100 MHz to 5 GHz, then the detector may be referred to as having an electronic bandwidth of 4.9 GHz that extends from 100 MHz to 5 GHz.

A Raman spectroscopy system 100 may include one or more optical waveplates that change or rotate the polarization of a beam of light. For example, a half-wave plate may be used to rotate a linearly polarized beam of light to a different polarization orientation (e.g., from vertically polarized to horizontally polarized), and a quarter-wave plate may be used to convert a linearly polarized beam of light to a circular or elliptical polarization. The pump laser 110pu in FIG. 2 may produce linearly polarized light, and the waveplate 132a may be a half-wave plate that rotates the polarization of the pump beam 120pu prior to the pump beam being directed to the sample 150. Alternatively, the waveplate 132a may be a quarter-wave plate that converts the linearly polarized pump beam 120pu to a circular or elliptical polarization prior to the pump beam being directed to the sample 150. Similarly, the Stokes laser 110S in FIG. 2 may produce linearly polarized light, and the waveplate 132b may be (i) a half-wave plate that rotates the polarization of the Stokes beam 120S or (ii) a quarter-wave plate that converts the Stokes beam 120S to a circular or elliptical polarization.

The probe laser 110pr in FIG. 2 may produce linearly polarized light, and the waveplate 132c may be (i) a half-wave plate that rotates the polarization of the probe beam 120pr or (ii) a quarter-wave plate that converts the probe beam 120pr to a circular or elliptical polarization prior to the probe beam being combined with the Raman signal 160. Changing the polarization of the probe beam 120pr may allow the Raman signal 160 and the probe beam to be coherently mixed. The polarization of the probe beam 120pr can be changed so that it has both horizontal and vertical polarization components, which ensures that at least a portion of the probe beam 120pr and the Raman signal 160 have polarizations that are oriented in the same direction so that their electric fields may be added together.

Each of the optical waveplates 132 in FIG. 2 may be a free-space optical element, a fiber-optic component, a waveguide-based optical element, or a metamaterial-based optic. Additionally, each of the optical waveplates 132 in FIG. 2 may be a fixed waveplate or an adjustable waveplate. A fixed waveplate may have a fixed optical phase difference between the two axes of the waveplate (e.g., a quarter-wave plate may have a one-quarter wavelength phase difference, and a half-wave plate may have a one-half wavelength phase difference). An adjustable waveplate may allow for the phase difference between the two axes of the waveplate to be dynamically changed. For example, an electronically adjustable waveplate may include a Pockels cell, a liquid crystal device, or a photoelastic modulator that allows the phase difference to be adjusted electronically so that the waveplate can be dynamically configured to act as a waveplate having any suitable phase difference (e.g., a phase difference between zero wavelengths and one-half wavelength). An adjustable waveplate may switch between (i) applying no phase difference to incident light so that the transmitted light has the same polarization as the incident light and (ii) applying a one-quarter wavelength or one-half wavelength phase difference so that linearly polarized incident light is converted to circularly polarized light or is rotated to a different polarization. For example, the pump laser 110pu in FIG. 2 may produce vertically polarized light, and the waveplate 132a may be an adjustable waveplate that switches between (i) applying no polarization rotation to the pump beam 120pu so that the pump beam remains vertically polarized and (ii) applying a 90-degree rotation to the pump-beam polarization so that the pump beam 120pu after the waveplate 132a is horizontally polarized. Dynamically changing the polarization of the pump beam 120pu may allow the Raman spectroscopy system 100 in FIG. 2 to perform measurements at two different pump-beam polarizations, which may produce additional data for characterization of the sample 150.

In some embodiments, an optical waveplate 132 may be a metamaterial-based waveplate. A metamaterial refers to an engineered material having features or repeating patterns at scales smaller than the wavelength of light interacting with the metamaterial. A metamaterial may be configured to act as a mirror, lens, waveplate, diffractive optical element, optical combiner, or optical waveguide. A metamaterial-based waveplate may affect the polarization of a beam of light based on wavelength. For example, the Raman spectroscopy system 100 in FIG. 2 may include a metamaterial-based waveplate (not illustrated in FIG. 2) located after the combiner 130a and before the sample 150. The metamaterial waveplate may change the polarization of the pump beam 120pu from linear to circular while preserving the polarization of the Stokes beam 120S (e.g., the Stokes beam may remain linearly polarized and may not be significantly changed by the waveplate).

A Raman spectroscopy system 100 may include an optical filter that transmits light at one or more wavelengths and blocks light at one or more other wavelengths. The optical filter 134 in FIG. 2 is located between the sample 150 and the optical receiver 200 and may be configured to substantially transmit one or more optical wavelengths associated with the Raman signal 160 and substantially block one or more wavelengths associated with the pump beam 120pu or the Stokes beam 120S. For example, the optical filter 134 may transmit greater than 90% of the Raman signal 160 and may block greater than 90% of both the pump and Stokes beams. As another example, the optical filter 134 may transmit greater than 90% of the Raman signal 160 and the Stokes beam 120S, and the optical filter 134 may block greater than 98% of the pump beam 120pu.

A Raman spectroscopy system 100 may include an optical polarizer that transmits light having a particular polarization (e.g., horizontal) and blocks light having an orthogonal polarization (e.g., vertical). The optical polarizer 136 in FIG. 2 is located between the sample 150 and the optical receiver 200 and may be oriented to transmit light with a polarization associated with the Raman signal. Additionally, the polarizer 136 may block a polarization associated with the pump or Stokes beams. For example, the Stokes beam 120S incident on the sample 150 may be vertically polarized, and the Raman signal 160 may be at least partially horizontally polarized. The polarizer 136 may be oriented to block vertically polarized light and transmit horizontally polarized light so that the Stokes beam 120S is blocked and the Raman signal 160 is at least partially transmitted by the polarizer. A Raman spectroscopy system 100 may include both an optical filter 134 and an optical polarizer 136. For example, the optical filter 136 in FIG. 2 may be configured to transmit the Raman signal 160 and the Stokes beam 120S and block the pump beam 120pu. Additionally, the Raman signal 160 and the Stokes beam 120S may be orthogonally polarized, and the polarizer 136 may be oriented to transmit the Raman signal 160 and block the Stokes beam 120S. Using a filter or polarizer located after the sample 150 to block light from the pump beam 120pu or the Stokes beam 120S may reduce noise in the system by reducing the amount of unwanted background light that reaches the detector 220.

The sample 150 in FIGS. 1-2 may be a solid, liquid, or gas, or any combination thereof. The sample 150 may include a biological material, an organic material, an inorganic material, a crystalline material, an amorphous solid material, or any other suitable material or combination of suitable materials. For example, the sample 150 may include a drug, mineral, food, contaminant, or explosive material that produces a Raman signal 160 in response to excitation by the pump and Stokes beams. As another example, the sample 150 may be a biological material (e.g., blood, urine, saliva, sweat, or cerebrospinal fluid) and a component or molecule (e.g., glucose or cortisol) that is part of the biological material may produce a Raman signal 160. As another example, the sample 150 may be water or wastewater that may include a contaminant, virus, bacteria, or an indicator of an infectious disease. The Raman signal 160 may be produced by coherent Raman scattering of the pump and Stokes beams within the sample 150, and the frequency offset Ω between the pump and Stokes beams may be approximately equal to a vibrational frequency or an electronic-transition frequency of a particular material that is part of the sample. The vibrational frequency of the particular material may correspond to a molecular vibration of a molecule, or in the case of a crystalline material, may correspond to a lattice vibration of a crystal. For example, the sample 150 may include glucose, and the frequency offset Ω may be approximately equal to a frequency of a molecular vibration of glucose.

The Raman spectroscopy systems 100 in FIGS. 1-2 may perform one or more measurements of a sample 150, and each measurement may include determining a characteristic of an electronic signal that results from the coherent mixing of the Raman signal 160 and the probe beam 120pr. The electronic signal may include a photocurrent i or a corresponding voltage signal 234. The frequency offset Ω may be approximately equal to a vibrational frequency or electronic-transition frequency of a particular material, and based on the one or more measurements, a processor may determine whether the particular material is present in the sample 150. Additionally or alternatively, the processor may determine an amount or a concentration of the particular material in the sample based on the measurements. For example, the frequency offset Ω may be approximately equal to a vibrational frequency of glucose, and, based on one or more optical heterodyne measurements of a Raman signal 160 produced by a sample 150, the processor may determine (i) whether glucose is present in the sample or (ii) an amount or a concentration of glucose in the sample. The amount of glucose that is present in the sample 150 may be proportional to the amplitude of a photocurrent signal i produced by coherent mixing of the Raman signal 160 and the probe beam 120pr. Based on the amplitude of the photocurrent signal i, the processor may determine the amount or concentration of glucose in the sample 150.

A technical advantage of a coherent Raman spectroscopy system 100 as described herein is a higher spectral resolution or a better chemical sensitivity than a conventional Raman spectroscopy system. As such, a Raman spectroscopy system 100 as described herein may be referred to as a high-resolution Raman spectroscopy system or as a high-resolution coherent Raman spectroscopy system. In a conventional Raman spectroscopy system, a Raman signal produced by a sample may be measured in the optical domain using an optical spectrometer. A spectrometer typically uses a dispersive optical element (e.g., a diffraction grating) to separate the Raman signal into its various spectral components. However, this type of measurement performed in the optical domain typically has a spectral resolution on the order of 1 cm⁻¹ (or, about 30 GHz). In contrast, the spectral resolution of a coherent Raman spectroscopy system with heterodyne detection, as described herein, is determined primarily by the spectral linewidth Δvₚᵣ of the probe beam 120pr that is coherently mixed with the Raman signal 160. The probe laser 110pr may include a wavelength-tunable laser diode with a linewidth of 200 MHz or less, which corresponds to a spectral resolution of the Raman spectroscopy system 100 of less than 200 MHz (or, less than 0.007 cm⁻¹). This 200-MHz spectral resolution is more than 100 times better than the 30-GHz spectral resolution of a conventional Raman spectroscopy system. In some embodiments, the probe laser 110pr may have a linewidth of 1 MHz or less, which corresponds to a spectral resolution of the Raman spectroscopy system 100 of less than 1 MHz (or, less than 33×10⁻⁶ cm⁻¹). A related advantage of a coherent Raman spectroscopy system 100 is that the signal capture and analysis are performed in the electronic domain (e.g., at electronic frequencies between DC and 50 GHz) rather than in the optical domain (e.g., at optical frequencies between 60 THz and 1,000 THz). The coherent mixing of two optical signals (Raman signal 160 and probe beam 120pr) produces an electronic signal which can be analyzed with relatively high resolution compared to an optical signal. This electronic signal analysis, along with the relatively narrow spectral linewidth of the probe laser 110pr, provides a coherent Raman spectroscopy system 100 with a high spectral resolution. Additionally, the wavelength tunability of the probe laser 110pr allows a Raman spectrum of a material to be determined at multiple frequencies with high spectral resolution.

The higher spectral resolution of a coherent Raman spectroscopy system 100 may provide a corresponding improvement in the ability of the coherent Raman spectroscopy system to sense various chemical species. For example, a high-resolution coherent Raman spectroscopy system 100 may be able to distinguish between different chemical species that have Raman peaks located relatively close together, whereas a conventional Raman spectroscopy system may not be able to resolve spectral features below about 1 cm⁻¹. Additionally, the higher spectral resolution of a coherent Raman spectroscopy system 100 may allow for lower concentrations of materials to be detected, as compared to a conventional Raman spectroscopy system. For example, a coherent Raman spectroscopy system 100 may be able to detect small deviations in the chemical signature of a biological sample, which may indicate the presence of damage or a mutation, which in turn may be correlated with a disease or pathogen.

Another technical advantage of a coherent Raman spectroscopy system 100 as described herein is its relatively compact size. A coherent Raman spectroscopy system may be packaged in a relatively compact enclosure as compared to a conventional Raman spectroscopy system. Since the spectral resolution of an optical spectrometer scales inversely with the optical path length of the spectrometer (e.g., a longer path length provides better spectral resolution), an optical spectrometer with a spectral resolution around 1 cm⁻¹ can be quite large or bulky. In contrast, since the spectral resolution of a coherent Raman spectroscopy system is determined primarily by the spectral linewidth of the probe laser 110pr, a coherent Raman spectroscopy system does not require a long optical path length to provide high spectral resolution. Thus, an enclosure for a coherent Raman spectroscopy system may be significantly smaller than that for a conventional Raman spectroscopy system. In some embodiments, a coherent Raman spectroscopy system may be packaged as a compact device that may be referred to as a lab-on-a-chip or a spectrometer on a chip. For example, a coherent Raman spectroscopy system may be packaged as a wearable device that provides ongoing, continual monitoring for a person or an animal.

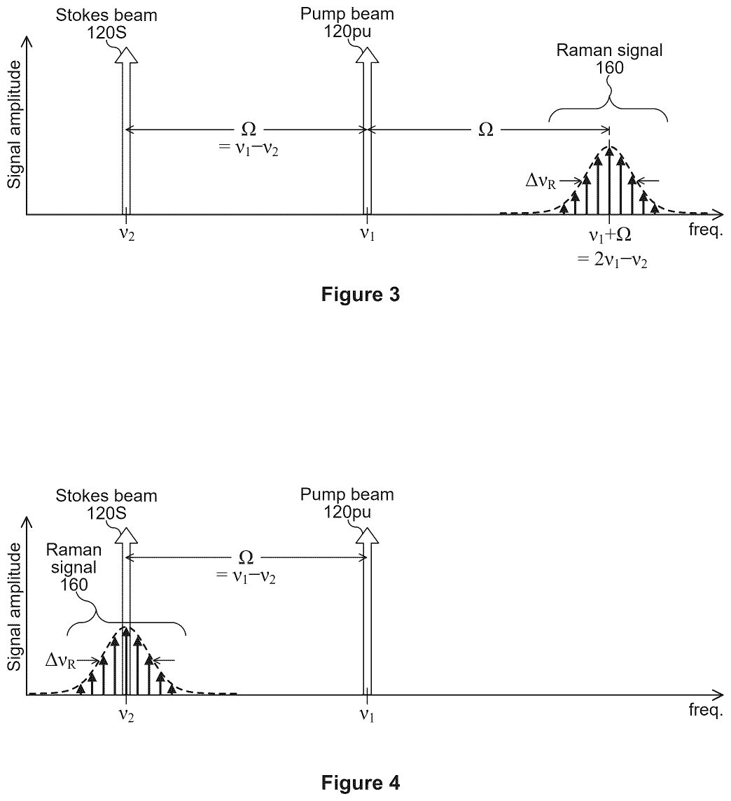

FIGS. 3-4 each illustrates an example Raman signal 160 produced by coherent Raman scattering. In a coherent Raman spectroscopy system 100, the pump beam 120pu and the Stokes beam 120S are directed to a sample 150, which produces a Raman signal 160 by coherent Raman scattering of the pump and Stokes beams within the sample. The frequency of the pump beam 120pu is v₁, and the frequency of the Stokes beam 120S is v₂. The frequency offset Ω between the pump and Stokes beams equals v₁−v₂. The frequencies of the pump and Stokes beams may be set so that the frequency offset Ω is approximately equal to a vibrational frequency or an electronic-transition frequency of a particular material. A coherent Raman spectroscopy system 100 may measure a Raman signal 160 produced by a sample 150 to determine (i) whether the particular material is present in the sample or (ii) an amount or a concentration of the particular material within the sample.

The frequency offset Ω between the pump and Stokes beams may be any suitable fixed or adjustable value between approximately 5 terahertz (THz) and approximately 100 THz. Expressed in wavenumbers, this corresponds to the frequency offset Ω being between approximately 167 cm⁻¹ and approximately 3336 cm⁻¹. For example, in a coherent Raman spectroscopy system 100, the pump beam 120pu may have a wavelength between approximately 1220 nanometers (nm) and approximately 1450 nm (which corresponds to a pump-beam frequency v₁ between approximately 246 THz and approximately 207 THz), and the Stokes beam 120S may have a wavelength between approximately 1490 nm and approximately 1570 nm (which corresponds to a Stokes-beam frequency v₂ between approximately 201 THz and approximately 191 THz). This system may produce pump and Stokes beams having a frequency offset Ω between approximately 5.6 THz and approximately 54.8 THz (or, in wavenumbers, between approximately 185 cm⁻¹ and 1827 cm⁻¹). For example, if the pump beam 120pu has a wavelength of 1330 nm (or equivalently, a frequency v₁ of 225.4 THz) and the Stokes beam 120S has a wavelength of 1550 nm (or equivalently, a frequency v₂ of 193.4 THz), then the frequency offset Ω between the pump and Stokes beams is approximately 32 THz (or, in wavenumbers, 1067 cm⁻¹). The pump and Stokes beams in a Raman spectroscopy system 100 may each have any suitable wavelength between approximately 300 nm and approximately 5,000 nm. For example, if the pump beam 120pu has a wavelength of approximately 785 nm (or equivalently, a frequency v₁ of 381.9 THz) and the Stokes beam 120S has a wavelength of approximately 840 nm (or equivalently, a frequency v₂ of 356.9 THz), then the frequency offset Ω between the pump and Stokes beams is approximately 25 THz (or, in wavenumbers, 834 cm⁻¹). As another example, the pump beam 120pu may have a wavelength between approximately 700 nm and approximately 850 nm, between approximately 890 nm and approximately 920 nm, or between approximately 1000 nm and approximately 1100 nm.

The Raman signal 160 in each of FIGS. 3-4 is an optical signal with a spectral linewidth of Δv_{R}. In FIG. 3, the Raman signal 160 has a center frequency approximately equal to 2v₁−v₂ (which is equal to v₁+Ω, since Ω=v₁−v₂). The center frequency of a Raman signal 160 may refer to the frequency of a central peak or the frequency of an approximate center of the Raman signal. Additionally or alternatively, the center frequency of a Raman signal 160 may correspond to a Raman peak of an associated Raman spectrum. The Raman signal 160 in FIG. 3 may be produced by coherent anti-Stokes Raman scattering (CARS) in which the pump and Stokes beams interact with a sample 150 to produce a Raman signal 160 at or around the frequency 2v₁−v₂. For example, if the pump and Stokes beams have respective wavelengths of 1064 nm and 1550 nm (which corresponds to frequencies of approximately 281.8 THz and 193.4 THz), then the frequency offset Ω is 88.3 THz (or, 2947 cm⁻¹), and the anti-Stokes Raman signal 160 has a center wavelength of approximately 810 nm (which corresponds to a frequency of approximately 370 THz). The Raman signal 160 in FIG. 4, which overlaps the frequency of the Stokes beam 120S, may be produced by stimulated Raman scattering. The Raman signal 160 in FIG. 4 may be centered at or near the frequency v₂ of the Stokes beam 120S. For example, the Raman signal 160 in FIG. 4 may have a center frequency that is within approximately 200 GHz (or, 6.7 cm⁻¹) of the Stokes-beam frequency v₂.

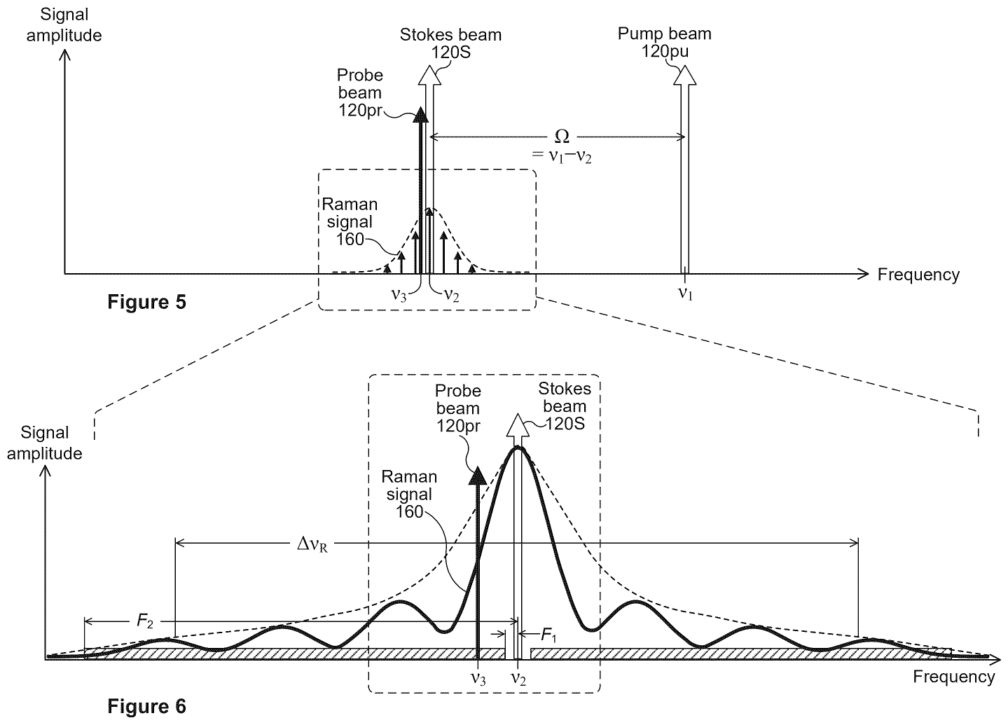

FIG. 5 illustrates the example Raman signal 160 of FIG. 4 along with a probe beam 120pr. The Raman signal 160 may be produced by stimulated Raman scattering of the pump beam 120pu and Stokes beam 120S, and the probe beam 120pr may be used to measure the Raman signal. The Raman signal 160 is centered at or near the frequency v₂ of the Stokes beam 120S, and the frequency v₃ of the probe beam of light 120pr overlaps the Raman signal 160 and is relatively close to the frequency v₂ of the Stokes beam of light 120S (e.g., the probe-beam frequency v₃ may be within 200 GHz of the Stokes-beam frequency v₂). In a coherent Raman spectroscopy system 100, the pump frequency v₁, Stokes frequency v₂, and probe frequency v₃ may each be between approximately 60 THz and approximately 1,000 THz (which corresponds to a wavelength between approximately 5,000 nm and approximately 300 nm). For example, in FIG. 5 the pump frequency v₁ may be 291 THz (which corresponds to a wavelength of approximately 1030 nm), the Stokes frequency v₂ may be 240.03 THz (which corresponds to a wavelength of approximately 1249.00 nm), and the probe frequency v₃ may be 240.00 THz (which corresponds to a wavelength of approximately 1249.14 nm).

Each of the light sources 110 of a coherent Raman spectroscopy system 100 may include a wavelength-tunable light source. A wavelength-tunable light source refers to a light source 110 that can produce light at multiple different wavelengths within a range of wavelengths (or equivalently, at multiple different frequencies within a range of frequencies). For example, the probe light source 110pr in FIG. 1 may be a wavelength-tunable light source where the wavelength of the probe beam 120pr is adjustable over an 80-nm wavelength range from 1490 nm to 1570 nm (which corresponds to a 10.3 THz frequency range from approximately 201.2 THz to approximately 191.0 THz). At any given time, a wavelength-tunable light source 110 may operate at any one of the different wavelengths within its wavelength-tuning range. For example, during a first period of time, the probe light source 110pr with a 1490-1570 nm wavelength-tuning range may produce a probe beam 120pr at 1500 nm, and during a subsequent second period of time, the probe light source may be tuned to operate at 1560 nm. A wavelength-tunable light source may be adjustable over a frequency range that corresponds to a wavelength range having a width or span between approximately 10 nm and approximately 100 nm. For example, the width of the wavelength-tuning range of a wavelength-tunable light source may be approximately 10 nm, 20 nm, 30 nm, 40 nm, 50 nm, 60 nm, 80 nm, or 100 nm. A wavelength-tuning range from 1490 nm to 1570 nm may be referred to as having an 80-nm width or an 80-nm span. Around 1550 nm, a 10-nm wavelength-tuning range corresponds to a frequency-tuning range of approximately 1.25 THz (or equivalently, 41.6 cm⁻¹), and a 100-nm wavelength-tuning range corresponds to a frequency-tuning range of approximately 12.5 THz (or equivalently, 416 cm⁻¹). Around 1050 nm, a 10-nm wavelength-tuning range corresponds to a frequency-tuning range of approximately 2.72 THz (or equivalently, 90.7 cm⁻¹), and a 100-nm wavelength-tuning range corresponds to a frequency-tuning range of approximately 27.3 THz (or equivalently, 909 cm⁻¹). A wavelength-tunable light source may be referred to as a frequency-tunable light source or a tunable light source.

Each of the light sources 110 of a coherent Raman spectroscopy system 100 may include one or more laser diodes, and each of the laser diodes may be a fixed-wavelength laser diode or a wavelength-tunable laser diode. A fixed-wavelength laser diode may operate at a single wavelength or within a relatively narrow wavelength range (e.g., within 0.1 nm of a particular wavelength). A fixed-wavelength laser diode may include a distributed feedback (DFB) laser diode, a distributed Bragg reflector (DBR) laser diode, a fiber-Bragg-grating (FBG) stabilized laser diode, a temperature-stabilized laser diode, or any other suitable fixed-wavelength laser diode. A wavelength-tunable laser diode may produce light at multiple different wavelengths within a range of wavelengths. For example, a wavelength-tunable laser diode may be configured to produce light at any wavelength within a wavelength range having a width between approximately 10 nm and approximately 100 nm. At any given time, a wavelength-tunable laser diode may operate at any one wavelength of multiple different wavelengths within a range of wavelengths. A wavelength-tunable laser diode may include an external-cavity laser diode, a thermally tuned laser diode, or a sampled-grating distributed Bragg reflector (SG-DBR) laser. For example, a wavelength-tunable SG-DBR laser may have a 40-nm wavelength-tuning range that extends from 1530 nm to 1570 nm, and the SG-DBR laser may be adjustable to operate at any single wavelength within the 40-nm wavelength range. A wavelength-tunable laser diode may be referred to as a frequency-tunable laser diode or a tunable laser diode. For example, a tunable laser with a 40-nm wavelength-tuning range that extends from 1530 nm to 1570 nm may also be referred to as a frequency-tunable laser with a 5.0-THz frequency-tuning range that extends from approximately 191 THz to approximately 196 THz.

Each of the light sources 110 of a coherent Raman spectroscopy system 100 may include one or more of the following: light-emitting diode (LED), super-luminescent light source, short-pulse laser, broadband light source, fiber laser, solid-state laser, quantum-cascade laser. For example, a light source that produces light over a relatively broad range of wavelengths (e.g., a super-luminescent light source, short-pulse laser, or broadband light source) may be used to investigate a sample over the broad range of wavelengths without having to use a wavelength-tunable light source.

FIG. 6 illustrates an expanded view of a portion of the Raman signal 160 of FIG. 5. The portion of FIG. 5 enclosed by the dashed-line box is expanded in FIG. 6. The peak of the Raman signal 160 in FIG. 6 is approximately coincident with the frequency v₂ of the Stokes beam 120S, and the frequency v₃ of the probe beam 120pr overlaps the Raman signal.

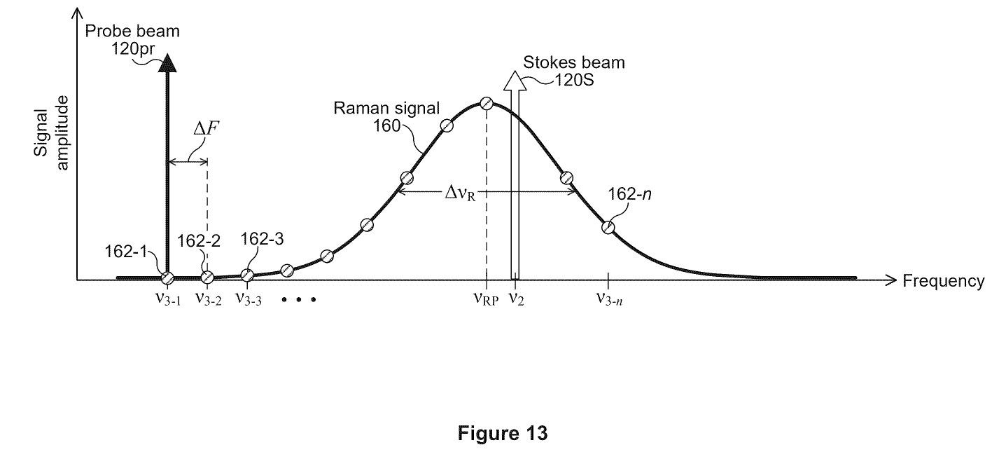

The Raman signal 160 in FIG. 6 is an optical signal with a spectral linewidth of Δv_{R}. The spectral linewidth of a Raman signal 160 may have a value between approximately 30 GHz and 300 GHz (or, in wavenumbers, between approximately 1 cm⁻¹ and approximately 10 cm⁻¹). The spectral linewidth Δv_{R} of a Raman signal 160 may represent the spectral width of a peak of the Raman signal (e.g., a full-width-at-half-maximum of the peak) or may represent an approximate extent or width of the full Raman signal. For example, the spectral linewidth Δv_{R} of the Raman signal 160 in FIG. 13 corresponds to a full-width-at-half-maximum of a peak of the Raman signal. In FIG. 6, the spectral linewidth Δv_{R} of the Raman signal 160 corresponds to an extent or width of the full Raman signal. For example, the spectral linewidth of a Raman signal 160 may equal a spectral width at which an envelope of the Raman signal has decreased to a particular level (e.g., to 50%, 20%, or 10% of a peak value). The envelope may be a curve that decreases monotonically away from a peak of the Raman signal and approximately follows an overall shape of the Raman signal. In FIG. 6, the dashed-line curve that traces the peaks of the Raman signal 160 represents an envelope of the Raman signal, and the spectral linewidth Δv_{R} corresponds to a full-width-at-10% of the Raman-signal envelope (i.e., the points at which the envelope has decreased to 10% of its maximum value).

In a coherent Raman spectroscopy system 100, the difference between the frequency v₂ of the Stokes beam 120S and the frequency v₃ of the probe beam 120pr may be greater than a low-frequency limit F₁ and less than a high-frequency limit F₂ (i.e., F₁<|v₂−v₃|<F₂). For example, the low-frequency limit F₁ may be approximately 1 MHz, 10 MHz, 50 MHz, 100 MHz, 200 MHz, 500 MHz, or 1 GHz, and the high-frequency limit F₂ may be approximately 10 GHz, 20 GHz, 50 GHz, 100 GHz, 200 GHz, 500 GHz, or 1 THz. As another example, the low-frequency limit F₁ may be related to the spectral linewidth Δvₚᵣ of the probe beam 120pr and the spectral linewidth Δv_{S} of the Stokes beam 120S (e.g., F₁ may be greater than Δvₚᵣ+Δv_{S}). As another example, the high-frequency limit F₂ may be related to the spectral linewidth Δv_{R} of a Raman signal 160 (e.g., F₂ may be approximately equal (0.5)Δv_{R}, Δv_{R}, or 2Δv_{R}). As another example, F₁ may be 100 MHz and F₂ may be 200 GHz, which indicates that the frequency v₂ of the Stokes beam 120S and the frequency v₃ of the probe beam 120pr may differ by greater than 100 MHz and less than 200 GHz (i.e., 100 MHz<|v₂−v₃|<200 GHz). The frequencies F₁ and F₂ represent the frequency range with respect to the Stokes-beam frequency v₂ over which the probe-beam frequency v₃ may be scanned. The two hatched rectangles along the frequency axis in FIG. 6 represent the allowed frequency ranges for the probe beam 120pr. The frequency of the probe beam 120pr may be (i) between v₂−F₂ and v₂−F₁ or (ii) between v₂+F₁ and v₂+F₂. In an optical receiver 200, the probe beam 120pr and the Raman signal 160 may be coherently mixed together at an optical detector 220. The frequency v₃ of the probe beam 120pr may be kept away from the frequency v₂ of the Stokes beam 120S by at least the low-frequency limit F₁ (e.g., |v₂−v₃|>F₁) to avoid mixing between the probe and Stokes beams, which could cause the detector to produce an unwanted electronic signal not related to the mixing between the probe beam and Raman signal. Additionally, the frequency v₃ of the probe beam 120pr may be kept within the high-frequency limit F₂ of the frequency v₂ of the Stokes beam 120S (e.g., |v₂−v₃|<F₂), since measurements outside the high-frequency limit may not produce a significant electronic signal.

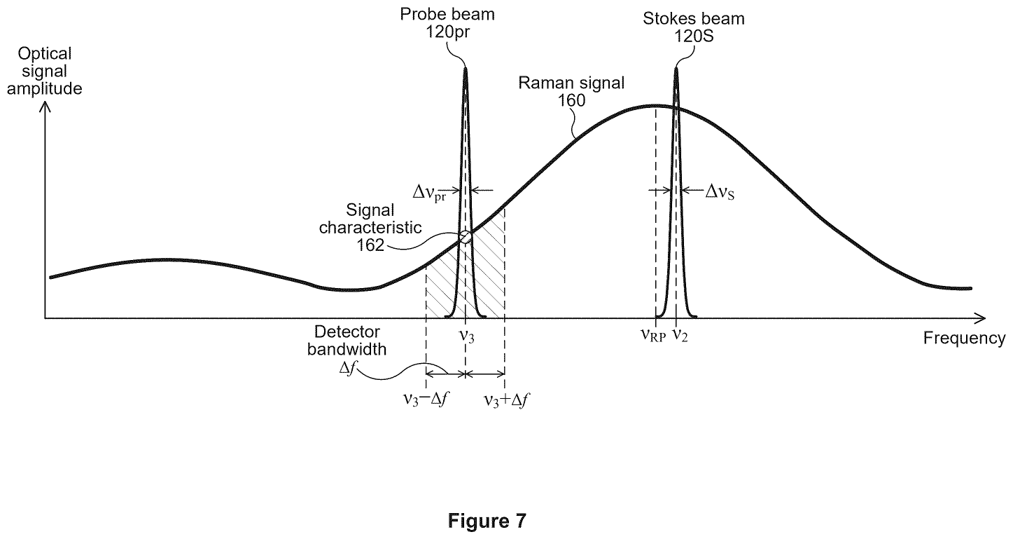

FIG. 7 illustrates an expanded view of a portion of the Raman signal 160 of FIG. 6. The portion of FIG. 6 enclosed by the dashed-line box is expanded in FIG. 7. The peak of the Raman signal 160 in FIG. 7 is located at frequency v_{RP}, and the Stokes beam 120S is located at the Stokes frequency V₂. The Raman-signal peak frequency v_{RP} may correspond to a Raman peak of a material that is part of a sample 150 being measured by a Raman spectroscopy system 100. For example, the difference between the pump-beam frequency v₁ and the Raman-signal peak frequency v_{RP} may equal a vibrational frequency Ω of the material (e.g., v₁−v_{RP}=Ω). In some embodiments, a Stokes light source 110S may be operated so that the Stokes-beam frequency v₂ is approximately equal to the Raman-signal peak frequency v_{RP}, and in other embodiments (e.g., as illustrated in FIG. 7), the Stokes-beam frequency v₂ may be slightly off-resonance or detuned with respect to the Raman-signal peak frequency v_{RP}. For example, in FIG. 7, the Stokes-beam frequency v₂ may differ from the Raman-signal peak frequency v_{RP} by less than or equal to 30 GHz, 10 GHz, 5 GHz, or 1 GHz.

The beams of light 120 produced by the pump, Stokes, and probe light sources 110 in a Raman spectroscopy system 100 may each have a spectral linewidth of less than 200 MHz. Additionally, one or more of the beams of light 120 may have a spectral linewidth of less than 1 MHz. For example, the spectral linewidth of a beam of light 120 may be less than 200 MHz, 100 MHz, 50 MHz, 10 MHz, 1 MHz, or 100 kHz. In FIG. 7, the spectral linewidth Δvₚᵣ of the probe beam 120pr and the spectral linewidth Δv_{S} of the Stokes beam 120S may each be less than 200 MHz. In some embodiments, the probe light source 110pr may be configured to produce a probe beam 120pr having a relatively narrow spectral linewidth, which may allow a Raman spectroscopy system 100 to measure a Raman spectrum with a high degree of spectral resolution. For example, the spectral linewidth Δvₚᵣ of the probe beam 120pr in FIG. 7 may be less than 1 MHz.

An optical receiver 200 of a coherent Raman spectroscopy system 100 may include one or more detectors 220, where each detector is configured to coherently mix a portion of a Raman signal 160 with at least a portion of a probe beam of light 120pr to produce an electronic signal. For an optical receiver 200 with a single detector 220, all or most of the probe beam of light 120pr may be mixed with the Raman signal 160. For an optical receiver 200 with multiple detectors 220, the probe beam of light 120pr may be split so that a portion of the probe beam of light is sent to each of the detectors. For example, in an optical receiver 200 with four detectors 220, the probe beam 120pr may be split into four portions, and each detector may receive one of the four portions of the probe beam. Similarly, for an optical receiver 200 with a single detector 220, all or most of the Raman signal 160 may be sent to the single detector, and for an optical receiver with multiple detectors 220, the Raman signal 160 may be split so that a portion of the Raman signal is sent to each of the detectors.

Coherent mixing of a probe beam 120pr and a Raman signal 160, which may be referred to as heterodyne detection, may occur when the two optical signals are optically combined and then detected by a detector 220. Optically combining the probe beam 120pr and the Raman signal 160 may refer to combining the two optical signals so that their electric fields are summed together. For example, the probe beam and Raman signal may be combined (e.g., with an optical combiner 130) so that the two signals are substantially coaxial and travel together in the same direction and along approximately the same optical path. Additionally, the probe beam and Raman signal may be combined so that at least a portion of their polarizations have the same orientation to allow at least a portion of their electric fields to be summed together. Once the probe beam and Raman signal are optically combined to produce a combined probe-Raman signal 210, the probe beam and Raman signal may be coherently mixed at a detector 220. The detector 220 may produce a photocurrent signal i corresponding to the coherent mixing of the probe beam 120pr and a portion of the Raman signal 160.

The portion of a Raman signal 160 that is coherently mixed with a probe beam of light 120pr at a detector 220 to produce an electronic signal may refer to a spectral portion of the Raman signal. The spectral portion of a Raman signal 160 that is coherently mixed with a probe beam 120pr may include optical frequency components of the Raman signal that are within a particular frequency range of the frequency v₃ of the probe beam of light, where the particular frequency range is based on or depends on the electronic bandwidth Δf of the optical detector 220. In FIG. 7, the hatched region around the probe frequency v₃ represents the spectral portion of the Raman signal 160 that is coherently mixed with the probe beam 120pr. The particular frequency range illustrated by the hatched region extends from v₃−Δf to v₃+Δf, where Δf is the electronic bandwidth of the detector. The particular frequency range includes the optical frequency components of the Raman signal 160 that are coherently mixed with the probe beam 120pr to produce an electronic signal.

The electronic signal produced by the detector 220 in response to the coherent mixing of the portion of the Raman signal 160 and probe beam 120pr may include one or more electronic frequency components, where each electronic frequency component has a frequency less than or equal to approximately Δf. For example, the electronic bandwidth Δf of the optical detector may be 10 GHz, and the electronic signal produced by the detector may include one or more electronic frequency components having frequencies less than or equal to approximately 10 GHz. Other optical frequency components of the Raman signal 160 that are outside the hatched region (e.g., optical frequencies less than v₃−Δf and greater than v₃+Δf) may produce a coherent-mixing response in the detector 220. However, since these Raman-signal optical frequency components would produce an electronic response at frequencies greater than Δf (which is outside of the electronic bandwidth of the detector), these optical frequency components will not result in any significant contribution to the electronic signal. The electronic bandwidth of the detector 220 effectively limits or filters the optical frequency components of the Raman signal 160 that are measured by the optical receiver 200 to optical frequency components that are within a particular frequency range of the probe frequency. Accordingly, the electronic bandwidth of the detector 220, in combination with the relatively narrow spectral linewidth of the probe beam 120pr, may allow a Raman spectroscopy system 100 to measure a Raman signal 160 with a high degree of spectral resolution. Herein, an optical frequency or an optical frequency component refers to a signal in the optical domain between approximately 60 THz and approximately 1,000 THz, and an electronic frequency or an electronic frequency component refers to a signal in the electronic domain between 0 Hz and approximately 50 GHz.

The electronic signal that results from coherent mixing of a Raman signal 160 and a probe beam 120pr may include a coherent-mixing term that is proportional to a product of (i) E_{R}, the amplitude of the electric field of the Raman signal and (ii) Eₚᵣ, the amplitude of the electric field of the probe beam. The photocurrent signal i produced by a detector 220 in response to the coherent mixing of a Raman signal 160 and a probe beam 120pr may be proportional to the square of the summed electric fields of the probe beam 120pr and a spectral portion of the Raman signal 160. This type of detector 220 that produces a photocurrent signal i that is proportional to the square of a received electric field may be referred to as a square-law detector. The photocurrent signal i may be expressed as i(t)=k|ε_{R}(t)+εₚᵣ(t)|², where k is a constant (e.g., k may account for the responsivity of the detector 220 as well as other constant parameters or conversion factors). For clarity, the constant k or other constants (e.g., conversion constants or factors of 2 or 4) may be excluded from expressions herein related to the photocurrent i or the voltage signal 234. In the above expression for i(t), ε_{R}(t) is the electric field of the Raman signal 160, and εₚᵣ(t) is the electric field of the probe beam 120pr. The electric field of the Raman signal 160 may be expressed as E_{R} cos[2πν_{R}t+ϕ_{R}], where E_{R} is the amplitude of the electric field of the Raman signal. The electric field of the probe beam 120pr may be expressed as Eₚᵣ cos[2πν₃t+ϕₚᵣ], where Eₚᵣ is the amplitude of the electric field of probe beam. The frequency v_{R} is the optical frequency of the electric field of the spectral portion of the Raman signal 160 that is coherently mixed with the probe beam 120pr. The frequency v_{R} may include the optical frequency components of the Raman signal 160 from v₃−Δf to v₃+Δf, where Δf is the electronic bandwidth of the detector. The frequency v₃ is the optical frequency of the electric field of the probe beam 120pr. The term ϕ_{R} is the phase of the electric field of the Raman signal 160, and the term ϕₚᵣ is the phase of the electric field of the probe beam 120pr.

The above expression for the photocurrent signal i may be expanded and written as i(t)=E_{R}²+Eₚᵣ²+2E_{R}Eₚᵣ cos[2π(ν_{R}−ν₃)t+Δϕ], where, for clarity, the constant k is not included. In this expanded expression for the photocurrent signal i(t), the first term E_{R}² corresponds to the optical power (P_{R}) of the Raman signal 160, and the second term Eₚᵣ² corresponds to the optical power (Pₚᵣ) of the probe beam 120pr. The third term in the above expression is 2E_{R}Eₚᵣ cos[2π(ν_{R}−ν₃)t+Δϕ] and may be referred to as a coherent-mixing term that represents coherent mixing between the electric fields of the Raman signal 160 and probe beam 120pr. The phase difference Δϕ is the phase difference between the electric fields of the Raman signal and the probe beam (e.g., Δϕ=ϕ_{R}−ϕₚᵣ). The coherent-mixing term is proportional to E_{R}×Eₚᵣ, which is the product of the electric-field amplitudes of the Raman signal 160 and the probe beam 120pr. Additionally, the coherent-mixing term includes a cosine function that varies in time based on the frequency difference (v_{R}−v₃) between the Raman signal 160 and the probe beam 120pr. Since the spectral portion of the Raman signal 160 that is coherently mixed with the probe beam 120pr includes the optical frequency components of the Raman signal from v₃−Δf to v₃+Δf, the frequency-difference term (v_{R}−v₃) may include frequency components from zero to Δf. Accordingly, the coherent-mixing term may be referred to as including multiple electronic frequency components, where each electronic frequency component is proportional to ε_{R}Eₚᵣ cos[2πft+Δϕ]. The frequency f, which may be referred to as an electronic frequency, is equal to the frequency difference (v_{R}−v₃) and has a value between zero and Δf. The coherent-mixing term may also be expressed as 2\sqrt{P_{R}}\sqrt{Pₚᵣ} cos[2πft+Δϕ], where P_{R} is the optical power of the Raman signal 160 and Pₚᵣ is the optical power of the probe beam 120pr.

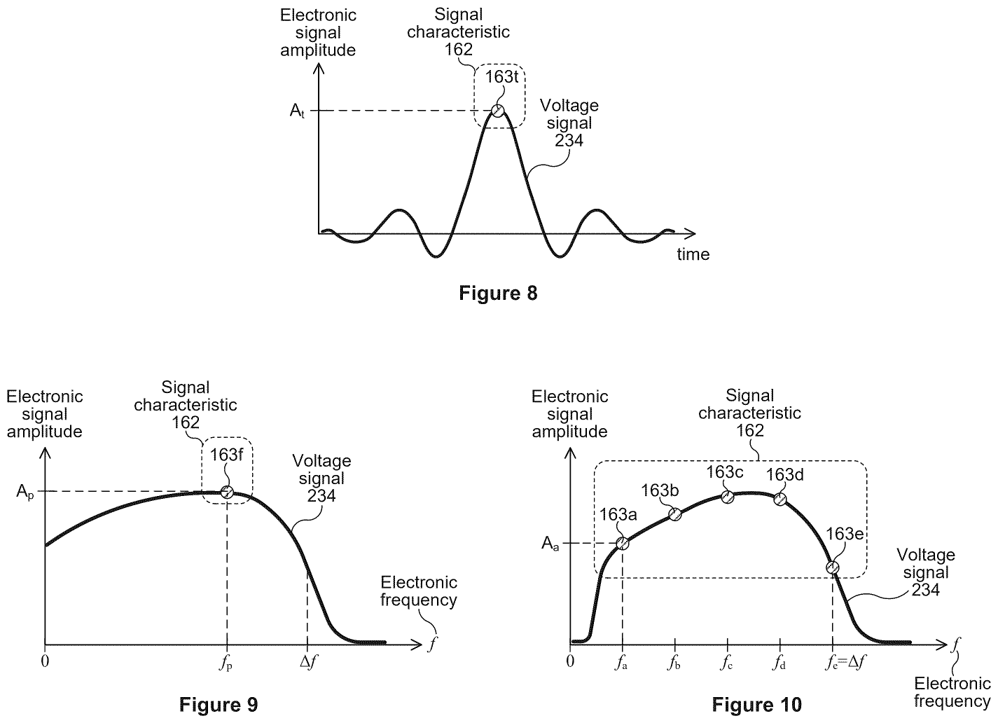

FIGS. 8-10 illustrate time-domain and frequency-domain plots of an example electronic signal resulting from coherent mixing of the Raman signal 160 and probe beam 120pr of FIG. 7. The electronic signal produced by a detector 220 may be a photocurrent signal i, and an electronic amplifier 232 may produce a voltage signal 234 that corresponds to the photocurrent signal i. The voltage signal 234 may be approximately proportional to the photocurrent signal i, and both the voltage and photocurrent signals may be proportional to P_{R}+Pₚᵣ+2\sqrt{P_{R}}\sqrt{Pₚᵣ} cos[2πft+Δϕ], where the electronic frequency f is equal to the frequency difference (v_{R}−v₃). The electronic frequency f may take on multiple values (or a continuous range of values) between zero and Δf, and so, the voltage signal 234 in the time domain may be viewed as a summation over these multiple frequency components. In the frequency domain, the voltage signal 234 may have frequency components that extend from DC to Δf (or, for an amplifier 232 with a low-frequency cutoff filter, from the low-frequency cutoff to Δf). The two terms P_{R} and Pₚᵣ represent the optical powers of the Raman signal and probe beam. Over the time duration of a measurement, the powers of the Raman signal and probe beam may be approximately constant, and so the contribution of P_{R}+Pₚᵣ in the above expression may correspond to a DC offset with little or no time variation. An electronic amplifier 232 may include a high-pass or band-pass filter that removes or attenuates the DC or low-frequency components, resulting in an electronic signal with little or no DC offset (e.g., as illustrated by the time-domain voltage signal 234 in FIG. 8).

The signal characteristic 162 in each of FIGS. 7-10 represents a characteristic of an electronic signal (e.g., a characteristic of a photocurrent signal i or a characteristic of a corresponding voltage signal 234) associated with a Raman signal 160. A signal characteristic 162 may be determined from a digital signal 240, where the digital signal is a digital representation of a photocurrent signal i or a voltage signal 234. A characteristic 162 of an electronic signal may be determined by a processor of a Raman spectroscopy system 100 and may include one or more data points 163, where each data point represents: a peak amplitude, an average amplitude, an amplitude at a particular frequency, an amplitude at a particular time, an amplitude at a frequency center, an amplitude at a temporal center, an area, a frequency (e.g., an electronic frequency or an optical frequency), a phase, or a polarization. A Raman spectroscopy system 100 may measure one or more signal characteristics 162 associated with one or more Raman signals 160, and based on the measured characteristics, a processor may determine (i) whether a particular material is present in a sample or (ii) an amount or a concentration of the particular material in the sample.

FIG. 8 illustrates an example time-domain plot of a voltage signal 234 resulting from coherent mixing of the Raman signal 160 and probe beam 120pr of FIG. 7. A digitizer 236 (e.g., an ADC) may produce a digital signal 240 that represents the voltage signal 234 in the time domain, and a processor may determine a characteristic 162 of the electronic signal based on the digital signal. The signal characteristic 162 in FIG. 8 includes a single data point 163t which represents a peak amplitude Aₜ of the time-domain voltage signal 234. The signal characteristic 162 may also include the optical frequency v₃ that the probe beam 120pr was set to when the electronic signal was obtained. Other time-domain-type data points 163 associated with the signal characteristic 162 in FIG. 8 may include (i) an amplitude of the time-domain voltage signal 234 at a particular time (e.g., at a temporal center) or (ii) an area associated with the voltage signal. For an area associated with the voltage signal 234, a processor may first convert the voltage signal into a non-negative signal (e.g., by taking the absolute value or by squaring the values of the voltage signal) and then integrate the non-negative signal to determine an area under the curve.

A processor of a Raman spectroscopy system 100 may determine a Fourier transform of a digital signal 240. A voltage signal 234 may be a time-domain signal, and the digital signal 240 may be a time-domain digital representation of the voltage signal 234. The Fourier transform of the digital signal 240 may produce a frequency-domain representation of the voltage signal 234. From the Fourier transform, the processor may determine one or more electronic frequency components of the voltage signal 234. Determining a frequency component of a voltage signal 234 may include determining an amplitude of the frequency-domain voltage signal at a particular frequency (e.g., at 4 GHz). FIGS. 9-10 each illustrates an example frequency-domain plot of a voltage signal 234 resulting from coherent mixing of the Raman signal 160 and probe beam 120pr of FIG. 7. The frequency-domain plots may be determined by taking a Fourier transform (e.g., a discrete Fourier transform or a fast Fourier transform) of a time-domain digital signal 240 that represents a time-domain voltage signal 234. The x-axis of each of the frequency-domain plots in FIGS. 9-10 is labeled as “electronic frequency” to clarify and distinguish it from the x-axis of the frequency-domain plots in FIGS. 3-7. The x-axis of each of the frequency-domain plots in FIGS. 3-7 may be referred to as an “optical frequency,” where the pump beam 120pu, Stokes beam 120S, Raman signal 160, and probe beam 120pr each have frequencies in the optical domain (e.g., in the range of 60-1,000 THz). In contrast, the x-axis of each of the frequency-domain plots in FIGS. 9-10 includes frequencies in the electronic domain (e.g., in the range of DC to 50 GHz). Coherent mixing of a Raman signal 160 and probe beam 120pr (which are signals in the optical domain) produces an electronic signal that can be detected and analyzed using electronic techniques. The y-axis of each of the plots in FIGS. 8-10 is labeled “electronic signal amplitude” and may have units of voltage, current, or electrical power (e.g., watts).

In FIG. 9, the frequency-domain voltage signal 234 has non-zero frequency components that extend from DC (i.e., zero hertz) to the detector-bandwidth frequency Δf. In FIG. 10, the frequency-domain voltage signal drops off before reaching zero hertz, indicating that the corresponding voltage signal 234 may have been AC-coupled or high-pass filtered to remove the DC or low-frequency components. The signal characteristic 162 in FIG. 9 includes a single data point 163f which represents a peak amplitude Aₚ of the frequency-domain voltage signal 234. The data point 163f may include the peak amplitude Aₚ or the frequency fₚ at which the peak amplitude is located. The signal characteristic 162 in FIG. 10 includes five data points: data point 163a at frequency fₐ, data point 163b at frequency f_{b}, data point 163c at frequency f_{c}, data point 163d at frequency f_{d}, and data point 163e at frequency fₑ. Each data point 163 in FIG. 10 may include an amplitude value (e.g., amplitude Aₐ may be associated with data point 163a) or a frequency (e.g., frequency fₐ may be associated with data point 163a). The frequencies associated with the data points 163 in FIG. 10 may have particular values. For example, the detector bandwidth Δf may be 5 GHz, and the frequencies fₐ, f_{b}, f_{c}, f_{d}, and fₑ may have respective values of approximately 1 GHz, 2 GHz, 3 GHz, 4 GHz, and 5 GHz. Other frequency-domain-type data points 163 associated with the signal characteristic 162 in FIG. 9 or 10 may include (i) an amplitude of the frequency-domain voltage signal 234 at a particular frequency or at a center frequency or (ii) an area or an average amplitude associated with the frequency-domain voltage signal 234. Additionally, the signal characteristic 162 in FIG. 9 or 10 may include the optical frequency v₃ that the probe beam 120pr was set to when the voltage signal 234 was obtained.

A processor of a coherent Raman spectroscopy system 100 may associate a determined signal characteristic 162 with a Raman frequency shift. For example, the signal characteristic 162 in FIG. 7 may be associated with a Raman frequency shift having a frequency v₁−v₃, which is the difference between the pump-beam frequency v₁ and the probe-beam frequency v₃. A sample 150 under investigation may include a material with a Raman spectrum having a peak at a frequency Ω, which is approximately equal to v₁−v_{RP}, the difference between the pump-beam frequency v₁ and the Raman-signal peak frequency v_{RP}. The peak frequency Ω may be approximately equal to a vibrational frequency of the material and may correspond to a Raman frequency shift of Ω (e.g., when excited with light at a frequency v, the material may produce Raman-shifted light at the frequencies v+Ω and v−Ω). In FIG. 7, the probe beam 120pr is being used to measure the Raman signal 160 at the probe-frequency v₃, and the resulting signal characteristic 162 that is determined may be associated with a Raman spectrum of the material at the frequency v₁−v₃, which may be referred to as a Raman frequency shift of v₁−v₃.

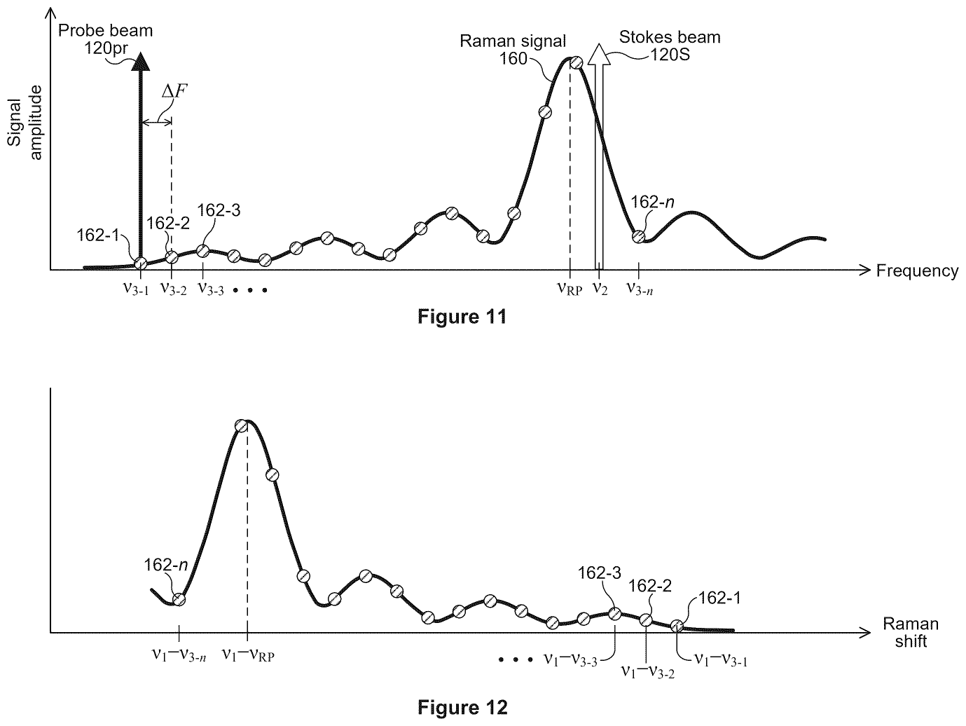

FIG. 11 illustrates an example Raman signal 160 that is measured at multiple probe frequencies v₃. The probe beam 120pr is tuned to multiple different probe frequencies (v₃₋₁, v₃₋₂, v₃₋₃, . . . v₃₋ₙ) to measure multiple respective signal characteristics (162-1, 162-2, 162-3, . . . 162-n) of the Raman signal 160. The Raman signal 160 is produced by coherent Raman scattering of pump and Stokes beams within a sample 150. Throughout the measurements of the multiple signal characteristics 162 in FIG. 11, the pump-beam frequency v₁ and the Stokes-beam frequency v₂ may remain substantially constant so that the resulting Raman signal 160 also remains substantially constant (e.g., the Raman signal may exhibit substantially the same shape and amplitude throughout the measurements). The number n of signal characteristics 162 that are measured may be 1, 5, 10, 50, 100, 500, 1,000, or any other suitable number of signal characteristics. At each of the n probe frequencies, the probe beam 120pr may be coherently mixed with a spectral portion of the Raman signal 160 that is within a particular frequency range of the probe frequency v₃ (e.g., within Δf of the probe frequency, as illustrated in FIG. 7) to measure one signal characteristic 162. Each signal characteristic 162 may provide information about the Raman signal 160 in the frequency region from v₃−Δf to v₃+Δf. Based on one or more measured signal characteristics 162, a processor may determine (i) whether a particular material is present in a sample or (ii) an amount or a concentration of the particular material in the sample.

At each of the n probe frequencies, a single measurement may be performed, or multiple measurements may be performed. For example, with the probe beam 120pr in FIG. 11 set to the probe-beam frequency v₃₋₁, an optical receiver 200 may measure a single photocurrent signal i and produce a corresponding single digital output signal 240. From that one output signal 240, a processor may determine a signal characteristic 162-1. Alternatively, with the probe beam 120pr in FIG. 11 set to the probe-beam frequency v₃₋₁, an optical receiver 200 may measure a series of multiple photocurrent signals i (e.g., 2, 4, 10, 20, 50, 100, or any other suitable number of signals) and produce multiple corresponding digital output signals 240. A processor may determine one signal characteristic 162-1 from the multiple digital output signals. For example, the processor may average or otherwise combine the multiple digital output signals 240 to produce one signal characteristic 162-1. Measurement of a series of multiple photocurrent signals i may improve the measurement accuracy by averaging out noise or removing outliers from the measurements.

By tuning the probe-beam frequency v₃ to multiple frequencies across at least a portion of a Raman signal 160, a coherent Raman spectroscopy system 100 may measure the Raman signal at multiple points 162. For example, the probe-beam frequency v₃ in FIG. 6 may be tuned across at least a portion of the frequency range between v₂−F₂ and v₂−F₁ or between v₂+F₁ and v₂+F₂. Each of the different probe-beam frequencies to which the probe beam 120pr is changed may be offset from an adjacent probe-beam frequency by a frequency increment ΔF between approximately 10 MHz and approximately 10 GHz. For example, the probe-beam frequency in FIG. 11 may be changed in frequency increments ΔF of approximately 5 GHz as it is tuned across at least a portion of the Raman signal 160. Each signal characteristic 162 in FIG. 11 is plotted along the x-axis at the probe frequency v₃ at which the signal characteristic was obtained. The y-axis in FIG. 11 may represent an amplitude or area associated with the signal characteristics 162. For example, each signal characteristic 162 in FIG. 11 may be plotted along the y-axis at a value corresponding to an amplitude or an area of an electronic signal from which the signal characteristic was obtained.

A probe light source 110pr of a coherent Raman spectroscopy system 100 may include a wavelength-tunable laser, where the frequency v₃ of the probe beam 120pr is adjustable by changing the wavelength of light produced by the wavelength-tunable laser. For example, a wavelength-tunable laser may be adjustable over a wavelength range having a width between approximately 10 nm and approximately 100 nm. As another example, the wavelength-tuning range of a wavelength-tunable laser may be between approximately 1000 nm and approximately 1100 nm, between approximately 1490 nm and approximately 1570 nm, or between approximately 1600 nm and approximately 1690 nm. A wavelength-tunable laser may be continuously tunable over a wavelength-tuning range or may be tunable to multiple discrete wavelengths within a wavelength-tuning range. For example, a wavelength-tunable laser may be continuously tunable to any wavelength between 1530 nm and 1570 nm. Alternatively, a wavelength-tunable laser may be tunable to a set of approximately 10, 100, or 1,000 discrete wavelengths between 1530 nm and 1570 nm (e.g., the wavelengths may be separated from one another by approximately 4 nm, 0.4 nm, or 0.04 nm, respectively). A probe light source 110pr may include a wavelength-tunable laser that sequentially changes the probe-beam frequency v₃ to multiple different frequencies. For example, the probe-beam frequency in FIG. 6 may be tuned to approximately 100 different frequencies between the frequencies v₂−F₂ and v₂−F₁. At each of the different probe-beam frequencies, the probe beam 120pr and a spectral portion of the Raman signal 160 may be coherently mixed at a detector 220 to produce a corresponding electronic signal, and a processor may determine a signal characteristic 162 based on the electronic signal.

In FIG. 11, the probe beam 120pr may initially be set to the probe-beam frequency v₃₋₁ and coherently mixed at a detector 220 with a spectral portion of the Raman signal 160 around the probe frequency v₃₋₁. For example, the spectral portion of the Raman signal 160 may include optical frequency components of the Raman signal from v₃₋₁−Δf to v₃₋₁+Δf, where Δf is the electronic bandwidth of the optical detector 220. A processor may determine a signal characteristic 162-1 based on the electronic signal resulting from the coherent mixing of the probe beam 120pr at frequency v₃₋₁ and the associated spectral portion of the Raman signal 160. After measuring the Raman signal 160 around the probe frequency v₃₋₁, the probe light source 110pr may change the probe-beam frequency by a frequency change ΔF to the frequency v₃₋₂. The probe frequency v₃₋₂ is equal to v₃₋₁+ΔF, and the frequency change ΔF between adjacent frequencies may be between approximately 10 MHz and approximately 10 GHz. The frequency change ΔF may be a fixed value or may be dynamically adjusted during a measurement of a Raman signal 160. After the probe-beam frequency is changed to v₃₋₂, the probe beam 120pr may be coherently mixed with the spectral portion of the Raman signal 160 around the probe frequency v₃₋₂ (e.g., the spectral portion may include optical frequency components of the Raman signal from v₃₋₂−Δf to v₃₋₂+Δf). A processor may determine a signal characteristic 162-2 based on the electronic signal resulting from the coherent mixing of the probe beam 120pr at frequency v₃₋₂ and the associated spectral portion of the Raman signal 160. After measuring the Raman signal 160 around the probe frequency v₃₋₂, the probe light source 110pr may change the probe-beam frequency by the frequency change ΔF to the frequency v₃₋₃, and a measurement of the Raman signal 160 around the frequency v₃₋₃ may be performed. The Raman spectroscopy system 100 may sequentially change the frequency v₃ of the probe light source and measure a spectral portion of the Raman signal 160 at each frequency until reaching the final probe frequency v₃₋ₙ. During the measurements, the probe-beam frequency v₃ may be tuned so that it avoids overlapping with the frequency v₂ of the Stokes beam to prevent mixing between the probe and Stokes beams.

FIG. 12 illustrates an example Raman spectrum corresponding to the Raman signal of FIG. 11. A Raman spectroscopy system 100 may measure a sample 150 and determine the signal characteristics 162 of the Raman signal 160 in FIG. 11, and the corresponding Raman spectrum in FIG. 12 may represent the Raman spectrum of one or more materials that are part of the sample 150. For example, the sample 150 may include glucose and the peak frequency v₁-v_{RP} of the Raman spectrum may be approximately equal to a frequency Ω of a molecular vibration of glucose. A processor of the Raman spectroscopy system 100 may determine the Raman spectrum in FIG. 12 based on the signal characteristics 162 (and the associated probe-beam frequencies v₃) of the Raman signal 160 in FIG. 11. Each signal characteristic 162 of a Raman signal 160 measured at a probe frequency v₃ may be associated with a Raman frequency shift having a frequency v₁−v₃, where v₁ is the pump-beam frequency. To determine the Raman spectrum, each signal characteristic 162 may be transformed from its Raman-signal frequency v₃ to a corresponding Raman-shift frequency v₁−v₃. For example, the processor may associate the signal characteristic 162-1 at frequency v₃₋₁ in FIG. 11 with a Raman shift having the frequency v₁-v₃₋₁ in FIG. 12. Similarly, the signal characteristic 162-2 at frequency v₃₋₂ in FIG. 11 may be associated with a Raman shift having the frequency v₁-v₃₋₂ in FIG. 12, and the signal characteristic 162-3 at frequency v₃₋₃ in FIG. 11 may be associated with a Raman shift having the frequency v₁-v₃₋₃ in FIG. 12. Additionally, the peak frequency v_{RP} of the Raman signal 160 in FIG. 11 may correspond to the Raman-signal peak in FIG. 12 with a frequency of v₁−v_{RP}, which in turn may correspond to the vibrational frequency Ω of a particular material.

Based on the Raman spectrum in FIG. 12, a processor may determine (i) whether a particular material is present in a sample 150 or (ii) an amount or a concentration of the particular material in the sample 150. For example, the processor may compare one or more peaks, signal characteristics 162, or other features of the Raman spectrum in FIG. 12 to a previously determined Raman spectrum for glucose. If one or more peaks or characteristics 162 of the Raman spectrum in FIG. 12 match or line up with peaks or characteristics of the Raman spectrum for glucose, then the processor may determine that glucose is present in the sample 150. Alternatively, if the Raman spectrum in FIG. 12 is missing one or more peaks or characteristics of the Raman spectrum for glucose, then the processor may determine that little or no glucose is present in the sample 150. As another example, the processor may determine the amount or concentration of glucose in the sample 150 based on the Raman spectrum in FIG. 12. The concentration of glucose in the sample 150 may be related to the amplitude or height of one or more peaks of the Raman spectrum in FIG. 12 (e.g., the glucose concentration may be approximately proportional to the height of one or more Raman peaks). The concentration of glucose may then be determined based at least in part on the height of the Raman peak located at the Raman-shift frequency v₁−v_{RP}.

FIG. 13 illustrates another example Raman signal 160 that is measured at multiple probe frequencies. The probe beam 120pr is tuned to multiple different probe frequencies (v₃₋₁, v₃₋₂, v₃₋₃, . . . v₃₋ₙ) to measure multiple respective signal characteristics (162-1, 162-2, 162-3, . . . 162-n) of the Raman signal 160. The Raman signal 160 in FIG. 13 has a single peak centered at frequency v_{RP} with a spectral linewidth of Δv_{R}. The Raman signal 160 in FIG. 11 has one main peak located at frequency v_{RP} along with multiple smaller peaks located on either side of the main peak. A Raman signal 160 may include a single peak (e.g., as illustrated in FIG. 13) or may include multiple peaks (e.g., as illustrated in FIG. 11).

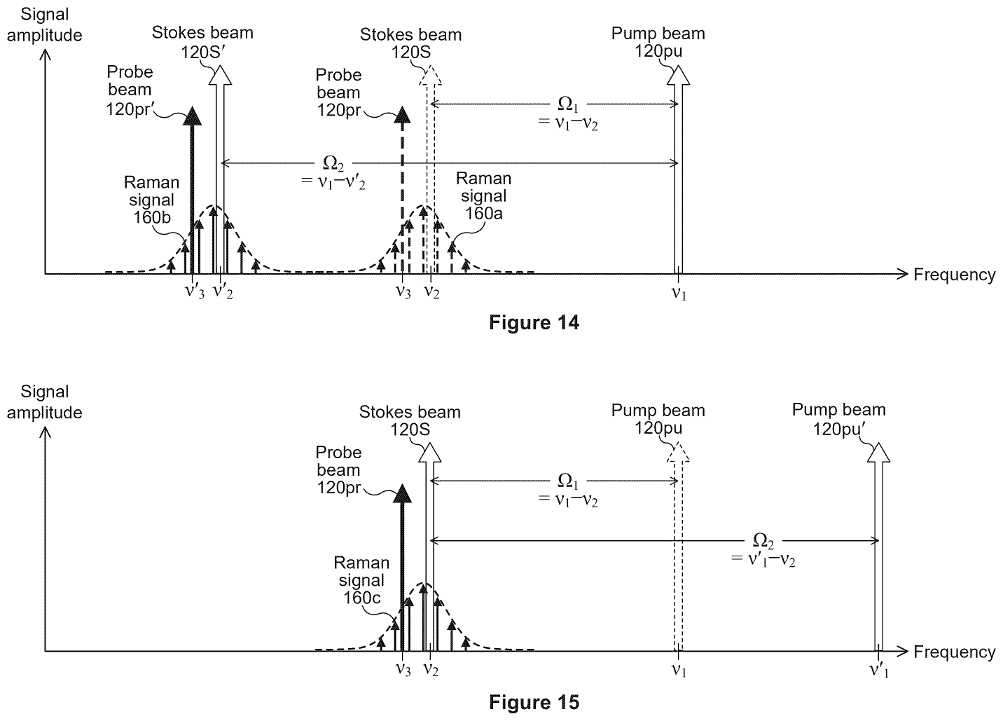

FIGS. 14-15 each illustrates a second example Raman signal obtained by changing the frequency offset Ω between a pump beam 120pu and a Stokes beam 120S. A coherent Raman spectroscopy system 100 may include a pump light source 110pu or a Stokes light source 110S with a wavelength-tunable laser, and the frequency offset Ω may be adjustable by changing the wavelength of the wavelength-tunable laser. A wavelength-tunable pump or Stokes laser may be continuously tunable over a wavelength-tuning range or may be tunable to multiple discrete wavelengths within a wavelength-tuning range. For example, Stokes beam 120 in FIG. 14 may be produced by a continuously tunable laser diode that can produce light at the frequencies ν₂ and ν₂′. As another example, a Stokes laser 110S may include two fixed-wavelength laser diodes that operate at the respective frequencies v₂ and v₂′. Similarly, pump beam 120pu in FIG. 15 may be produced by a continuously tunable laser diode that can produce light at the frequencies ν₁ and ν₁′, or a pump laser 110pu may include two fixed-wavelength laser diodes that operate at the respective frequencies ν₁ and ν₁′.

In FIG. 14, the pump frequency ν₁ is fixed, and the Stokes frequency is changed from ν₂ to ν₂′ to change the frequency offset from Ω₁ to Ω₂. Frequency offset Ω₁ equals ν₁−ν₂, and frequency offset Ω₂ equals ν₁−ν₂′. In FIG. 15, the Stokes frequency ν₂ is fixed, and the pump frequency is changed from ν₁ to ν₁′ to change the frequency offset from Ω₁ to Ω₂. Frequency offset Ω₁ equals ν₁−ν₂, and frequency offset Ω₂ equals ν₁′−ν₂. In other embodiments, both the pump and Stokes frequencies may be changed to change the frequency offset Ω from one value to another.

FIG. 14 includes two Raman signals 160a and 160b. Initially, a Stokes light source 110S may produce a Stokes beam 120S at the frequency ν₂ to produce the frequency offset Ω₁ between the Stokes beam and the pump beam 120pu, where Ω₁=ν₁−ν₂. For example, the Stokes beam 120S may have a frequency v₂ of 193 THz, and the pump beam 120pu may have a frequency v₁ of 207 THz, which corresponds to a frequency offset Ω₁ of 14 THz (or, 467 cm⁻¹). The Raman signal 160a is produced by coherent Raman scattering of the Stokes beam 120S and pump beam 120pu within a sample 150. The Raman signal 160a is centered at or near the frequency v₂ of the Stokes beam 120S, and the frequency v₃ of the probe beam 120pr overlaps the Raman signal 160a and is relatively close to the frequency v₂ of the Stokes beam 120S (e.g., the probe-beam frequency v₃ may be within 200 GHz of the Stokes-beam frequency v₂). The probe beam 120pr and a spectral portion of the Raman signal 160a may be coherently mixed at a detector 220 to produce an electronic signal, from which a signal characteristic 162 may be determined. Additionally, the frequency v₃ of the probe beam 120pr may be tuned across at least a portion of the Raman signal 160a to measure multiple signal characteristics 162 associated with the Raman signal.

After measuring the first Raman signal 160a, the Stokes light source 110S may change the frequency of the Stokes beam to produce a Stokes beam 120S′ at the frequency ν₂′, resulting in a frequency offset of Ω₂ between the Stokes beam 120S′ and the pump beam 120pu, where Ω₂=ν₁−ν₂′. For example, the Stokes beam 120S may be changed to a frequency ν₂′ of 182 THz, and the pump-beam frequency v₁ may remain at 207 THz, which corresponds to a frequency offset Ω₁ of 25 THz (or, 834 cm⁻¹). The second Raman signal 160b is produced by coherent Raman scattering of the Stokes beam 120S′ and pump beam 120pu within the sample 150. The Raman signal 160b is centered at or near the frequency ν₂′ of the Stokes beam 120S′. Additionally, a probe light source 110pr may change the frequency of the probe beam to produce a probe beam 120pr′ at a frequency ν₃′ that overlaps the Raman signal 160b and is relatively close to the frequency ν₂′ of the Stokes beam 120S′ (e.g., the probe-beam frequency ν₃′ may be within 200 GHz of the Stokes-beam frequency ν₂′).

The probe beam 120pr′ and a spectral portion of the Raman signal 160b may be coherently mixed at a detector 220 to produce an electronic signal, from which a signal characteristic 162 may be determined. Additionally, the frequency ν₃′ of the probe beam 120pr′ may be tuned across at least a portion of the second Raman signal 160b to measure multiple signal characteristics 162 associated with the Raman signal.

The two Raman signals 160a and 160b in FIG. 14 may correspond to two respective peaks of a Raman spectrum of a material that is in the sample 150. One Raman peak, associated with Raman signal 160a, is located at a frequency of approximately Ω₁, and the frequency Ω₁ may correspond to a vibrational frequency of the material. The other Raman peak, associated with Raman signal 160b, is located at a frequency of approximately Ω₂, and the frequency Ω₂ may correspond to another vibrational frequency of the material. A Raman spectroscopy system 100 may perform measurements of signal characteristics 162 at 1, 2, 4, 10, 20, or 50 different values of the frequency offset Ω. The frequency offset Ω between the Stokes beam 120S and the pump beam 120pu may be set to each of the different frequency-offset values to produce an associated Raman signal 160. At each value of 0, the frequency v₃ of the probe beam 120pr may be tuned across at least a portion of the Raman signal 160 to measure multiple signal characteristics 162 associated with the Raman signal. Then, the frequency of the Stokes beam or pump beam may be adjusted to the next value of 0, where another measurement of an associated Raman signal 160 is performed. Based on the signal characteristics 162 associated with each of the values of the frequency offset Ω, a processor may determine (i) whether a particular material is present in a sample or (ii) an amount or a concentration of the particular material in the sample.

FIG. 15 includes the Raman signal 160c. A first Raman signal (similar to Raman signal 160a in FIG. 14) may be approximately overlapped with the second Raman signal 160c in FIG. 15, and for clarity, the first Raman signal is not included in FIG. 15. Initially, a Stokes light source 110S may produce a Stokes beam 120S at the frequency ν₂, and a pump light source 110pu may produce a pump beam 120pu at the frequency ν₁, which results in the frequency offset Ω₁ between the Stokes and pump beams in FIG. 15. For example, the Stokes beam 120S may have a frequency v₂ of 193 THz, and the pump beam 120pu may have a frequency v₁ of 207 THz, which corresponds to a frequency offset Ω, of 14 THz (or, 467 cm⁻¹). A first Raman signal (similar to Raman signal 160a in FIG. 14) is produced by coherent Raman scattering of the Stokes beam 120S and pump beam 120pu within a sample 150. The first Raman signal may be centered at or near the frequency v₂ of the Stokes beam 120S, and the frequency v₃ of the probe beam 120pr may overlap the first Raman signal and may be relatively close to the frequency v₂ of the Stokes beam of light 120S. The probe beam 120pr and a spectral portion of the first Raman signal may be coherently mixed at a detector 220 to produce an electronic signal, from which a signal characteristic 162 may be determined. Additionally, the frequency v₃ of the probe beam 120pr may be tuned across at least a portion of the first Raman signal to measure multiple signal characteristics 162 associated with the first Raman signal.

In FIG. 15, after measuring the first Raman signal, the pump light source 110pu may change the frequency of the pump beam 120pu from v₁ to ν₁′. This results in a frequency offset of Ω₂ between the Stokes beam 120S and the pump beam 120pu′, where Ω₂=ν₁′−ν₂. For example, the pump beam may be changed to a frequency v₁ of 218 THz, and the Stokes-beam frequency v₂ may remain at 193 THz, which corresponds to a frequency offset Ω₁ of 25 THz (or, 834 cm⁻¹). The second Raman signal 160c is produced by coherent Raman scattering of the Stokes beam 120S and pump beam 120pu′ within the sample 150. As with the first Raman signal, the Raman signal 160c is centered at or near the frequency v₂ of the Stokes beam 120S, and the frequency v₃ of the probe beam 120pr overlaps the Raman signal 160c and is relatively close to the frequency v₂ of the Stokes beam of light 120S (e.g., the probe-beam frequency v₃ may be within 200 GHz of the Stokes-beam frequency v₂). The probe beam 120pr and a spectral portion of the Raman signal 160c may be coherently mixed at a detector 220 to produce an electronic signal, from which a signal characteristic 162 may be determined. Additionally, the frequency v₃ of the probe beam 120pr may be tuned across at least a portion of the Raman signal 160c to measure multiple signal characteristics 162 associated with the Raman signal.

In FIG. 15, the first Raman signal (which may be similar to Raman signal 160a in FIG. 14) and the second Raman signal 160c may correspond to two different peaks of a Raman spectrum of a material that is in the sample 150. One Raman peak, associated with the first Raman signal, is located at a frequency of approximately Ω₁, and the frequency Ω₁ may correspond to a vibrational frequency of the material. The other Raman peak, associated with Raman signal 160c, is located at a frequency of approximately Ω₂, and the frequency Ω₂ may correspond to another vibrational frequency of the material. Based at least in part on the signal characteristics 162 associated with the two frequency offsets Ω₁ and Ω₂, a processor may determine (i) whether a particular material is present in a sample or (ii) an amount or a concentration of the particular material in the sample.

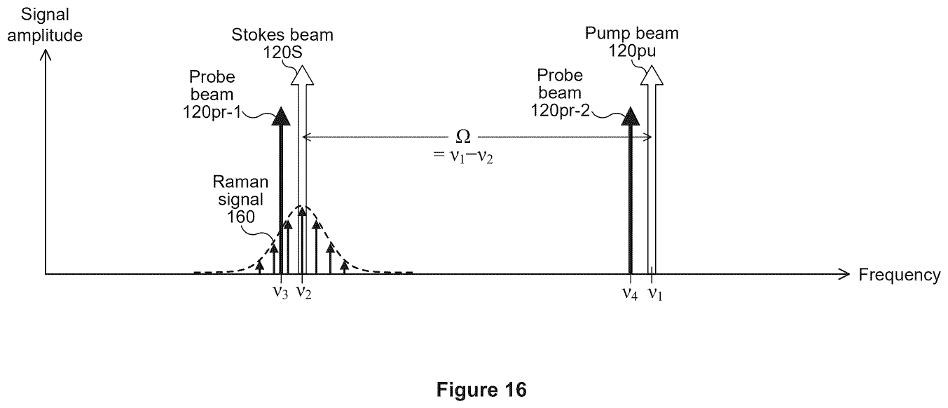

FIG. 16 illustrates an example Raman signal 160 along with two probe beams of light 120pr-1 and 120pr-2. The Raman signal 160 may be produced by coherent Raman scattering of the pump beam 120pu and Stokes beam 120S within a sample 150. The frequency of the pump beam 120pu is v₁, and the frequency of the Stokes beam 120S is v₂, which corresponds to a frequency offset Ω equal to v₁−v₂. The Raman signal 160 is centered at or near the frequency v₂ of the Stokes beam 120S (e.g., the center frequency of the Raman signal 160 may be within 200 GHz of v₂). The first probe beam 120pr-1 may be used to measure the Raman signal 160, and the second probe beam 120pr-2 may be used to measure the pump beam 120pu.

The frequency v₃ of first probe beam 120pr-1 overlaps the Raman signal 160 and is relatively close to the frequency v₂ of the Stokes beam 120S (e.g., v₃ may be within 200 GHz of V₂). The probe beam 120pr-1 and a spectral portion of the Raman signal 160 may be coherently mixed at a detector 220 to produce an electronic signal, from which a signal characteristic 162 may be determined. Additionally, the frequency v₃ of the probe beam 120pr-1 may be tuned across at least a portion of the Raman signal 160 to measure multiple signal characteristics 162 associated with the Raman signal.

The frequency v₄ of the second probe beam 120pr-2 is relatively close to the frequency v₁ of the pump beam 120pu (e.g., v₄ may be within 50 GHz of v₁). For example, the frequency v₄ of the second probe beam 120pr-2 may be offset from the frequency v₁ of the pump beam 120pu by approximately 10 GHz, 5 GHz, or 1 GHz. Alternatively, the frequency v₄ of the second probe beam 120pr-2 may be approximately equal to the frequency v₁ of the pump beam 120pu. After the pump beam 120pu has interacted with the sample, the probe beam 120pr-2 may be coherently mixed with the pump beam. For example, after the pump and Stokes beams have produced the Raman signal 160 and after the pump beam has exited the sample, the pump and probe beams may be coherently mixed together at a detector 220 to produce an electronic signal, from which a signal characteristic may be determined.

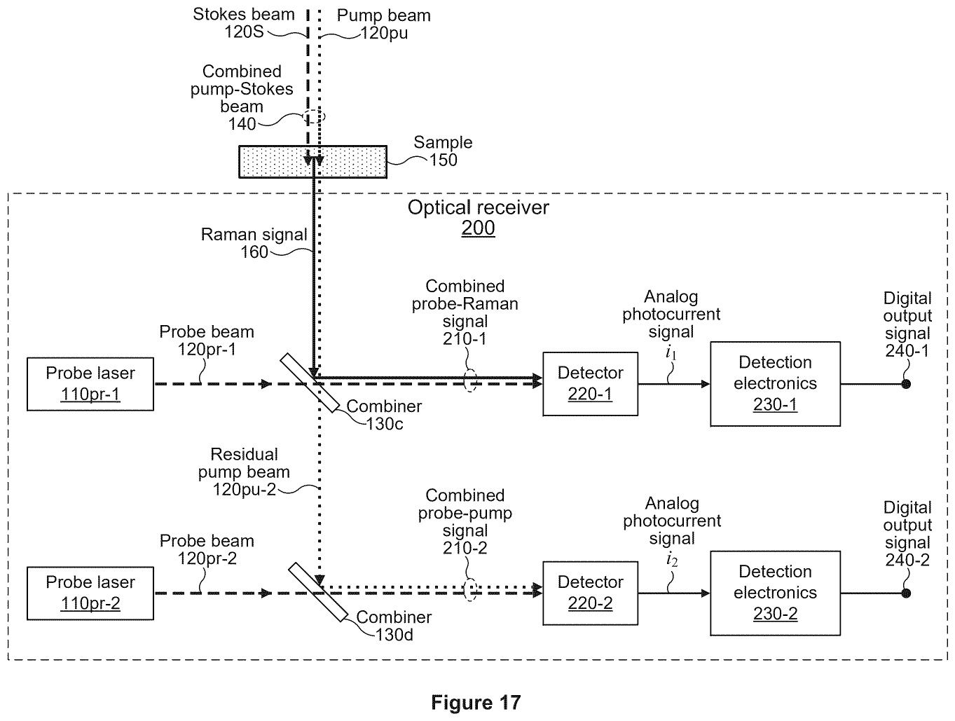

FIG. 17 illustrates an example optical receiver 200 for measuring the Raman signal 160 and pump beam of light 120pu from FIG. 16. The combined pump-Stokes beam 140 (which includes pump beam 120pu and Stokes beam 120S) is directed to a sample 150, which produces a Raman signal 160 in response to the pump and Stokes beams. The Raman signal 160 may be collected by one or more optical elements and directed to the optical receiver 200. Additionally, residual light from the pump beam 120pu may be collected and directed to the optical receiver 200 as a residual pump beam 120pu-2. The residual pump beam 120pu-2 may include light from the pump beam 120pu after the pump beam has interacted with and exited the sample 150. The optical receiver 200 in FIG. 17 may be referred to as a two-channel optical receiver that includes two parallel measurement channels for separately detecting and measuring the Raman signal 160 and the residual pump beam 120pu-2. The first measurement channel detects the Raman signal 160 and includes probe laser 110pr-1, detector 220-1, and detection electronics 230-1. The second measurement channel detects the residual pump beam 120pu-2 and includes probe laser 110pr-2, detector 220-2, and detection electronics 230-2.

The Raman signal 160 and the residual pump beam 120pu-2 are directed to the combiner 130c, which may be a dichroic beamsplitter, and the combiner 130c reflects the Raman signal 160 and transmits the residual pump beam 120pu-2. The combiner 130c also transmits at least a portion of the probe beam 120pr-1 produced by the probe laser 110pr-1 and combines the probe beam 120pr-1 with the Raman signal 160 to produce a combined probe-Raman signal 210-1. The probe-Raman signal 210-1 is sent to the detector 220-1, where the probe beam 120pr-1 and a spectral portion of the Raman signal 160 are coherently mixed to produce a photocurrent signal i₁. The detection electronics 230-1 receives the photocurrent signal i₁ and produces a digital output signal 240-1 that corresponds to the photocurrent signal i₁.

The combiner 130d (which may be a dichroic or a non-dichroic beamsplitter) reflects at least a portion of the residual pump beam 120pu-2 and transmits at least a portion of the probe beam 120pr-2 produced by the probe laser 110pr-2. The combiner 130d combines the probe beam 120pr-2 with the residual pump beam 120pu-2 to produce a combined probe-pump signal 210-2, which is sent to the detector 220-2. The probe beam 120pr-2 and the residual pump beam 120pu-2 are coherently mixed at the detector 220-2 to produce a photocurrent signal i₂, and the detection electronics 230-2 produces a digital output signal 240-2 that corresponds to the photocurrent signal i₂.

The two digital output signals 240-1 and 240-2 may be sent to a processor which determines a signal characteristic 162 of each of the photocurrent signals i₁ and i₂ based on the digital output signals. Additionally, the frequency of the first probe beam 120pr-1 may be tuned across at least a portion of the Raman signal 160 to measure multiple signal characteristics 162 associated with the Raman signal. If the frequency v₁ of the pump beam 120pu remains fixed, the frequency v₄ of the second probe beam 120pr-2 may also remain fixed. Alternatively, if the frequency v₁ of the pump beam 120pu is changed (e.g., to switch to a different frequency offset Ω), the frequency of the probe beam 120pr-2 may also be switched to maintain a particular frequency offset between the pump and probe frequencies.

Measurement of the residual pump beam 120pu-2 may be performed two or more times to determine how the power of the pump beam changes when the Raman signal 160 is produced. For example, the residual pump beam 120pu-2 may be measured once when the Stokes beam 120S is turned off (and no Raman signal 160 is produced) and another time when the Stokes beam is turned on (and the Raman signal 160 is produced). A processor may determine the change in the power of the residual pump beam 120pu-2 associated with the Stokes beam 120S being turned off and on. Since at least part of the Raman signal 160 may be produced by Stokes-shifted photons from the pump beam 120pu, a decrease in the power of the residual pump beam 120pu-2 may correspond to the power of the Raman signal.

In another embodiment of a two-channel optical receiver, the optical receiver may not include a second probe laser 110pr-2. Instead, the residual pump beam 120pu-2 may be sent to a detector 220 for direct detection without mixing the residual pump beam with another signal.

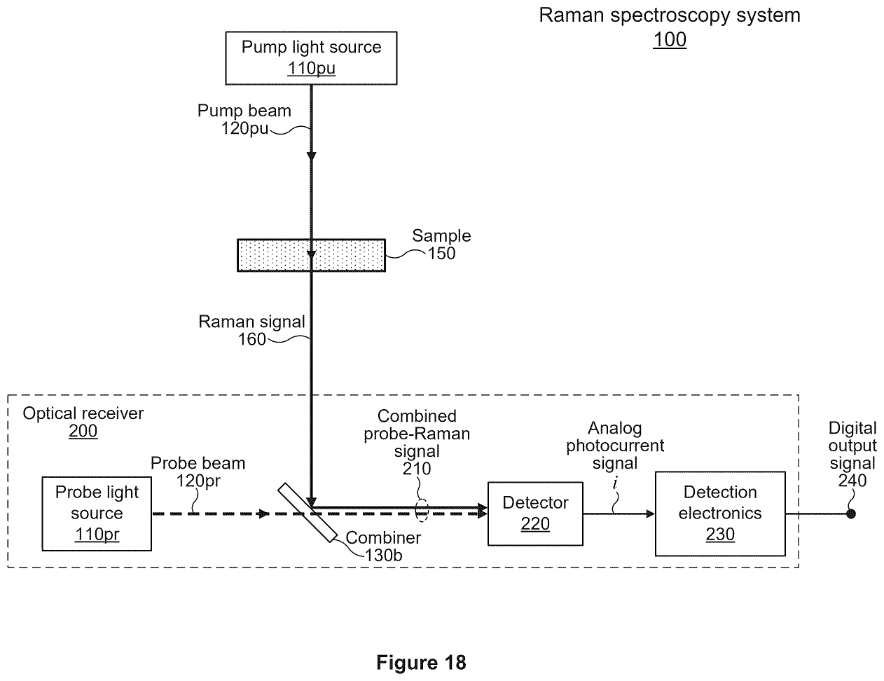

FIG. 18 illustrates an example Raman spectroscopy system 100 for measuring a Raman signal 160 produced by spontaneous Raman scattering. Instead of producing a Raman signal by coherent Raman scattering of pump and Stokes beams within a sample (e.g., as illustrated in FIGS. 1-2), the Raman signal 160 in FIG. 18 is produced by spontaneous Raman scattering of the pump beam of light 120pu within the sample 150. While the production of the Raman signal 160 in FIG. 18 is different from that of the Raman spectroscopy systems of FIGS. 1-2, the optical receiver 200 and the Raman-signal detection technique in FIG. 18 is similar to that of FIGS. 1-2. In FIG. 18, the Raman signal 160 is detected by coherently mixing the Raman signal with a probe beam of light 120pr.

The Raman spectroscopy system 100 in FIG. 18 includes a pump light source 110pu that produces a pump beam of light 120pu at a pump frequency v₁. The pump beam 120pu is directed to a sample 150 (e.g., by one or more optical elements), and the sample 150 produces a Raman signal 160 by spontaneous Raman scattering of light from the pump beam. The spontaneous Raman signal 160 is collected (e.g., by one or more optical elements) and directed to the optical receiver 200. The optical receiver 200 includes a probe light source 110pr that produces a probe beam of light 120pr at a probe frequency v₃, where the probe frequency overlaps the Raman signal. The optical combiner 130b, which may be a dichroic or a non-dichroic beamsplitter, combines the Raman signal 160 and the probe beam 120pr to produce a combined probe-Raman signal 210 that is directed to a detector 220. The detector 220 coherently mixes a spectral portion of the Raman signal 160 with the probe beam 120pr to produce a photocurrent signal i. The detection electronics 230 may produce (i) an analog voltage signal that corresponds to the photocurrent signal i and (ii) a digital output signal 240 that corresponds to the photocurrent signal or the voltage signal. The digital output signal 240 may be sent to a processor, and the processor may determine a signal characteristic 162 of the photocurrent signal or voltage signal based on the digital output signal 240.

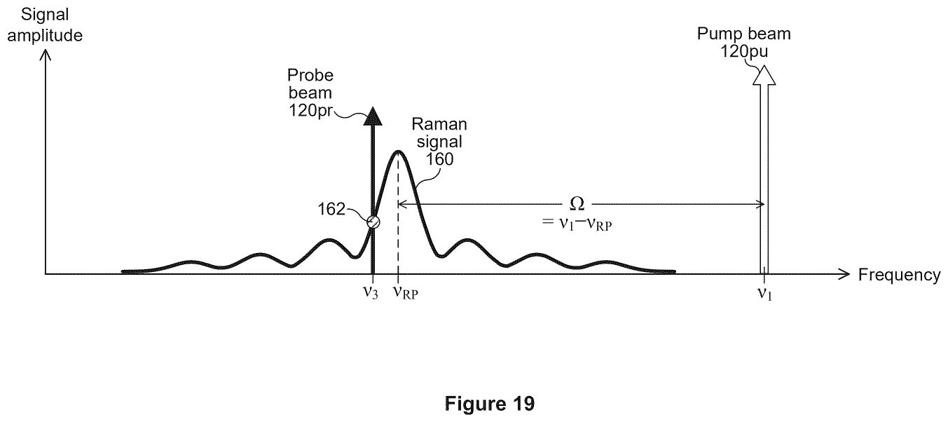

FIG. 19 illustrates an example Raman signal produced by the Raman spectroscopy system of FIG. 18. The Raman signal 160 produced by spontaneous Raman scattering of the pump beam 120pu has a peak frequency of v_{RP}. The frequency offset Ω between the pump beam and the peak frequency of the Raman signal equals v₁−v_{RP}, and the frequency offset Ω may correspond to a vibrational frequency of a material that is part of the sample 150. In FIG. 19, the probe beam 120pr may be coherently mixed with a spectral portion of the Raman signal 160 that is within a particular frequency range of the probe frequency v₃ to measure one signal characteristic 162. Additionally, the probe light source 110pr in FIG. 18 may include a wavelength-tunable laser that tunes the probe beam 120pr to multiple frequencies across at least a portion of the Raman signal 160, and the optical receiver 200 may measure multiple respective signal characteristics 162 associated with the Raman signal.

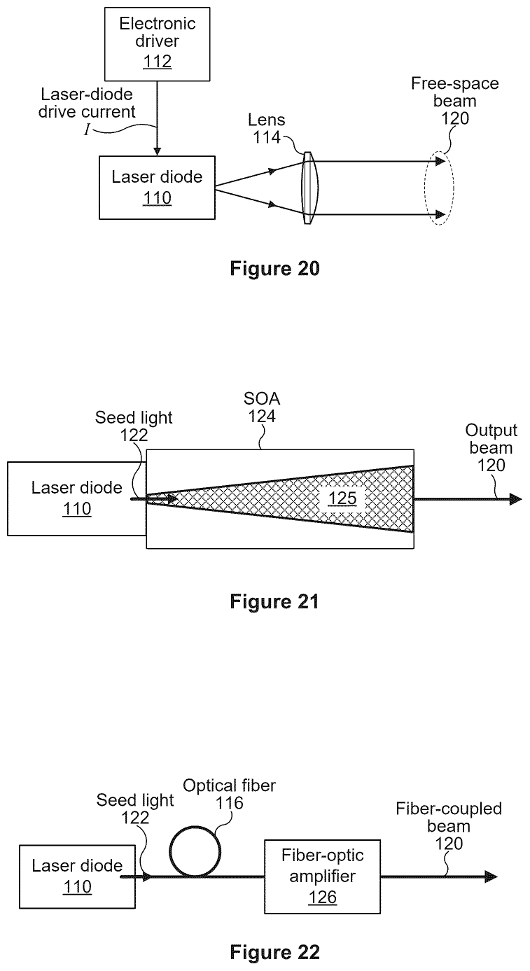

FIG. 20 illustrates an example laser diode 110 that produces a free-space beam of light 120. The laser diode 110 in FIG. 20 may be part of a pump light source 110pu, a Stokes light source 110S, or a probe light source 110pr, and the free-space beam 120 may be a pump beam 120pu, a Stokes beam 120S, or a probe beam 120pr. For example, the probe laser 110pr in FIG. 2 may be similar to the laser diode 110 in FIG. 20, and the probe laser 110pr may produce a free-space probe beam 120pr that is combined with the Raman signal 160 by a free-space beam combiner 130b. In FIG. 20, the electronic driver 112 supplies laser-diode drive current I to the laser diode 110, and the laser diode produces output light that is collimated by a lens 114 to produce a collimated free-space beam 120. In other embodiments, a lens 114 may produce a focused free-space beam 120 (e.g., the lens may focus the free-space beam onto a sample 150). The laser current I supplied to the laser diode 110 may be a substantially constant DC current resulting in an output beam of light 120 having a substantially constant optical power. Additionally or alternatively, the laser current I may include pulses of current resulting in an output beam 120 that includes corresponding pulses of light.

The output beam of light 120 produced by the laser diode 110 may have a spectral linewidth of less than approximately 200 MHz, 100 MHz, 50 MHz, 10 MHz, 1 MHz, or 100 kHz. The laser diode 110 in FIG. 20 may be a wavelength-tunable laser diode where the wavelength of the output beam 120 is adjustable over a wavelength range having a width between approximately 10 nm and approximately 100 nm. For example, the operating wavelength of the laser diode 110 may be tunable over at least a portion of one of the following wavelength ranges: 1000 nm to 1100 nm; 1220 nm to 1450 nm; 1490 nm to 1570 nm; 1600 nm to 1690 nm. Alternatively, the laser diode 110 in FIG. 20 may be a fixed-wavelength laser diode. For example, the laser diode 110 in FIG. 20 may be a distributed feedback (DFB) laser diode with a spectral linewidth of less than 1 MHz, and the output beam 120 may have any suitable substantially fixed wavelength between approximately 600 nm and approximately 2000 nm.

FIG. 21 illustrates an example laser diode 110 that produces seed light 122 that is amplified by a semiconductor optical amplifier (SOA) 124. Instead of directly emitting an output beam 120 (e.g., as illustrated in FIG. 20), the light from a laser diode 110 may first be amplified by an optical amplifier. The laser diode 110 in FIG. 21 acts as a seed laser that produces seed light 122 that is coupled into the input end of the waveguide 125 of the SOA 124. The SOA waveguide 125 in FIG. 21 is indicated by the cross-hatched region within the SOA 124. The SOA 124 amplifies the seed light as it propagates within the waveguide from the input end to the output end, and the output beam of light 120 is emitted from the output end of the SOA. The optical gain provided by the SOA may come from electrical current that is supplied to the SOA by an electronic driver (not illustrated in FIG. 21). For example, an electronic driver 112 may supply substantially constant DC electrical current to the laser diode 110 and to the SOA 124, and the resulting output beam 120 may have substantially constant optical power. The output beam 120 may be a free-space beam, or the output beam 120 may be coupled into an optical fiber or into a waveguide of a photonic integrated circuit (PIC).

The laser diode 110 and the SOA 124 in FIG. 21 may be fabricated or integrated together on the same chip so that seed light 122 from the laser diode is directly coupled into the waveguide 125 of the SOA. The waveguide 125 of the SOA 124 may be a tapered optical waveguide (as illustrated in FIG. 21) with a width that increases along a lateral direction from the input end that receives the seed light 122 to the output end that emits the output beam 120. A light source that includes a seed laser diode 110 that supplies seed light 122 that is amplified by a SOA 124 (as illustrated in FIG. 21) may be referred to as a master-oscillator power-amplifier laser (MOPA laser). The seed laser diode 110 may be referred to as a master oscillator, and the SOA 124 may be referred to as a power amplifier. The MOPA laser in FIG. 21 may be part of a pump light source 110pu, a Stokes light source 110S, or a probe light source 110pr, and the output beam of light 120 may be a pump beam 120pu, a Stokes beam 120S, or a probe beam 120pr.

FIG. 22 illustrates an example laser diode 110 that produces seed light 122 that is amplified by a fiber-optic amplifier 126. The laser diode 110 in FIG. 22 acts as a seed laser that produces seed light 122 that is coupled into an optical fiber 116. The optical fiber 116 directs the seed light 122 to the fiber-optic amplifier 126, and the fiber-optic amplifier amplifies the seed light as it propagates through an optical gain fiber of the fiber-optic amplifier. The optical gain fiber may be doped with rare-earth ions (e.g., neodymium, erbium, or ytterbium) that provide the optical gain to the seed light. One or more pump lasers may optically pump the rare-earth ions, which in turn provide optical amplification to the seed light 122 propagating through the gain fiber. The amplified seed light produced by the fiber-optic amplifier 126 propagates in an optical fiber as a fiber-coupled output beam 120. The laser diode 110 and fiber-optic amplifier 126 in FIG. 22 may be part of a pump light source 110pu, a Stokes light source 110S, or a probe light source 110pr, and the fiber-coupled output beam 120 may be directed to an optical combiner 130, a sample 150, or a detector 220.

A pump light source 110pu, a Stokes light source 110S, or a probe light source 110pr may include a seed laser diode 110 followed by an optical amplifier. The seed laser diode 110 may produce seed light 122 that is amplified by the optical amplifier to produce an output beam of light 120. An optical amplifier may include a SOA 124 (e.g., as illustrated in FIG. 21) or a fiber-optic amplifier 126 (e.g., as illustrated in FIG. 22). In some embodiments, an optical amplifier may include a SOA 124 followed by a fiber-optic amplifier 126. For example, a seed laser diode 110 may produce seed light 122 that is first amplified by a SOA 124 and then further amplified by a fiber-optic amplifier 126.

In some embodiments, a pump light source 110pu, a Stokes light source 110S, or a probe light source 110pr may include a laser diode 110 and an optical fiber 116 and may not include a fiber-optic amplifier. For example, light produced by a laser diode 110 may be coupled into an optical fiber 116 to produce a fiber-coupled beam 120, and the optical fiber may direct the laser-diode light to an optical combiner 130, a sample 150, or a detector 220. A laser diode 110 that produces a fiber-coupled beam 120 may be referred to as a fiber-coupled laser diode.

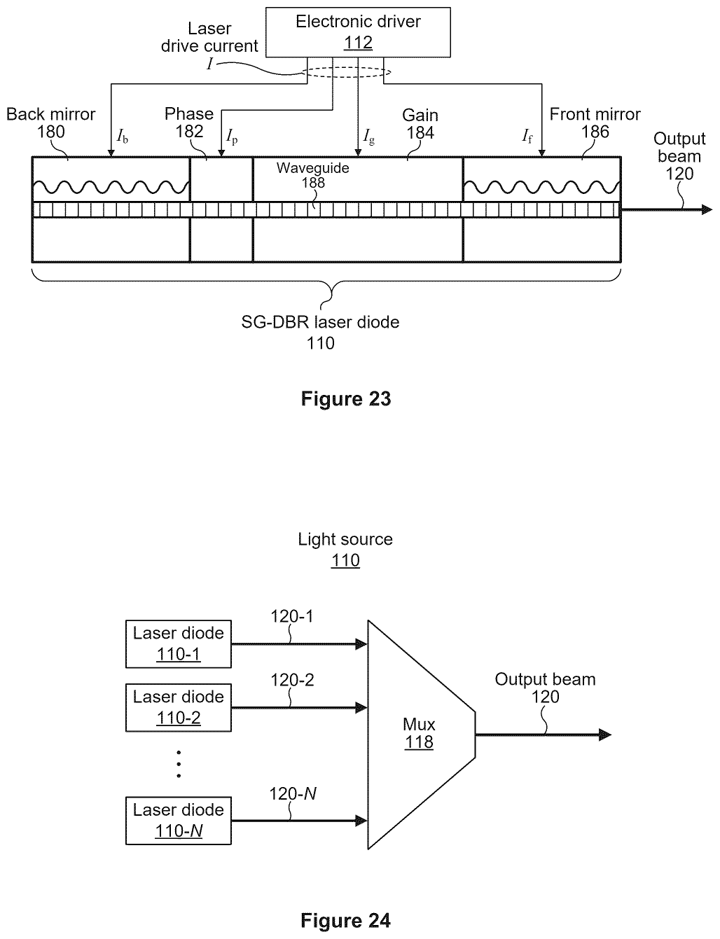

FIG. 23 illustrates an example sampled-grating distributed Bragg reflector (SG-DBR) laser 110. An SG-DBR laser 110 is a wavelength-tunable laser diode that produces an output beam 120 that can be tuned over a wavelength range having a width of between 20 nm and 50 nm. For example, an SG-DBR laser 110 may have a 40-nm wavelength-tuning range from approximately 1530 nm to approximately 1570 nm or from approximately 1630 nm to approximately 1670 nm. The SG-DBR laser 110 in FIG. 23 may be part of a pump light source 110pu, a Stokes light source 110S, or a probe light source 110pr, and the output beam 120 may be a pump beam 120pu, a Stokes beam 120S, or a probe beam 120pr. For example, an SG-DBR laser 110 may be part of a probe light source 110pr that produces the probe beam 120pr in FIG. 6, and the SG-DBR laser may tune the frequency v₃ of the probe beam across at least a portion of the Raman signal 160. An SG-DBR laser 110 may produce a free-space beam 120, a fiber-coupled beam 120, or a beam that is coupled into a waveguide of a PIC. Alternatively, an SG-DBR laser 110 may be integrated with a SOA 124 that amplifies the light produced by the SG-DBR laser (e.g., as illustrated in FIG. 21).

The SG-DBR laser 110 in FIG. 23 includes a back mirror 180, a phase section 182, a gain section 184, and a front mirror 186, where the phase and gain sections are located between the front and back mirrors. The laser diode current I supplied to the SG-DBR laser 110 includes the following: current I_{b} supplied to the back mirror 180, current Iₚ supplied to the phase section 182, current I_{g} supplied to the gain section 184, and current I_{f} supplied to the front mirror 186. The gain current I_{g} provides optical gain to the optical waveguide 188 of the SG-DBR laser 110, and the other currents may be used to set the wavelength of the output beam 120 produced by the SG-DBR laser. The electronic driver 112 may supply particular combinations of electrical currents to the back mirror 180, phase section 182, gain section 184, and front mirror 186, where each particular combination of electrical currents causes the SG-DBR laser 110 to produce an output beam 120 at a particular wavelength. For example, an SG-DBR laser 110 may be part of a wavelength-tunable probe light source 110pr that produces the probe beam 120pr in FIG. 11, and the electronic driver 112 may supply particular different combinations of the electrical currents I_{b}, Iₚ, I_{g}, and I_{f} to produce the different probe frequencies v₃₋₁, v₃₋₂, v₃₋₃, . . . and v₃₋ₙ to tune the probe beam across at least a portion of the Raman signal 160 in FIG. 11.

FIG. 24 illustrates an example light source 110 with multiple laser diodes 110 and an optical multiplexer 118 that combines light produced by the laser diodes into a single output beam of light 120. Each of the laser diodes 110-1, 110-2, . . . 110-N produces a respective output beam 120-1, 120-2, . . . 120-N, and the optical multiplexer 118 combines the output beams into the output beam of light 120. The light source 110 may be configured to switch between operating the N laser diodes one at a time so that, at any given time, only one laser diode produces light, and the output beam 120 includes just the light produced by that one laser diode.

The optical multiplexer 118 may be a free-space device, a fiber-optic device, a waveguide-based device, or a metamaterial-based device, and the multiplexer may combine N different wavelengths of light from the N laser diodes into a single output beam 120. The optical multiplexer 118 may include one or more of the following: a free-space diffraction grating; an arrayed waveguide grating (AWG); a metamaterial that acts as a diffractive optical element; one or more optical filters; one or more optical combiners; one or more optical switches (e.g., thermo-optic switches, liquid crystal switches, or microelectromechanical systems (MEMS) switches); a series of two or more fiber Bragg gratings with optical circulators.

The light source 110 in FIG. 24 may be a pump light source 110pu, a Stokes light source 110S, or a probe light source 110pr, and the output beam 120 may be a pump beam 120pu, a Stokes beam 120S, or a probe beam 120pr. The output beam 120 may be a free-space beam, or the output beam 120 may be coupled into an optical fiber or into a waveguide of a photonic integrated circuit (PIC). For example, each of the laser diodes 110-1, 110-2, . . . 110-N may produce a fiber-coupled beam 120-1, 120-2, . . . 120-N, and the optical multiplexer 118 may be a fiber-optic device that produces a fiber-coupled output beam 120. The output beam 120 may be sent to an optical combiner 130, a sample 150, or a detector 220. Alternatively, the light source 110 may include an optical amplifier (e.g., an SOA or a fiber-optic amplifier) located after the optical multiplexer 118, and the output beam 120 may be coupled from the multiplexer to an optical amplifier that provides optical amplification to the output beam.

The light source 110 in FIG. 24 includes N laser diodes 110-1, 110-2, . . . 110-N, where N is an integer greater than or equal to 2. Each of the N laser diodes 110 in FIG. 24 may be a wavelength-tunable laser diode or a fixed-wavelength laser diode. For example, the light source in FIG. 24 may include (i) N wavelength-tunable laser diodes, (ii) N fixed-wavelength laser diodes, or (iii) one or more wavelength-tunable laser diodes and one or more fixed-wavelength laser diodes. The light source 110 in FIG. 24 may be referred to as a wavelength-tunable light source, a frequency-tunable light source, or a tunable light source. A wavelength-tunable light source may include one or more continuously tunable laser diodes (e.g., SG-DBR laser diodes); multiple fixed-wavelength laser diodes (e.g., multiple DFB laser diodes), each laser diode operating at a different wavelength; or any combination thereof.

The light source 110 in FIG. 24 may be a pump light source 110pu or a Stokes light source 110S that includes N fixed-wavelength laser diodes, each laser diode having a different operating wavelength. The wavelength of the output beam 120 produced by the wavelength-tunable light source 110 in FIG. 24 may be adjustable to any wavelength of N different wavelengths by selecting one of the N fixed-wavelength laser diodes for operation. The frequency offset Ω between the pump beam 120pu and Stokes beam 120S may be adjustable by selecting one of the fixed-wavelength laser diodes for operation. For example, the Stokes beams 120S and 120S′ in FIG. 14 may be produced by the light source 110 in FIG. 24. Laser diode 110-1 may be a fixed-wavelength laser diode operating at the frequency v₂, and laser diode 110-2 may be a fixed-wavelength laser diode operating at the frequency ν₂′. Selecting laser diode 110-1 for operation produces the frequency offset Ω₁ in FIG. 14, and selecting laser diode 110-2 for operation produces the frequency offset Ω₂.

The light source 110 in FIG. 24 may operate only one of the N laser diodes 110 at any given time. Each of the laser diodes 110 may operate at a particular wavelength or over a particular range of wavelengths, and one of the laser diodes may be selected for operation based on the wavelength that is needed to perform a particular measurement. For example, the pump beams 120pu and 120pu′ in FIG. 15 may be produced by the light source 110 in FIG. 24. Laser diode 110-1 may be a fixed-wavelength laser diode operating at the frequency v₁, and laser diode 110-2 may be a fixed-wavelength laser diode operating at the frequency ν₁′. During a first measurement period, laser diode 110-1 may be operated to produce output beam 120-1 at the frequency v₁, and the other laser diodes 110-2 to 110-N may be turned off or otherwise configured to not produce light. The multiplexer 118 receives the output beam 120-1 from the laser diode 110-1 and directs it to the output of the multiplexer to produce the output beam 120 having a frequency v₁. During a second measurement period, the Raman signal 160c in FIG. 15 may be measured, and laser diode 110-2 may be operated to produce output beam 120-2 at the frequency ν₁′. The other laser diodes (i.e., laser diodes 110-1 to 110-N, excluding laser diode 110-2) may be turned off or otherwise configured to not produce light. The multiplexer 118 receives the output beam 120-2 from the laser diode 110-2 and directs it to the output of the multiplexer to produce the output beam 120 having a frequency ν₁′.

The light source 110 in FIG. 24 may be a probe light source that includes N wavelength-tunable laser diodes. The probe light source may be configured to tune over one or more wavelength ranges having a total width between p·N·Δλₐᵥ and N·Δλₐᵥ, where Δλₐᵥ is an average wavelength-tuning range of the N laser diodes 110, and p is a wavelength-overlap parameter between 0.5 and 1. For example, if the overlap parameter p has a value of 0.7, then the combined wavelength-tuning range of the N wavelength-tunable laser diodes may be between (0.7)N·Δλₐᵥ and N·Δλₐᵥ. The wavelength-overlap parameter p represents the amount of wavelength overlap between adjacent wavelength-tuning ranges (e.g., an overlap value p of 1 indicates that there is no wavelength overlap between the wavelength-tuning ranges). For example, the light source 110 in FIG. 24 may be a probe light source that includes three SG-DBR laser diodes having respective wavelength-tuning ranges of 1490-1530 nm, 1520-1560 nm, and 1550-1590 nm. Each of the SG-DBR laser diodes has a 40-nm tuning range with a 10-nm overlap between adjacent tuning ranges, which results in the light source 110 in FIG. 24 having a 100-nm wavelength-tuning range from 1490 nm to 1590 nm. In this case, the average wavelength-tuning range Δλₐᵥ of the three laser diodes is 40 nm, and the total wavelength-tuning range has a width of 100 nm, which corresponds to the wavelength-overlap parameter p having a value of approximately 0.83. The probe light source 110 may produce an output beam 120 having any wavelength from 1490 nm to 1590 nm by selecting one of the three SG-DBR laser diodes for operation and tuning the laser diode to the desired wavelength. As another example, the light source 110 in FIG. 24 may be a probe light source 110 that includes three SG-DBR laser diodes having respective wavelength-tuning ranges of 1490-1530 nm, 1530-1560, and 1640-1680 nm. Each of the SG-DBR laser diodes has a 40-nm tuning range with no wavelength overlap between adjacent tuning ranges. The average wavelength-tuning range Δλₐᵥ of the three laser diodes is 40 nm, and the total wavelength-tuning range has a width of 120 nm. This corresponds to the wavelength-overlap parameter p having a value of 1, indicating that there is no wavelength overlap between the tuning ranges of the three laser diodes.

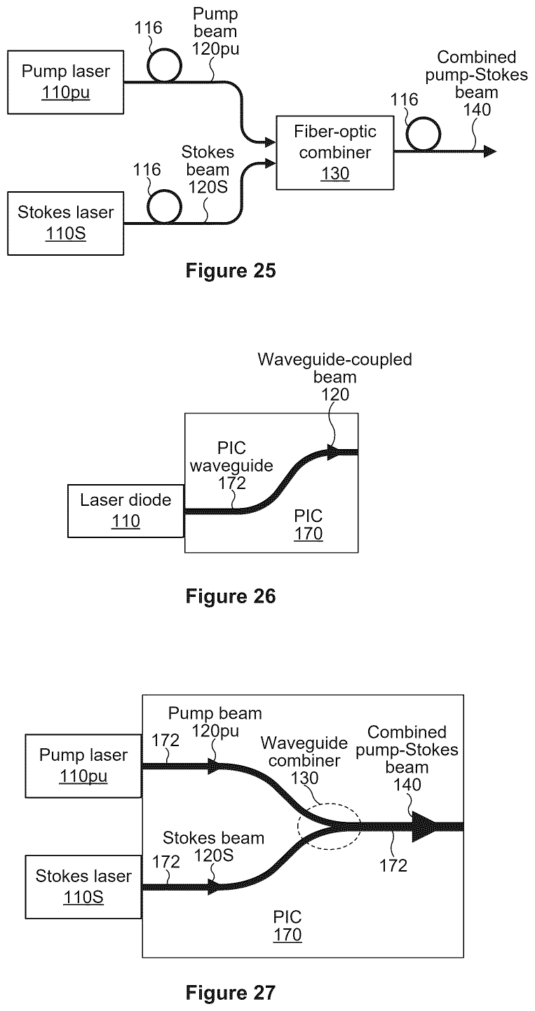

FIG. 25 illustrates an example pump laser 110pu and Stokes laser 110S with a fiber-optic combiner 130 that produces a combined pump-Stokes beam 140 coupled into an optical fiber 116. A Raman spectroscopy system 100 may include one or more optical elements that direct the pump and Stokes beams to a sample 150. The optical elements may include a combiner 130 that combines the pump beam 120pu and the Stokes beam 120S to produce a combined pump-Stokes beam 140 that is directed to a sample 150. In FIG. 1, the combiner 130a may be a free-space optical combiner, and the pump beam 120pu, Stokes beam 120S, and combined beam 140 may each be free-space beams. The combiner 130 in FIG. 25 is a fiber-optic combiner that receives the pump and Stokes beams via two input optical fibers 116 and combines the two beams into a combined pump-Stokes beam 140 that propagates in an output optical fiber 116. The pump laser 110pu may be a fiber-coupled laser diode that produces a pump beam 120pu that is directed to the fiber-optic combiner 130 via an input optical fiber 116. Similarly, the Stokes laser 110S may be a fiber-coupled laser diode that produces a Stokes beam 120S that is directed to the fiber-optic combiner 130 via another input optical fiber 116. The pump laser 110pu or the Stokes laser 110S may be followed by an optical amplifier (not illustrated in FIG. 25) that amplifies the pump beam 120pu or Stokes beam 120S prior to directing the light to the combiner 130. After the fiber-optic combiner 130 combines the pump and Stokes beams, the output optical fiber 116 may direct the combined pump-Stokes beam 140 to a sample 150.

The fiber-optic combiner 130 in FIG. 25 may include a fiber-optic wavelength division multiplexer (WDM) with two input optical fibers (for the pump and Stokes beam) and one output optical fiber for the output beam 120. The WDM may include a dichroic beamsplitter or a fused fiber coupler. Each of the input or output optical fiber 116 may be a single-mode optical fiber or a multi-mode optical fiber.

In some embodiments, instead of using a single pump laser or a single Stokes laser (as illustrated in FIG. 25), a Raman spectroscopy system may use a pump or Stokes light source 110 with multiple laser diodes and an optical multiplexer 118 (e.g., as illustrated in FIG. 24). For example, the light source 110 in FIG. 24 may be a pump light source that produces a fiber-coupled output beam 120 that is coupled to an input fiber of the fiber-optic combiner 130 in FIG. 25. One of the laser diodes of the pump light source may be selected for operation, and the light from the selected laser diode may be directed by the multiplexer 118 to an optical fiber that is coupled to the combiner 130. Additionally or alternatively, the light source 110 in FIG. 24 may be a Stokes light source that produces a fiber-coupled output beam 120 that is coupled to an input fiber of the fiber-optic combiner 130 in FIG. 25.

FIG. 26 illustrates an example laser diode 110 coupled to a waveguide 172 of a photonic integrated circuit (PIC) 170. A PIC 170 (which may be referred to as a planar lightwave circuit (PLC), a waveguide-based device, an integrated-optic device, an integrated optoelectronic device, or a silicon optical bench) may be fabricated from a substrate that includes silicon, indium phosphide, glass (e.g., silica), a polymer, or an electro-optic material (e.g., lithium niobate (LiNbO₃) or lithium tantalate (LiTaO₃)). A PIC 170 may include one or more optical waveguides 172 that confine and guide a beam of light. An optical waveguide 172 that is part of a PIC 170 may be a passive optical waveguide formed in the PIC, and the waveguide may convey light from one optical element to another with relatively low optical loss.

In FIG. 26, light from the laser diode 110 is coupled into the PIC waveguide 172 to produce a waveguide-coupled beam 120. The waveguide 172 may convey the beam of light 120 from the laser diode 110 to another optical element (e.g., an optical combiner 130, a sample 150, or a detector 220). Light from the laser diode 110 in FIG. 26 may be coupled into the waveguide 172 using one or more lenses, or the laser diode 110 may be butt-coupled to an input of the waveguide so that the light from the laser diode is directly coupled into the waveguide. The laser diode 110 may be mechanically attached or connected to the PIC 170 or to a substrate to which the PIC is also attached. For example, the laser diode 110 may be attached using epoxy, adhesive, or solder. Alternatively, the laser diode 110 in FIG. 26 may be located apart from the PIC 170, and the laser diode may send a beam of light 120 to the PIC 170 via optical fiber. An output end of the optical fiber may be attached or connected to the PIC 170 so that the light is coupled into the PIC waveguide 172. Light from the laser diode 110 may be amplified by an optical amplifier (not illustrated in FIG. 26) prior to being coupled into the PIC waveguide 172. For example, the laser diode 110 in FIG. 26 may be a MOPA laser similar to that illustrated in FIG. 21, and the output beam 120 produced by the MOPA laser may be directly coupled into the waveguide 172.

FIG. 27 illustrates an example pump laser 110pu and Stokes laser 110S with a photonic integrated circuit (PIC) 170 that produces a combined pump-Stokes beam 140 coupled into an optical waveguide 172 of the PIC. The PIC 170 includes a waveguide combiner 130 and three optical waveguides 172 (two input waveguides for the pump and Stokes beams and one output waveguide for the combined pump-Stokes beam 140). The waveguide combiner 130 is a waveguide-based optical combiner that combines the pump beam 120pu and the Stokes beam 120S to produce a combined pump-Stokes beam 140. The combined pump-Stokes beam 140 is coupled to an output optical waveguide 172 of the PIC 170, and the output waveguide may direct the beam to a sample 150. The pump laser 110pu or the Stokes laser 110S may be a laser diode that is mechanically attached or connected to the PIC 170 or to a substrate to which the PIC is also attached. Alternatively, the pump laser 110pu or the Stokes laser 110S may be a fiber-coupled laser diode that sends a beam of light to the PIC via optical fiber (e.g., an output end of the optical fiber may be attached to the PIC so that the light is coupled into an input optical waveguide 172).

In some embodiments, instead of using a single pump laser or a single Stokes laser (as illustrated in FIG. 27), a Raman spectroscopy system may use a pump or Stokes light source 110 with multiple laser diodes and an optical multiplexer 118 (e.g., as illustrated in FIG. 24). For example, the light source 110 in FIG. 24 may be a pump or Stokes light source that produces a fiber-coupled output beam 120 that is coupled to an input optical waveguide 172 of the PIC 170 in FIG. 27. Alternatively, the multiplexer 118 in FIG. 24 may be a waveguide-based device and the output beam 120 may propagate in a PIC waveguide that directs the light to an input optical waveguide 172 of the PIC 170 in FIG. 27.

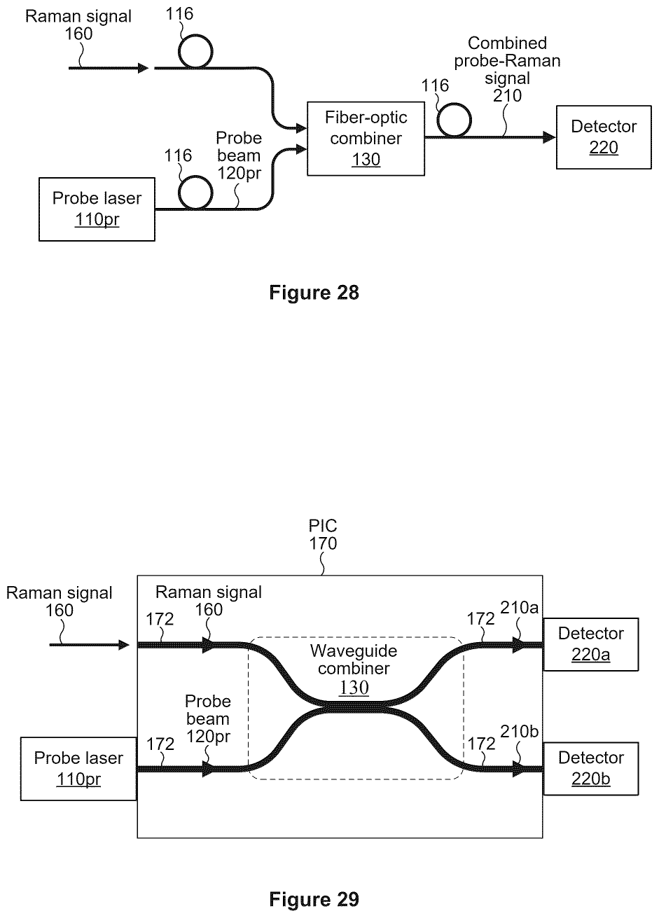

FIG. 28 illustrates an example fiber-optic combiner 130 that combines a Raman signal 160 with a probe beam 120pr. An optical receiver 200 may include an optical combiner 130 that combines a Raman signal 160 and a probe beam of light 120pr to produce one or more combined probe-Raman signals 210 that are each directed to a detector 220. In FIG. 1, the combiner 130b may be a free-space optical combiner, and the Raman signal 160, probe beam 120pr, and the combined probe-Raman signal 210 may each be free-space beams. The combiner 130 in FIG. 28 is a fiber-optic combiner that receives the Raman signal 116 and the probe beam 120pr via two input optical fibers 116 and combines the two beams into a combined probe-Raman signal 210 that is directed to a detector 220 via an output optical fiber 116. Each of the input or output optical fiber 116 in FIG. 28 may be a single-mode optical fiber or a multi-mode optical fiber.

The Raman signal 160 in FIG. 28 may be a free-space beam that is coupled into an input optical fiber 116 using one or more lenses. The probe laser 110pr may be a fiber-coupled laser diode that directs the probe beam 120pr to the fiber-optic combiner 130 via optical fiber 116. The probe beam 120pr may be amplified by an optical amplifier (not illustrated in FIG. 28) prior to being directed to the combiner 130. In some embodiments, instead of using a single probe laser 110pr (as illustrated in FIG. 28), an optical receiver 200 may use a light source 110 with multiple laser diodes and an optical multiplexer 118 (e.g., as illustrated in FIG. 24). For example, the light source 110 in FIG. 24 may be a probe light source that produces a fiber-coupled output beam 120 that is coupled to an input optical fiber 116 of the fiber-optic combiner 130 in FIG. 28.

FIG. 29 illustrates an example photonic integrated circuit (PIC) 170 with a waveguide combiner 130 that combines a Raman signal 160 with a probe beam 120pr. An optical combiner 130 may be a waveguide combiner 130 that is part of a PIC 170 and may combine a Raman signal 160 and a probe beam of light 120pr to produce one or more combined probe-Raman signals 210 that are each directed to a detector 220. The waveguide combiner 130 in FIG. 29 receives the Raman signal 160 and the probe beam 120pr via two input waveguides 172. A waveguide combiner 130 may produce 1, 2, or 4 combined output beams 210. The waveguide combiner 130 in FIG. 29 combines the Raman signal 160 and the probe beam 120pr to produce two combined probe-Raman signals 210a and 210b which are each directed to a respective detector 220a and 220b via two output waveguides 172. The PIC 170 in FIG. 29 may be part of an optical receiver 200.

The Raman signal 160 in FIG. 29 may be a free-space beam that is coupled into an input waveguide 172 using one or more lenses. The probe laser 110pr may be a laser diode that is mechanically attached or connected to the PIC 170 or to a substrate to which the PIC is also attached. Alternatively, the probe laser 110pr may be a fiber-coupled laser diode that sends the probe beam 120pr to the PIC 170 via optical fiber (e.g., an output end of the optical fiber may be attached to the PIC so that the light is coupled into an input optical waveguide 172). The probe beam 120pr may be amplified by an optical amplifier (not illustrated in FIG. 29) prior to being coupled into an input optical waveguide 172. In some embodiments, instead of using a single probe laser 110pr (as illustrated in FIG. 29), an optical receiver 200 may use a light source 110 with multiple laser diodes and an optical multiplexer 118 (e.g., as illustrated in FIG. 24), and the probe beam 120pr may be delivered from the multiplexer to the PIC 170 via optical fiber or via a waveguide 172 of the PIC.

A Raman spectroscopy system 100 may include one or more optical elements that (i) direct a pump beam 120pu and a Stokes beam 120S to a sample 150 and (ii) direct a Raman signal 160 and a probe beam 120pr to one or more detectors 220. The optical elements may include one or more PICs 170 that each include one or more optical waveguides 172. One or more of the optical waveguides 172 may direct the pump beam 120 and the Stokes beam 120s to the sample 150. For example, a PIC 170 may include an optical combiner 130 that produces a combined pump-Stokes beam 140 that is directed to the sample by an optical waveguide 172 of the PIC 170. One or more other optical waveguides 172 may direct the Raman signal 160 and the probe beam 120pr to one or more detectors 220. For example, a PIC 170 may include an optical combiner 130 that combines the Raman signal 160 and the probe beam 120pr to produce one or more combined probe-Raman signals 210 that are each directed to a detector 220 by an optical waveguide 172 of the PIC 170.

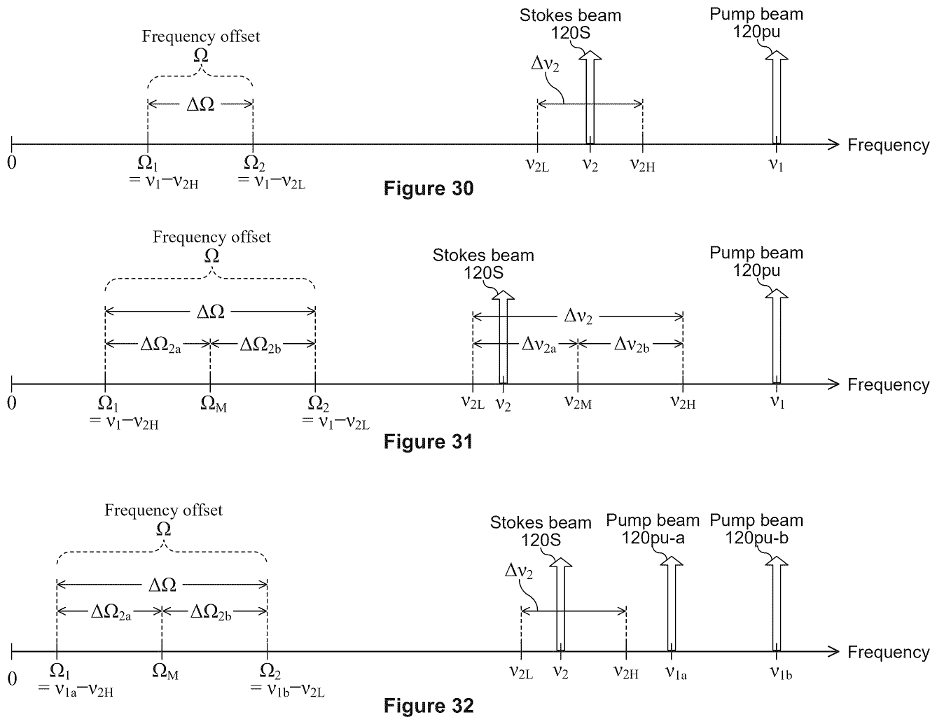

FIGS. 30-35 each illustrates example frequency ranges of a pump beam 120pu and a Stokes beam 120S. The pump beam 120pu may be produced by a pump light source 110pu, and the Stokes beam 120S may be produced by a Stokes light source 110S. The pump and Stokes light sources may each include one or more fixed wavelength laser diodes or one or more wavelength-tunable laser diodes. In each of FIGS. 30-35, the pump beam 120pu and the Stokes beam 120S each have one or more fixed frequencies or one or more frequencies that are adjustable over a particular frequency range. The corresponding frequency offset Ω between the pump and Stokes beams is indicated as a range of frequencies or a set of discrete frequencies that the frequency offset can be set to, based on the frequencies that are available to the pump and Stokes beams. The frequency offset Ω is determined from v₁−v₂, where v₁ is the range or set of fixed frequencies for the pump beam 120pu, and v₂ is the range or set of fixed frequencies for the Stokes beam 120S. The frequency offsets Ω₁, Ω₂, Ω₃, and Ω₄ in FIGS. 30-35 may have any suitable value between approximately 5 THz and approximately 100 THz. The frequency range ΔΩ over which a frequency offset may be varied may have any suitable value between approximately 5 THz and approximately 80 THz.

In FIG. 30, the pump beam 120pu has a single fixed frequency v₁, and the Stokes beam 120S has a frequency v₂ that is adjustable over a frequency range of width Δv₂. The adjustable frequency range Δv₂ of the Stokes beam 120S extends from a low frequency v_{2L} to a high frequency v_{2H}, where Δv₂=v_{2H}−v_{2L}. The pump laser 110pu that produces the pump beam 120pu in FIG. 30 may be a fixed-wavelength laser diode, and the Stokes laser 110S that produces the Stokes beam 120S may be a wavelength-tunable laser diode. The frequency offset C between the pump and Stokes beams may be set to any value between Ω₁ and Ω₂, and the frequency range ΔΩ of the frequency offset is Ω₂−Ω₁. In FIG. 30, the frequency range ΔΩ is also equal to the frequency range Δv₂ of the Stokes beam 120S. When the Stokes beam 120S is set to the lower frequency v_{2L}, the frequency offset between the pump and Stokes beams is v₁−v_{2L}, which is equal to Ω₂. Similarly, when the Stokes beam 120S is set to the upper frequency v_{2H}, the frequency offset between the pump and Stokes beams is v₁−v_{2H}, which is equal to Ω₁.

For example, the pump beam 120pu in FIG. 30 may have a frequency v₁ of 250 THz (corresponding to a wavelength of approximately 1200 nm), and the Stokes beam 120S may be adjustable from a low frequency v_{2L} of 195 THz to a high frequency v_{2H} of 200 THz. This corresponds to a frequency-tuning range Δv₂ of the Stokes beam 120S of 5 THz (167 cm⁻¹ in wavenumbers) and a 38-nm wavelength-tuning range from approximately 1499 nm to approximately 1537 nm. The resulting frequency offset C between the pump and Stokes beams may be set to a value between the lower value Ω₁ of 50 THz (1668 cm⁻¹ in wavenumbers) and the upper value Ω₂ of 55 THz (1835 cm⁻¹ in wavenumbers), corresponding to a frequency range ΔΩ of 5 THz (167 cm⁻¹ in wavenumbers).

In FIG. 31, the pump beam 120pu has a single fixed frequency v₁, and the Stokes beam 120S has a frequency v₂ that is adjustable over a frequency range of width Δv₂. The adjustable frequency range Δv₂ of the Stokes beam 120S extends from a low frequency v_{2L} to a high frequency v_{2H}, where Δv₂=v_{2H}−v_{2L}. The pump laser 110pu that produces the pump beam 120pu in FIG. 31 may be a fixed-wavelength laser diode. The Stokes light source 110S that produces the Stokes beam 120S may include two wavelength-tunable laser diodes. For example, the Stokes light source 110S may be similar to the light source in FIG. 24 where two wavelength-tunable laser diodes are combined by a multiplexer 118. A first wavelength-tunable laser diode may operate from frequency v_{2L} to frequency v_{2M}, and a second wavelength-tunable laser diode may operate from frequency v_{2M} to frequency v_{2H}. The total tuning range Δv₂ of the Stokes laser 110S equals the sum of the tuning ranges Δv₂ₐ and Δv_{2b} of the two wavelength-tunable laser diodes. In other embodiments, if the tuning ranges of the two wavelength-tunable laser diodes overlap, the total tuning range Δv₂ of the Stokes light source 110S will be reduced by the amount of frequency overlap between the two lasers.

In FIG. 31, the frequency offset Ω between the pump and Stokes beams may be set to any value between Ω₁ and Ω₂, and the frequency range ΔΩ of the frequency offset is Ω₂−Ω₁. When the first wavelength-tunable laser diode (with a frequency range from v_{2L} to v_{2M}) is selected to operate, the frequency offset Ω may be set to any value between Ω_{M} and Ω₂. For example, when the Stokes beam 120S is set to the lower frequency v_{2L}, the frequency offset between the pump and Stokes beams is v₁−v_{2L}, which is equal to Ω₂. When the second wavelength-tunable laser diode (with a frequency range from v_{2M} to v_{2H}) is selected to operate, the frequency offset Ω may be set to any value between Ω₁ and Ω_{M}. For example, when the Stokes beam 120S is set to the upper frequency v_{2H}, the frequency offset between the pump and Stokes beams is v₁−v_{2H}, which is equal to Ω₁. The total frequency range ΔΩ of the frequency offset C is equal to the sum of the two frequency ranges ΔΩ₂ₐ and ΔΩ_{2b}. The frequency range ΔΩ is also equal to the overall frequency range Δv₂ of the Stokes beam 120S.

In FIG. 32, the pump beam 120pu can be set to two fixed frequencies v₁ₐ and v_{1b}, and the Stokes beam 120S has a frequency v₂ that is adjustable over a frequency range of width Δv₂. The adjustable frequency range Δv₂ of the Stokes beam 120S extends from a low frequency v_{2L} to a high frequency v_{2H}, where Δv₂=v_{2H}−v_{2L}. The pump light source 110pu that produces the two pump beams 120pu-a and 120pu-b may include two fixed-wavelength laser diodes. For example, the pump light source 110pu may be similar to the light source in FIG. 24 where two fixed-wavelength laser diodes are combined by a multiplexer 118. The Stokes laser 110S that produces the Stokes beam 120S may be a wavelength-tunable laser diode. The frequency offset C between the pump and Stokes beams may be set to any value between Ω₁ and Ω₂, and the frequency range ΔΩ of the frequency offset is Ω₂−Ω₁. When the pump laser 110pu produces the pump beam 120pu-a at frequency v₁ₐ, the Stokes beam 120S may be tuned to a frequency between v_{2L} and v_{2H} to produce a frequency offset C between Ω₁ and Ω_{M}. For example, with the Stokes beam 120S set to the upper frequency v_{2H}, the frequency offset between the pump and Stokes beams is v₁ₐ−v_{2H}, which is equal to Ω₁. When the pump laser 110pu produces the pump beam 120pu-b at frequency v_{1b}, the Stokes beam 120S may be tuned to a frequency between v_{2L} and V_{2H} to produce a frequency offset C between Ω_{M} and Ω₂. For example, with the Stokes beam 120S set to the lower frequency v_{2L}, the frequency offset between the pump and Stokes beams is v_{1b}−v_{2L}, which is equal to Ω₂.

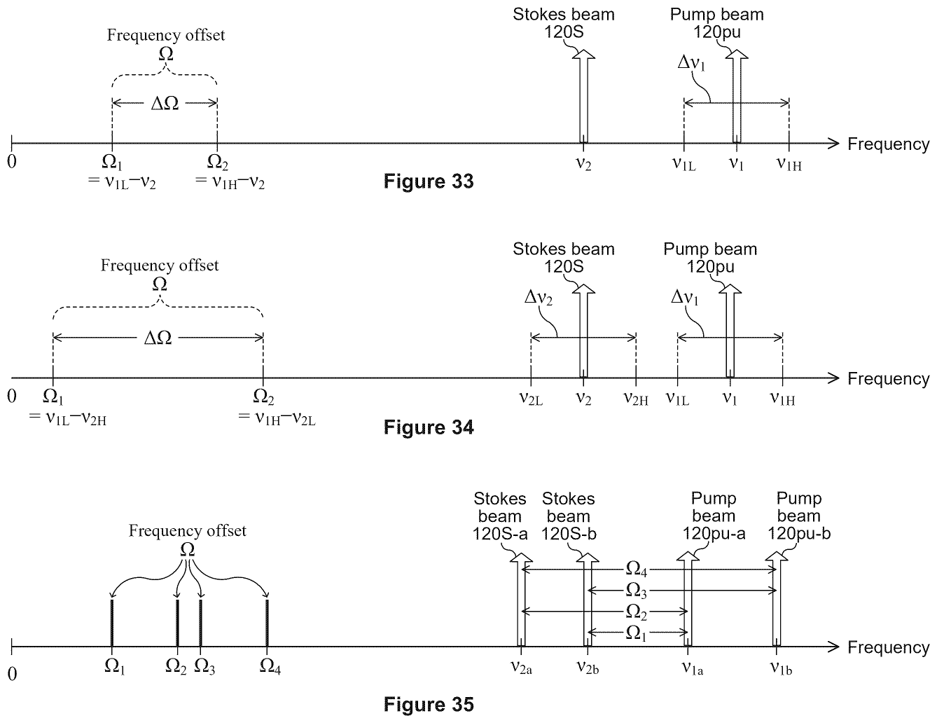

FIG. 33 is similar to FIG. 30, except in FIG. 33, the Stokes beam 120S has a fixed frequency v₂ and the frequency of the pump beam 120pu is adjustable. The adjustable frequency range Δv₁ of the pump beam 120pu extends from a low frequency v_{1L} to a high frequency v_{1H}, where Δv₁=v_{1H}−v_{1L}. The Stokes laser 110S that produces the Stokes beam 120pu in FIG. 33 may be a fixed-wavelength laser diode, and the pump laser 110pu that produces the pump beam 120pu may be a wavelength-tunable laser diode. The frequency offset Ω between the pump and Stokes beams may be set to any value between Ω₁ and Ω₂, and the frequency range ΔΩ of the frequency offset is Ω₂−Ω₁. In FIG. 33, the frequency range ΔΩ is also equal to the frequency range Δv₁ of the pump beam 120pu. When the pump beam 120pu is set to the lower frequency v_{1L}, the frequency offset between the pump and Stokes beams is v_{1L}−v₂, which is equal to Ω₁. Similarly, when the pump beam 120pu is set to the upper frequency v_{1H}, the frequency offset between the pump and Stokes beams is v_{1H}−v₂, which is equal to Ω₂.

In FIG. 34, both the pump beam 120pu and the Stokes beam 120S have adjustable frequencies. The pump laser 110pu that produces the pump beam 120pu and the Stokes laser 110S that produces the Stokes beam 120S may each include a wavelength-tunable laser diode. The adjustable frequency range Δv₁ of the pump beam 120pu extends from a low frequency v_{1L} to a high frequency v_{1H}, where Δv₁=v_{1H}−v_{1L}. The adjustable frequency range Δv₂ of the Stokes beam 120S extends from a low frequency v_{2L} to a high frequency v_{2H}, where Δv₂=v_{2H}−v_{2L}. The frequency offset Ω between the pump and Stokes beams may be set to any value between Ω₁ and Ω₂, and the frequency range ΔΩ of the frequency offset is Ω₂−Ω₁. When the Stokes beam 120S is set to the lower Stokes frequency v_{2L} and the pump beam 120pu is set to the upper pump frequency v_{1H}, the frequency offset between the pump and Stokes beams is v_{1H}−v_{2L}, which is equal to Ω₂. When the Stokes beam 120S is set to the upper Stokes frequency v_{2H} and the pump beam 120pu is set to the lower pump frequency v_{1L}, the frequency offset between the pump and Stokes beams is v_{1L}−v_{2H}, which is equal to Ω₁.

In FIG. 35, both the pump beam 120pu and the Stokes beam 120S can be set to two different fixed frequencies. A pump light source 110pu and a Stokes light source 110S may each include two or more fixed wavelength laser diodes, and each light source may be similar to the light source in FIG. 24 where multiple fixed-wavelength laser diodes are combined by a multiplexer 118. In FIG. 35, the pump light source 110pu that produces the two pump beams 120pu-a and 1200pu-b may include two fixed-wavelength laser diodes, and the Stokes light source 110S that produces the two Stokes beams 120S-a and 120S-b may include two fixed-wavelength laser diodes. The frequencies of the pump and Stokes beams may be selected to produce four different frequency offsets Ω₁, Ω₂, Ω₃, and Ω₄. For example, selecting Stokes beam 120S-b at frequency v_{2b} and pump beam 120pu-a at frequency v₁ₐ produces a frequency offset Ω₁, which is equal to v₁ₐ−v_{2b}. As another example, selecting Stokes beam 120S-a at frequency v₂ₐ and pump beam 120pu-b at frequency v_{1b} produces a frequency offset Ω₄, which is equal to v_{1b}−v₂ₐ. The frequency offset Ω₂ may be produced by selecting Stokes beam 120S-a at frequency v₂ₐ and pump beam 120pu-a at frequency v₁ₐ, and the frequency offset Ω₃ may be produced by selecting Stokes beam 120S-b at frequency v_{2b} and pump beam 120pu-b at frequency v_{1b}.

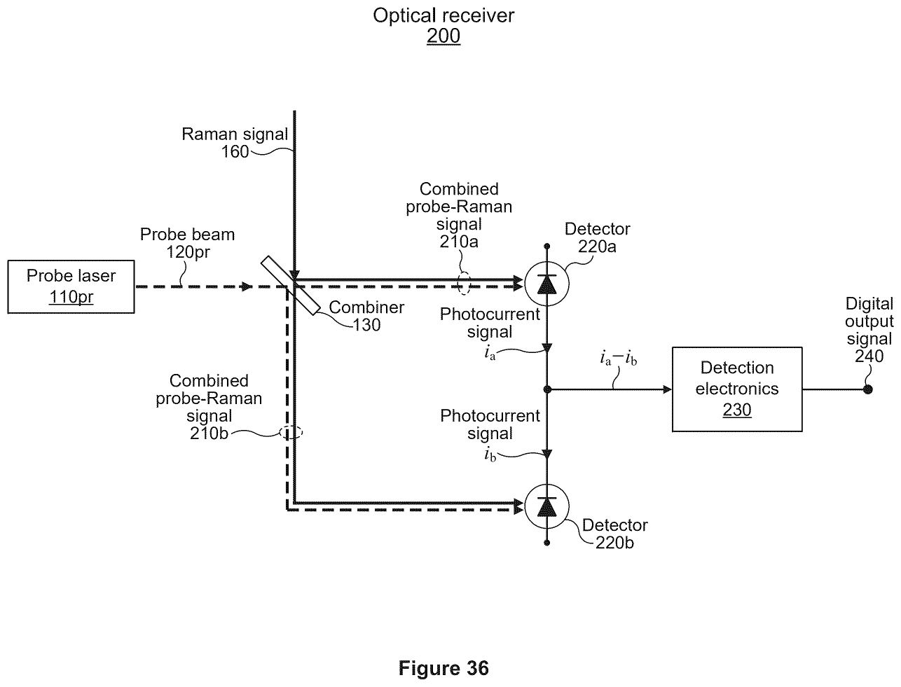

FIG. 36 illustrates an example optical receiver 200 with two detectors 220a and 220b. The optical receivers 200 in FIGS. 29 and 36 are similar, except one difference is that the optical receiver in FIG. 29 is a waveguide-based optical receiver, while the optical receiver in FIG. 36 is a free-space optical receiver 200. The optical combiner 130 in FIG. 36 may be a 50/50 free-space beamsplitter that reflects approximately 50% of an incident beam of light and transmits approximately 50% of the beam. The optical combiner 130 splits the Raman signal 160 and the probe beam 120pr into two beams to produce two combined probe-Raman signals 210a and 210b. The combined probe-Raman signal 210a is directed to detector 220a and includes a transmitted portion of the probe beam 120pr and a reflected portion of the Raman signal 160 (e.g., approximately 50% of the probe beam and approximately 50% of the Raman signal). Similarly, the combined probe-Raman signal 210b is directed to detector 220b and includes a reflected portion of the probe beam 120pr and a transmitted portion of the Raman signal 160. The portions of the probe beam 120pr and the Raman signal 160 that make up the combined probe-Raman signal 210a may be coherently mixed at detector 220a to produce the photocurrent signal iₐ. Similarly, the portions of the probe beam 120pr and the Raman signal 160 that make up the combined probe-Raman signal 210b may be coherently mixed at detector 220b to produce the photocurrent signal i_{b}.

The two detectors 220a and 220b are arranged so that their respective photocurrents iₐ and i_{b} are subtracted. The anode of detector 220a is electrically connected to the cathode of detector 220b, and the subtracted photocurrent signal iₐ−i_{b} from the anode-cathode connection is sent to the detection electronics 230, which produces a digital output signal 240 that corresponds to the subtracted photocurrent signal. The subtracted photocurrent signal may be expressed as iₐ−i_{b}=2E_{R}Eₚᵣ cos[2π(ν_{R}−ν₃)t+Δϕ], which corresponds to the coherent-mixing term discussed herein. The subtracted photocurrent signal does not include the terms E_{R}² and Eₚᵣ² corresponding to the respective optical powers of the Raman signal 160 and the probe beam 120pr. By subtracting the two photocurrents iₐ and i_{b}, the common-mode terms E_{R}² and Eₚᵣ² (as well as common-mode noise) that appear in each of the photocurrent signals iₐ and i_{b} are substantially removed, leaving the coherent-mixing term, which is the quantity of interest. Since subtraction may remove common-mode noise, the subtracted photocurrent signal iₐ−i_{b} may have a reduced noise compared to each of the photocurrent signals iₐ and i_{b} alone. The dual-detector arrangement in FIG. 36 in which the photocurrents are subtracted may be referred to as a balanced optical detector. A balanced detector may be implemented as a free-space device, a fiber-optic-based device, or a waveguide-based device.

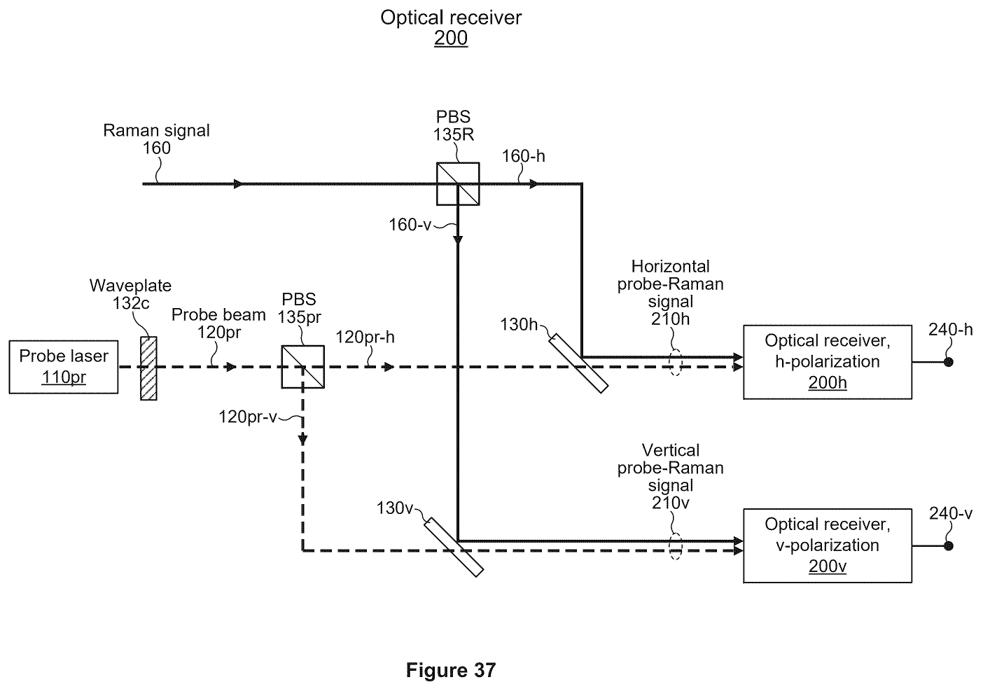

FIG. 37 illustrates an example optical receiver 200 configured for polarization-sensitive detection of a Raman signal 160. A polarization-sensitive optical receiver 200 may be used to determine the polarization of a Raman signal 160. The polarization of a Raman signal 160 may be determined by a processor based on one or more digital output signals 240 produced by the polarization-sensitive optical receiver 200. Determining the polarization of a Raman signal 160 may include determining a relative size or ratio of two orthogonal polarization components of the Raman signal (e.g., horizontal and vertical polarization components of the Raman signal). For example, if the ratio of the horizontal and vertical polarization components of a Raman signal 160 is 100:1, then the Raman signal may be determined to be substantially horizontally polarized. As another example, if the ratio of the horizontal and vertical polarization components of a Raman signal 160 is 1:1, then the horizontal and vertical polarization components of the Raman signal may be determined to be approximately equal (e.g., the Raman signal may be circularly polarized or linearly polarized at a 45-degree angle to the horizontal and vertical directions).

A polarization-sensitive optical receiver 200 may include a polarization beamsplitter (PBS) 135 that splits an input beam into two output beams, where one output beam is horizontally polarized, and the other output beam is vertically polarized. The horizontally polarized output beam includes the horizontal polarization component of the input beam, and the vertically polarized output beam includes the vertical polarization component of the input beam. The Raman signal 160 in FIG. 37 is directed to a Raman-signal PBS 135R that splits the Raman signal into a horizontal-polarization Raman signal 160-h and a vertical-polarization Raman signal 160-v. Similarly, the probe beam 120pr is directed to a probe-beam PBS 135pr that splits the probe beam into a horizontal-polarization probe beam 120pr-h and a vertical-polarization probe beam 120pr-v.

A polarization-sensitive optical receiver 200 may include a waveplate 132 that changes the polarization of the probe beam 120pr so that the probe beam is split into two polarization components. The two polarization components may each have approximately one-half the power of the probe beam 120pr. The waveplate 132c in FIG. 37 may be (i) a half-wave plate that rotates the polarization of the probe beam 120pr or (ii) a quarter-wave plate that converts the probe beam 120pr to a circular or elliptical polarization. For example, the probe laser 110pr may produce a probe beam 120pr that is vertically polarized, and the waveplate 132c may be a half-wave plate that rotates the probe-beam polarization by 45 degrees so that the horizontal-polarization and vertical-polarization probe beams 120pr-h and 120pr-v each have approximately equal optical powers.

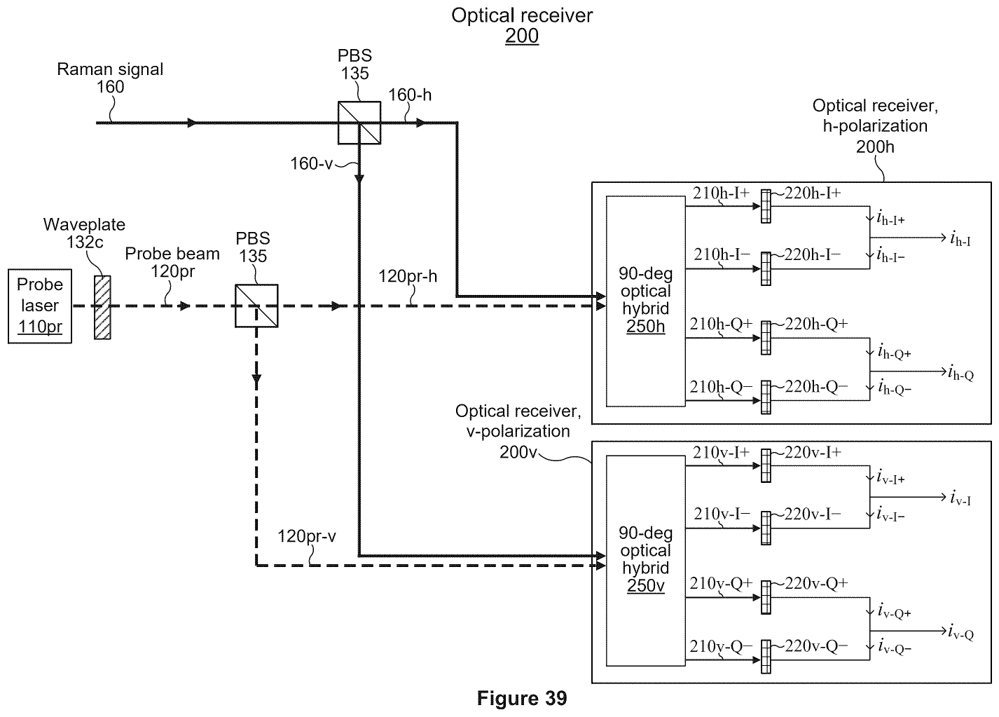

The optical combiner 130h in FIG. 37 combines the horizontal-polarization Raman signal 160-h and the horizontal-polarization probe beam 120pr-h to produce a horizontal probe-Raman signal 210h that is directed to a horizontal-polarization optical receiver 200h. Similarly, the optical combiner 130v combines the vertical-polarization Raman signal 160-v and the vertical-polarization probe beam 120pr-v to produce a vertical probe-Raman signal 210v that is directed to a vertical-polarization optical receiver 200v. The horizontal-polarization optical receiver 200h may include one or more optical detectors 200, where each detector is configured to coherently mix at least a portion of the horizontal-polarization Raman signal 160-h and at least a portion of the horizontal-polarization probe beam 120pr-h to produce a horizontal-polarization electronic signal. Similarly, the vertical-polarization optical receiver 200v may include one or more optical detectors 200, where each detector is configured to coherently mix at least a portion of the vertical-polarization Raman signal 160-v and at least a portion of the vertical-polarization probe beam 120pr-v to produce a vertical-polarization electronic signal. The horizontal-polarization optical receiver 200h and the vertical-polarization optical receiver 200v may each include: (i) a single detector 220 (e.g., similar to the optical receiver 200 in FIG. 2), (ii) two detectors 220 (e.g., similar to the balanced optical detector arrangement in FIG. 36), or (iii) four detectors 220 (e.g., similar to the arrangement in FIG. 39). The electronic signals may include a photocurrent signal i, and each optical receiver may include an electronic amplifier 232 that produces a corresponding voltage signal 234. The h-polarization optical receiver 200h may produce a digital output signal 240-h corresponding to the horizontal-polarization electronic signal, and the v-polarization optical receiver 200v may produce a digital output signal 240-v corresponding to the vertical-polarization electronic signal.

A processor may determine one or more characteristics of the horizontal-polarization and vertical-polarization electronic signals based on the digital output signals 240-h and 240-v. Additionally, a processor may determine a polarization of the Raman signal 160 based on the characteristics of the horizontal-polarization and vertical-polarization electronic signals. For example, the characteristics of the electronic signals may include an amplitude or an area associated with the electronic signals, and the polarization of the Raman signal 160 may be expressed as a relative size or ratio of the amplitudes or areas associated with the horizontal and vertical polarization components of the Raman signal. If the horizontal digital output signal 240-h includes an amplitude characteristic with value 100 and the vertical digital output signal 240-v includes a corresponding amplitude characteristic with value 1, then the Raman signal 160 may be determined to be substantially horizontally polarized. If the horizontal and vertical digital output signals each include amplitude characteristics having approximately equal values, then the Raman signal 160 may be determined to have approximately equal horizontal and vertical polarization components.

A polarization-sensitive optical receiver 200 as illustrated in FIG. 37 may be implemented with free-space optical elements, fiber-optic components, waveguide-based optical elements, a metamaterial-based device, or any suitable combination thereof. For example, the two PBSs 135 in FIG. 37 may be free-space polarization beamsplitter cubes, and the Raman signal 160 and the probe beam 120pr may be free-space optical beams. Alternatively, the two PBSs 135 may be fiber-optic components, and the Raman signal 160 and the probe beam 120pr may be conveyed to the PBSs 135 via optical fiber (e.g., single-mode optical fiber or polarization-maintaining optical fiber). Additionally, the horizontally and vertically polarized probe-Raman signals 210h and 210v may be conveyed to the respective h-polarization and v-polarization optical receivers via polarization-maintaining optical fiber. The h-polarization and v-polarization optical receivers may each preserve the polarization of the respective horizontally and vertically polarized probe-Raman signals. For example, the h-polarization and v-polarization optical receivers may each include polarization-maintaining optical fiber that maintains the polarization of the beams. Alternatively, the h-polarization and v-polarization receivers may each include a PIC with optical waveguides configured to maintain the polarization of the beams.

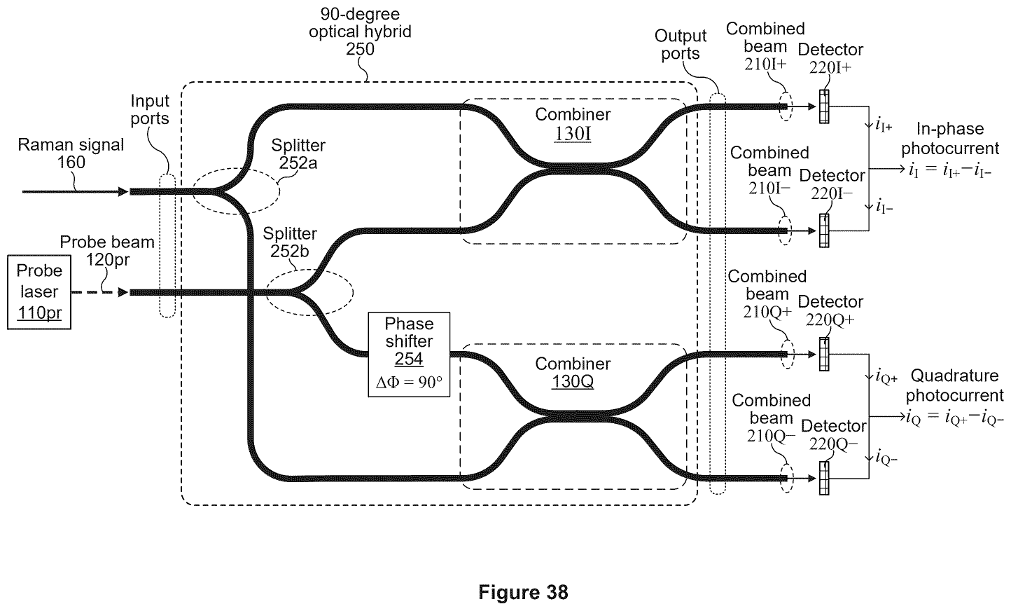

FIG. 38 illustrates an example optical receiver 200 configured to detect in-phase and quadrature components of a Raman signal 160. The optical receiver 200 includes a 90-degree optical hybrid 250 and four detectors 220I+, 220I−, 220Q+, and 220Q−. A 90-degree optical hybrid 250 is an optical-combiner component with two input ports and four output ports. Input light received at each of the two input ports is split, combined, and directed to each of the four output ports, and a 90-degree phase shift is imparted to one of the split beams before the Raman signal 160 and probe beam 120pr are combined. The 90-degree optical hybrid 250 in FIG. 38 combines a Raman signal 160 and a probe beam 120pr to produce four combined output beams: two in-phase combined beams 210I+ and 210I−, and two quadrature combined beams 210Q+ and 210Q−. Each of the four combined beams 210 may include a portion of the Raman signal 160 and a portion of the probe beam 120pr, and each of the combined beams is directed to one of the four detectors of the optical receiver 200. In FIG. 38, each of the four detectors produces a photocurrent signal that corresponds to the coherent mixing of a portion of the Raman signal 160 and a portion of the probe beam 120pr.

A 90-degree optical hybrid 250 may be configured so that the combined beams directed to each of the output ports have approximately the same optical power or energy. For example, the 90-degree optical hybrid 250 in FIG. 38 may split the Raman signal 160 into four approximately equal portions and direct each of the Raman-signal portions to one of the detectors. Similarly, the probe beam 120pr may be split into four approximately equal portions directed to each of the four detectors. In the example of FIG. 38, the combined beam 210I+, which is directed to detector 220I+, may include approximately one-quarter of the power of the Raman signal 160 and approximately one-quarter of the power of the probe beam 120pr. Similarly, each of the three other combined beams (210I−, 210Q+, 210Q−) in FIG. 38 may also include approximately one-quarter of the Raman signal 160 and approximately one-quarter of the probe beam 120pr.

A 90-degree optical hybrid 250 may be implemented as a waveguide-based device in a PIC. The 90-degree optical hybrid 250 in FIG. 38 is a waveguide-based optical device that includes two waveguide-based optical splitters (252a, 252b) and two waveguide-based optical combiners (130I, 130Q). Splitter 252a may split the Raman signal 160 into two portions having substantially equal optical power, a first portion directed to combiner 130I and a second portion directed to combiner 130Q. Similarly, splitter 252b may split the probe beam 120pr into two portions having substantially equal power, a first portion directed to combiner 130I and a second portion directed to combiner 130Q. Each optical combiner 130 combines a portion of the Raman signal 160 with a portion of the probe beam 120pr, and the combined portions are split into a first combined beam (e.g., combined beam 210I+) and a second combined beam (e.g., combined beam 210I−). The combined beam 210I+ is directed to detector 220I+ and includes portions of the Raman signal 160 and the probe beam 120pr (e.g., approximately 25% of the Raman signal 160 and approximately 25% of the probe beam 120pr). The combined beam 210I− is directed to detector 220I− and may include approximately 25% of the Raman signal 160 and approximately 25% of the probe beam 120pr.

In other embodiments, all or part of a 90-degree optical hybrid 250 may be implemented as a free-space optical device. For example, a free-space 90-degree optical hybrid 250 may include one or more free-space beamsplitters or combiners that receive the Raman signal 160 and probe beam 120pr as free-space beams and produce four free-space combined beams (210I+, 210I−, 210Q+, 210Q−). Alternatively, all or part of a 90-degree optical hybrid 250 may be implemented as a fiber-optic device. For example, a 90-degree optical hybrid 250 may be contained in a package with two input optical fibers that direct the Raman signal 160 and probe beam 120pr into the package and four output optical fibers that direct the four combined beams to four respective detectors.

A 90-degree optical hybrid 250 may include an optical phase shifter 254 that imparts a 90-degree phase change (ΔΦ) to a portion of the probe beam 120pr or to a portion of the Raman signal 160. The phase shifter 254 may apply the 90-degree phase change after a beam of light is split by an optical splitter 252 and prior to combining the Raman signal with the probe beam at an optical combiner 130. For example, a splitter 252a may split the Raman signal 160 into two portions, and a phase shifter 254 may impart a 90-degree phase change to one portion of the Raman signal with respect to the other portion, after which the two portions are sent to two different optical combiners. As another example, a splitter 252b may split the probe beam 120pr into two portions, and a phase shifter 254 may impart a 90-degree phase change to one portion of the probe beam with respect to the other portion. In FIG. 38, the phase shifter is located after the splitter 252b and before the combiner 130Q. The splitter 252b splits the probe beam 120pr into two portions, and the phase shifter 254 imparts a 90-degree phase change to the probe-beam portion directed to combiner 130Q. The other portion of the probe beam 120pr directed to combiner 130I does not pass through the phase shifter 254 and does not receive a phase shift from the phase shifter 254.

An optical phase shifter 254 may be implemented as a part of a waveguide-based 90-degree optical hybrid 250. For example, a phase shifter 254 may be implemented as part of an optical waveguide that only one portion of the probe beam 120pr propagates through. That part of the optical waveguide may be temperature controlled to adjust the refractive index of the waveguide and produce a relative phase delay of approximately 90 degrees between two portions of the probe beam 120pr. Additionally or alternatively, the 90-degree optical hybrid 250 as a whole may be temperature controlled to set and maintain a 90-degree phase delay. As another example, a phase shifter 254 may be implemented by applying an external electric field to part of an optical waveguide to change the refractive index of the waveguide and produce a 90-degree phase delay. In other embodiments, a phase shifter 254 may be implemented as a part of a free-space or fiber-coupled 90-degree optical hybrid 250. For example, the input and output beams in a free-space 90-degree optical hybrid 250 may be reflected by or transmitted through the optical surfaces of a free-space optical hybrid 250 so that a relative phase shift of 90 degrees is imparted to one portion of the probe beam 120pr with respect to another portion of the probe beam.

In FIG. 38, each of the four detectors produces a photocurrent signal that corresponds to the coherent mixing of a portion of the Raman signal 160 and a portion of the probe beam 120pr. The photocurrents are subtracted in a manner similar to that illustrated in FIG. 36. The photocurrents i_{I+} and i_{I-} from detectors 220I+ and 220I− are subtracted to produce the subtracted in-phase photocurrent signal i_{I} which is equal to i_{I+}−i_{I-}. Similarly, the photocurrents i_{Q+} and i_{Q-} from detectors 220Q+ and 220Q− are subtracted to produce the subtracted quadrature photocurrent signal i_{Q} which is equal to i_{Q+}−i_{Q-}. Each of the subtracted photocurrent signals represents a coherent-mixing term corresponding to the coherent mixing of a portion of the Raman signal 160 and a portion of the probe beam 120pr. The two subtracted photocurrent signals i_{I} and i_{Q} are similar, except the in-phase photocurrent signal i_{I} includes a cosine function, while the quadrature photocurrent signal i_{Q} includes a sine function. This difference between the two subtracted photocurrent signals arises from the 90-degree phase shift provided by the phase shifter 254. Because a 90-degree phase shift is imparted to the probe beam 120pr directed to the combiner 130Q, the subtracted quadrature photocurrent signal i_{Q} includes a sine function (which has a 90-degree phase offset with respect to a cosine function).

Each of the subtracted photocurrent signals i_{I} and i_{Q} may be sent to detection electronics 230 that produce voltage signals and digital output signals corresponding to the subtracted photocurrent signals. Based on the digital output signals (which result from the four photocurrent signals i_{I+}, i_{I-}, i_{Q+}, and i_{Q-}), a processor may determine an in-phase portion IP associated with the Raman signal 160 and a quadrature portion Q associated with the Raman signal. Additionally or alternatively, the processor may determine a phase associated with the Raman signal 160. For example, the processor may determine a phase difference Δϕ between the Raman signal 160 and the probe beam 120pr. A phase difference may be referred to as a phase offset or a relative phase between the Raman signal 160 and the probe beam 120pr.

The in-phase portion IP associated with the Raman signal 160 may be determined from a characteristic (e.g., an amplitude or an area) of an electronic signal associated with the in-phase photocurrent signal i_{I}, and the quadrature portion Q may be determined from a characteristic associated with the quadrature photocurrent signal i_{Q}. The in-phase portion IP may correspond to an amount of the Raman signal 160 that is in-phase with the probe beam 120pr, and the quadrature portion Q may represent an amount of the Raman signal that is out of phase (i.e., 90-degrees phase-shifted) with the probe beam. For example, the in-phase portion IP and the quadrature portion Q, may each have values from −1 to 1. If the Raman signal 160 is in-phase with the probe beam 120pr, then the in-phase portion IP may have a value of approximately 1, and the quadrature portion Q may have a value of approximately 0. Similarly, if the Raman signal 160 is out of phase by ±90 degrees with respect to the probe beam 120pr, then the in-phase portion IP may have a value of 0, and the quadrature portion Q may have a value of ±1. The phase difference Δϕ between the Raman signal 160 and the probe beam 120pr may be determined from the expression Δϕ=arctan(Q/IP). For example, if Q is 0 and IP is 1, then the Raman signal and the probe beam are substantially in phase, with a phase difference Δϕ of 0 degrees. As another example, if Q is 1 and IP is 0, then the Raman signal and the probe beam are substantially out of phase, with a phase difference Δϕ of 90 degrees.

FIG. 39 illustrates an example optical receiver 200 configured to detect polarization as well as in-phase and quadrature components of a Raman signal 160. The optical receiver 200 in FIG. 39 is similar the optical receiver 200 in FIG. 37, where the horizontal-polarization optical receiver 200h and the vertical-polarization optical receiver 200v each includes a 90-degree optical hybrid 250. Each of the 90-degree optical hybrids in FIG. 39 may be similar to the 90-degree optical hybrid 250 in FIG. 38. In FIG. 39, the horizontal-polarization Raman signal 160-h and the horizontal-polarization probe beam 120pr-h are directed to a horizontal-polarization optical receiver 200h that includes a 90-degree optical hybrid 250h and four detectors 220h-I+, 220h-I−, 220h-Q+, and 220h-Q−. The vertical-polarization Raman signal 160-v and the vertical-polarization probe beam 120pr-h are directed to a vertical-polarization optical receiver 200v that includes a 90-degree optical hybrid 250v and four detectors 220v-I+, 220v-I−, 220v-Q+, and 220v-Q−. The h-polarization optical receiver 200h may be used to determine the relative size of the horizontal-polarization Raman signal 160-h as well as the in-phase and quadrature components of the horizontal-polarization Raman signal 160-h. Similarly, the v-polarization optical receiver 200h may be used to determine the relative size of the vertical-polarization Raman signal 160-v as well as the in-phase and quadrature components of the vertical-polarization Raman signal 160-v.

The 90-degree optical hybrid 250h in FIG. 39 combines the horizontal-polarization Raman signal 160-h and the horizontal-polarization probe beam 120pr-h to produce four horizontally polarized combined output beams: two in-phase combined beams 210h-I+ and 210h-I−, and two quadrature combined beams 210h-Q+ and 210h-Q−. Each of the four horizontally polarized combined beams includes a portion of the horizontal-polarization Raman signal 160-h and a portion of the horizontal-polarization probe beam 120pr-h. The four combined beams are directed to four respective detectors (220h-I+, 220h-I−, 220h-Q+, 220h-Q−), and each detector produces a respective photocurrent signal (i_{h-I+}, i_{h-I-}, i_{h-Q+}, i_{h-Q-}) that corresponds to the coherent mixing of a portion of the horizontal Raman signal 160-h and a portion of the horizontal probe beam 120pr-h. Each of the four photocurrents i_{h-I+}, i_{h-I-}, i_{h-Q+}, and i_{h-Q-} may be referred to as a horizontal-polarization electronic signal. The photocurrents from the detectors are subtracted to produce a subtracted horizontal in-phase photocurrent signal i_{h-I} which is equal to i_{h-I+}−i_{h-I-} and a subtracted horizontal quadrature photocurrent signal i_{h-Q} which is equal to i_{h-Q+}−i_{h-Q-}.

The 90-degree optical hybrid 250v in FIG. 39 combines the vertical-polarization Raman signal 160-v and the vertical-polarization probe beam 120pr-v to produce four vertically polarized combined output beams: two in-phase combined beams 210v-I+ and 210v-I−, and two quadrature combined beams 210v-Q+ and 210v-Q−. Each of the four vertically polarized combined beams includes a portion of the vertical-polarization Raman signal 160-v and a portion of the vertical-polarization probe beam 120pr-v. The four combined beams are directed to four respective detectors (220v-I+, 220v-I−, 220v-Q+, 220v-Q−), and each detector produces a respective photocurrent signal (i_{v-I+}, i_{v-I-}, i_{v-Q+}, i_{v-Q-}) that corresponds to the coherent mixing of a portion of the vertical Raman signal 160-v and a portion of the vertical probe beam 120pr-v. Each of the four photocurrents i_{v-I+}, i_{v-I-}, i_{v-Q+}, and i_{v-Q-} may be referred to as a vertical-polarization electronic signal. The photocurrents from the detectors are subtracted to produce a subtracted vertical in-phase photocurrent signal i_{v-I} which is equal to i_{v-I+}−i_{v-I-} and a subtracted vertical quadrature photocurrent signal i_{v-Q} which is equal to i_{v-Q+}−i_{v-Q-}.

Each of the subtracted photocurrent signals i_{h-I}, i_{h-Q}, i_{v-I}, and i_{V-Q} may be sent to detection electronics 230 that produces voltage signals and digital output signals corresponding to the subtracted photocurrent signals. Based on the digital output signals (which are determined from the four horizontal-polarization electronic signals and the four vertical-polarization electronic signals), a processor may determine (i) the polarization of the Raman signal 160 and (ii) a phase associated with the Raman signal (e.g., a phase difference Δϕ between the Raman signal 160 and the probe beam 120pr). Determining the polarization of a Raman signal 160 may include determining a relative size or ratio of the horizontal and vertical polarization components of the Raman signal. For example, the relative size of the horizontal polarization component of the Raman signal 160 may be determined by adding characteristics (e.g., areas or amplitudes) associated with the two horizontal photocurrent signals i_{h-I} and i_{h-Q}. Similarly, the relative size of the vertical polarization component of the Raman signal 160 may be determined by adding characteristics associated with the two vertical photocurrent signals i_{v-I} and i_{v-Q}. As an example, if the relative size of the horizontal polarization component of the Raman signal 160 is 1 and the relative size of the vertical polarization component of the Raman signal 160 is 100, then the Raman signal 160 may be determined to be substantially vertically polarized.

Based on the digital output signals, a processor may determine a phase associated with the Raman signal. For example, the processor may determine (i) a phase difference Δϕₕ between the horizontal Raman signal 160-h and the horizontal probe beam 120pr-h and (ii) a phase difference Δϕᵥ between the vertical Raman signal 160-v and the vertical probe beam 120pr-v. Based on the digital output signals, a processor may determine in-phase and quadrature portions associated with each of the horizontal Raman signal 160-h and vertical Raman signal 160-v. The phase difference Δϕₕ between the horizontal Raman signal 160-h and the horizontal probe beam 120pr-h may be determined from the expression Δϕₕ=arctan(Qₙ/IPₕ), where Qₙ and IPₕ are the quadrature and in-phase portions associated with the horizontal Raman signal. The phase difference Δϕᵥ between the vertical Raman signal 160-v and the vertical probe beam 120pr-v may be determined from the expression Δϕₕ=arctan(Qᵥ/IPᵥ), where Qᵥ and IPᵥ are the quadrature and in-phase portions associated with the vertical Raman signal.

An optical receiver 200 may include one or more detectors 220. An optical receiver 200 may include one detector 220 (e.g., as illustrated in FIGS. 1, 2, and 18), or an optical receiver 200 may include multiple detectors 220 (e.g., as illustrated in FIGS. 17, 36, 38, and 39). An optical receiver 200 with multiple detectors 220 may include 2, 3, 4, 8, 16, or any other suitable number of detectors. For example, an optical receiver 200 may include two detectors 220 arranged so that their respective photocurrents are subtracted (e.g., as illustrated in FIG. 36). As another example, an optical receiver 200 may include four detectors 220 (e.g., as illustrated in FIG. 38) or eight detectors 220 (e.g., as illustrated in FIG. 39). In an optical receiver 200 with multiple detectors 220, portions of a probe beam 120pr and a Raman signal 160 may be coherently mixed together at one or more of the multiple detectors 220, and each of these one or more detectors may produce a photocurrent signal i corresponding to the coherent mixing of the probe beam and the Raman signal. Any of the optical receivers 200 described herein as having a single detector 220 may also be configured to have two or more detectors. For example, the optical receiver in FIG. 1 (which includes one detector 220) may include a second detector (not illustrated in FIG. 1), and the detection electronics 230 may be configured to receive and process photocurrent signals from each of the two detectors.

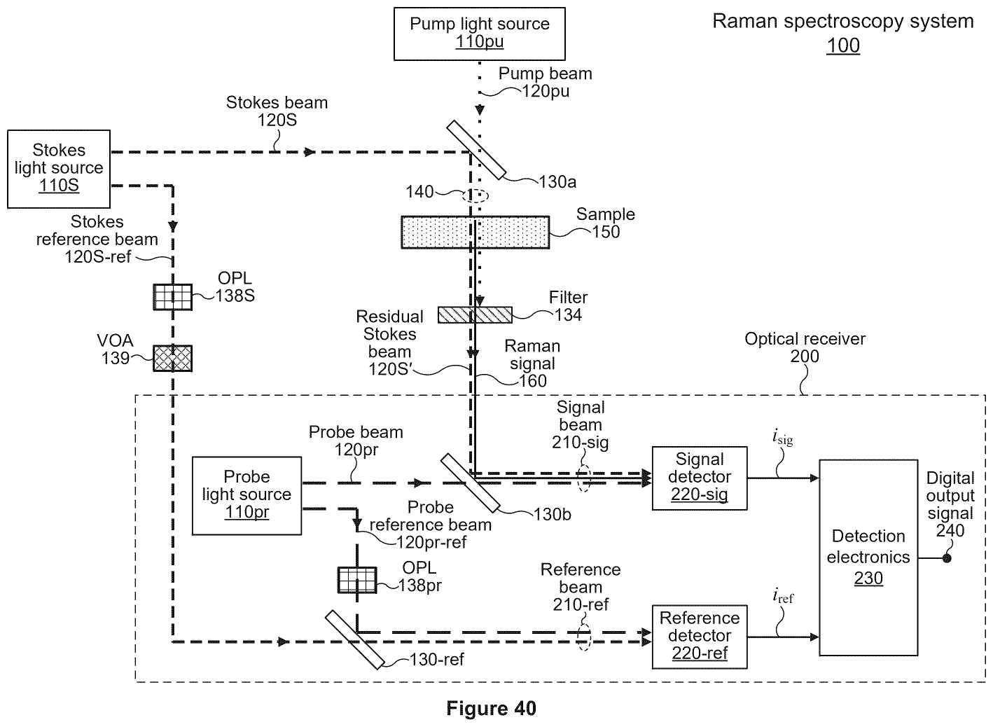

FIG. 40 illustrates an example Raman spectroscopy system 100 with balanced detection. The optical receiver 200 includes two detectors (signal detector 220-sig and reference detector 220-ref) arranged in a balanced-detection configuration. The Raman spectroscopy system 100 in FIG. 40 may detect a Raman signal 160 by coherently mixing the Raman signal 160 with the probe beam of light 120pr at the signal detector 220-sig. Additionally, the reference detector 220-ref may be used to reduce or remove common-mode noise that is present in both the signal beam 210-sig and the reference beam 210-ref. The Raman spectroscopy system 100 in FIG. 40 is similar to the Raman spectroscopy system illustrated in FIG. 2, except the optical receiver 200 in FIG. 40 includes two detectors arranged for balanced detection. Additionally, the system in FIG. 40 is configured to produce a Stokes reference beam 120S-ref and a probe reference beam 120pr-ref that are detected by the reference detector 220-ref. The Raman spectroscopy system 100 in FIG. 40 may be referred to as a Raman spectroscopy system with balanced detection, a coherent Raman spectroscopy system with balanced detection, a coherent Raman spectroscopy system with heterodyne detection and balanced detection, or a high-resolution coherent Raman spectroscopy system with balanced detection.

The Raman spectroscopy system 100 in FIG. 40 includes a pump light source 110pu that produces a pump beam of light 120pu and a Stokes light source 110S that produces (i) a Stokes beam of light 120S and (ii) a Stokes reference beam of light 120S-ref. The pump light source 110pu produces the pump beam of light 120pu at a pump frequency (which may be referred to as a first frequency and may be represented by vₚᵤ, v₁, ωₚᵤ, or ω₁). The pump light source 110pu may be referred to as a first light source, and the pump beam of light 120pu may be referred to as a first beam of light. The Stokes light source 110S produces the Stokes beam of light 120S at a Stokes frequency (which may be referred to as a second frequency and may be represented by v_{S}, v₂, ω_{S}, or ω₂). The Stokes light source 110S may be referred to as a second light source, and the Stokes beam of light 120S may be referred to as a second beam of light. The pump and Stokes frequencies may be offset by a frequency offset Ω, where Ω equals vₚᵤ−v_{S} (or equivalently, Ω=v₁−v₂). The Stokes beam of light 120S and the Stokes reference beam of light 120S-ref may be derived from the same light source and may have the same optical frequency v_{S}.

In FIG. 40, the pump beam 120pu and the Stokes beam 120S are directed to a sample 150, and the sample 150 produces a Raman signal 160 in response to the pump and Stokes beams. For example, the Raman signal 160 may be produced by coherent Raman scattering of the pump and Stokes beams within the sample 150. A Raman spectroscopy system 100 may include one or more optical elements that direct the pump beam 120pu and the Stokes beam 120S to a sample 150. Additionally, the optical elements may collect the Raman signal 160 produced by the sample 150 in response to the pump beam 120pu and Stokes beam 120S and may direct the Raman signal 160 to an optical receiver 200. In addition to collecting the Raman signal 160, the optical elements may also collect residual light from the Stokes beam of light 120S after the Stokes beam of light has interacted with the sample. For example, after the pump beam 120pu and the Stokes beam 120S have interacted with the sample 150 to produce a Raman signal 160, the residual Stokes beam of light 120S′ may be produced as “leftover” light from the Stokes beam that is reflected from, transmitted through, or scattered by the sample. In FIG. 40, the optical combiner 130a combines the pump beam 120pu and the Stokes beam 120S to produce a combined pump-Stokes beam 140 that is directed to the sample 150. The residual Stokes beam of light 120S′ in FIG. 40 is produced after the Stokes beam of light 120S is transmitted through the sample 150, and one or more optical elements may collect the Raman signal 160 and the residual Stokes beam of light 120S′ and direct the beams to the optical receiver 200.

The optical filter 134 in FIG. 40 may be configured to substantially block the pump beam of light 120pu and transmit the Raman signal 160. Additionally, the filter 134 may transmit at least a portion of the residual Stokes beam 120S′. For example, the Stokes frequency may be within approximately 200 GHz of the center frequency of the Raman signal 160, and the optical filter 134 may transmit the Raman signal as well as transmitting at least a portion of the residual Stokes beam 120S′. In addition to or instead of including an optical filter, the Raman spectroscopy system 100 in FIG. 40 may include an optical polarizer (e.g., similar to the polarizer 136 illustrated in FIG. 2) that blocks the pump beam and transmits at least a portion of the Raman signal. Additionally, the polarizer may transmit at least a portion of the residual Stokes beam. For example, at least a portion of the Raman signal 160 may be orthogonally polarized with respect to the pump beam 110pu, and a polarizer 136 may be used to block the polarization of the pump beam and transmit the orthogonally polarized portion of the Raman signal. Additionally, the polarizer may also transmit at least a portion of the residual Stokes beam 120S′.

The Raman spectroscopy system 100 in FIG. 40 includes an optical receiver 200 that detects the Raman signal 160 produced by the sample 150. The optical receiver 200 may be referred to as an optical receiver with balanced detection, a balanced optical receiver, a heterodyne optical receiver with balanced detection, or a high-resolution optical receiver with balanced detection. The optical receiver 200 may detect the Raman signal 160 using an optical heterodyne technique in which the Raman signal 160 is coherently mixed with the probe beam of light 120pr. Additionally, the signal and reference detectors may be arranged in a balanced configuration in which electronic signals corresponding to the signal photocurrent i_{sig} and the reference photocurrent i_{ref} are subtracted to provide a reduction in noise. The balanced-detection optical receiver 200 in FIG. 40 includes a probe light source 110pr that produces (i) a probe beam of light 120pr at a probe frequency and (ii) a probe reference beam of light 120pr-ref. The probe light source 110pr may be referred to as a third light source, and the probe beam of light 120pr may be referred to as a third beam of light. The probe frequency may be referred to as a third frequency and may be represented by vₚᵣ, v₃, ωₚᵣ, or ω₃. The probe beam of light 120pr and the probe reference beam of light 120pr-ref may be derived from the same light source and may have the same optical frequency vₚᵣ.

In FIG. 40, the probe beam 120pr is combined with the Raman signal 160 and the residual Stokes beam 120S′ at the optical combiner 130b to produce the combined signal beam 210-sig which is directed to the signal detector 220-sig. Additionally, the Stokes reference beam 120S-ref produced by the Stokes light source 110S and the probe reference beam 120pr-ref produced by the probe light source 110pr are combined at the optical combiner 130-ref to produce the combined reference beam 210-ref which is directed to the reference detector 220-ref. The optical combiner 130-ref may be a dichroic or non-dichroic beamsplitter that combines the Stokes and probe reference beams. Alternatively, the Stokes and probe reference beams may be orthogonally polarized (e.g., the Stokes reference beam 120pr-ref may be horizontally polarized and the probe reference beam 120pr-ref may be vertically polarized), and a polarization beamsplitter (PBS) may be used (instead of a combiner 130-ref) to combine the two orthogonal polarizations to produce the reference beam 210-ref. The Stokes and probe reference beams may be combined so that the two beams are substantially coaxial and travel together in the same direction and along approximately the same optical path. Alternatively, the Stokes and probe reference beams may not be optically overlapped or may be directed to the reference detector 220-ref as separate optical beams. For example, a balanced-detection optical receiver 200 may not include an optical combiner 130-ref for the reference beams, and the Stokes and probe reference beams may be sent to the reference detector 220-ref as two separate optical beams. As another example, the Stokes and probe reference beams may be sent to the reference detector 220-ref as two separate and substantially parallel optical beams, and a lens may be used to focus the two beams onto the reference detector 220-ref. The angle between the two focused beams may be large enough (e.g., greater than approximately 2 degrees) that the effect of coherent mixing between the two beams is minimized or eliminated.

The optical receiver 200 in FIG. 40 includes a signal detector 220-sig and a reference detector 220-ref. The signal detector 220-sig receives the signal beam 210-sig (which includes the Raman signal 160, probe beam 120pr, and residual Stokes beam 120S′) and produces a signal photocurrent i_{sig} corresponding to the Raman signal, probe beam, and residual Stokes beam. A portion of the Raman signal 160 may be coherently mixed at the detector 220-sig with at least a portion of the probe beam 120pr, and a portion of the signal photocurrent i_{sig} may correspond to the coherent mixing between the Raman signal and probe beam. Additionally, the signal photocurrent may include one or more portions that correspond to the Raman signal 160, the probe beam 120pr, or the residual Stokes beam 120S′. The portion of the signal photocurrent i_{sig} that results from coherent mixing between the Raman signal 160 and probe beam 120pr may be produced by coherent mixing of optical frequency components of the Raman signal that are within a particular frequency range of the probe frequency vₚᵣ. The particular frequency range may be based on the electronic bandwidth Δf of the signal detector 220-sig, where the detector bandwidth may refer to the bandwidth of the signal detector or the bandwidth of the signal detector in combination with a signal-photocurrent amplifier 232-sig. For example, the particular frequency range of optical frequency components of the Raman signal 160 that are coherently mixed with the probe beam 120pr to produce an electronic signal may extend from approximately vₚᵣ−Δf to approximately vₚᵣ+Δf.

The reference detector 220-ref in FIG. 40 receives the reference beam 210-ref (which includes the probe reference beam 120pr-ref and the Stokes reference beam 120S-ref) and produces a reference photocurrent i_{ref} corresponding to the probe and Stokes reference beams. In some embodiments, the reference photocurrent i_{ref} produced by the reference detector 220-ref may not include a signal corresponding to coherent mixing between the probe and Stokes reference beams. For example, any coherent mixing between the probe and Stokes reference beams may correspond to an electronic frequency that is greater than the electronic bandwidth Δf of the reference detector 220-ref. Accordingly, the reference photocurrent i_{ref} may include portions that correspond to the probe reference beam 120pr-ref and the Stokes reference beam 120S-ref, and the reference photocurrent may include little or no contribution from coherent mixing between the two beams. In other embodiments, the reference photocurrent i_{ref} produced by the reference detector 220-ref may include a signal corresponding to coherent mixing between the probe and Stokes reference beams. For example, if the frequency difference between the probe and Stokes reference beams is less than the electronic bandwidth Δf of the reference detector 220-ref, then the reference photocurrent i_{ref} may include a portion that corresponds to coherent mixing between the probe reference beam 120pr-ref and the Stokes reference beam 120S-ref. Additionally, the reference photocurrent i_{ref} may include portions that correspond to the probe reference beam 120pr-ref and the Stokes reference beam 120S-ref. Alternatively, if the probe and Stokes reference beams are directed to the reference detector 220-ref at an angle (e.g., the angle between the two beams may be greater than approximately 2 degrees), then any portion of the reference photocurrent associated with coherent mixing between the two beams may average out to approximately zero

The detection electronics 230 in FIG. 40 receives the signal photocurrent i_{sig} and the reference photocurrent i_{ref} and produces a digital output signal 240 that corresponds to the two photocurrents. For example, the detection electronics 230 may include a subtraction module that determines a subtraction signal that corresponds to or that equals a difference between (i) a signal corresponding to the signal photocurrent i_{sig} and (ii) a signal corresponding to the reference photocurrent i_{ref}. The detection electronics 230 may include a digitizer that produces a digital representation of the subtraction signal, and the digital output signal 240 may include the digital representation of the subtraction signal. The digital output signal 240 may be sent to a processor, and the processor may determine a characteristic 162 of the subtraction signal based on the digital output signal 240. In other embodiments, the detection electronics 230 may include a first digitizer that produces a first digital signal corresponding to the signal photocurrent i_{sig} and a second digitizer that produces a second digital signal corresponding to the reference photocurrent i_{ref}, and the digital output signal 240 may include the two digital signals. The processor may determine a digital subtraction signal from the two digital signals, and a characteristic 162 of the subtraction signal may be determined from the digital subtraction signal.

The characteristic 162 of a subtraction signal determined by a processor may be associated with a Raman signal 160 and may include a peak amplitude, an average amplitude, an amplitude at a particular frequency, an amplitude at a particular time, an amplitude at a frequency center, an amplitude at a temporal center, a DC offset, an area, a frequency, a phase, or a polarization. Additionally, a characteristic 162 of a subtraction signal may be associated with a Raman shift at a frequency vₚᵤ−vₚᵣ. The probe light source 110pr of a Raman spectroscopy system 100 with balanced detection may include a wavelength-tunable laser, and the system may perform measurements of a Raman signal 160 at multiple different probe frequencies to determine multiple signal characteristics 162 (e.g., as illustrated in FIGS. 11 and 13). The frequency offset Ω associated with the pump and Stokes frequencies may be approximately equal to a vibrational frequency of a particular material, and based on one or more determined signal characteristics 162, a processor may determine (i) whether the particular material is present in a sample 150 or (ii) an amount or a concentration of the particular material in the sample. A processor of a Raman spectroscopy system 100 may include or may be referred to as a computer system, a controller, a computing device, a computing system, a computer, or a data-processing apparatus. A processor may be similar to the computer system 5900 illustrated in FIG. 59 and described herein.

A technical advantage of a Raman spectroscopy system 100 with balanced detection as described herein is a reduction in noise and a corresponding improvement in measurement sensitivity. For example, balanced detection may allow a Raman signal 160 to be measured with less noise and higher sensitivity as compared to a system without balanced detection. A Raman spectroscopy system that does not employ balanced detection may use a single detector to detect a Raman signal. While the single detector may produce a photocurrent signal corresponding to the Raman signal, the photocurrent signal may also include one or more additional portions produced by the probe beam or Stokes beam, along with corresponding intensity noise associated with the probe or Stokes beam. Intensity noise, which may be referred to as optical intensity noise or amplitude noise, is associated with fluctuations in the optical power of light produced by a laser, and these optical-power fluctuations result in corresponding fluctuations in the photocurrent signal produced by a detector 220. For example, a laser diode supplied with a substantially constant DC current may produce an output beam of light 120 having a substantially constant optical power along with unwanted power fluctuations caused by noise. The intensity noise present in a beam of light may arise from spontaneous emission in the laser or from technical noise (e.g., noise from the electronic driver that provides the DC current, noise from mechanical vibrations, or noise from temperature fluctuations).

A Raman spectroscopy system 100 with balanced detection uses two detectors to substantially reduce or remove intensity noise that may be present in the probe beam 120pr or the Stokes beam 120S. In FIG. 40, the signal beam 210-sig detected by the signal detector 220-sig includes the Raman signal 160 along with the probe beam 120pr and the residual Stokes beam 120S′. The reference beam 210-ref detected by the reference detector 220-ref includes the probe reference beam 120pr-ref and the Stokes reference beam 120S-ref. Since the probe beam 120pr and probe reference beam 120pr-ref may be derived from the same light source, the two beams may each include correlated (or, common-mode) noise signals. Similarly, the residual Stokes beam 120S′ and the Stokes reference beam 120S-ref may each include correlated noise signals. In a balanced-detection optical receiver 200, a signal corresponding to the reference photocurrent i_{ref} may be subtracted from a signal corresponding to the signal photocurrent i_{sig} to produce a subtraction signal. The subtraction signal may include a signal associated with the Raman signal 160, while the common-mode noise present in the probe beam and the Stokes beam may be substantially removed by the subtraction operation that produces the subtraction signal. As a result, the subtraction signal may have a reduced noise compared to each of the photocurrent signals i_{sig} and i_{ref} alone. The reduced noise of a Raman spectroscopy system 100 with balanced detection may provide a corresponding improvement in the sensitivity of the system, such as the ability to detect lower concentrations of chemical species.

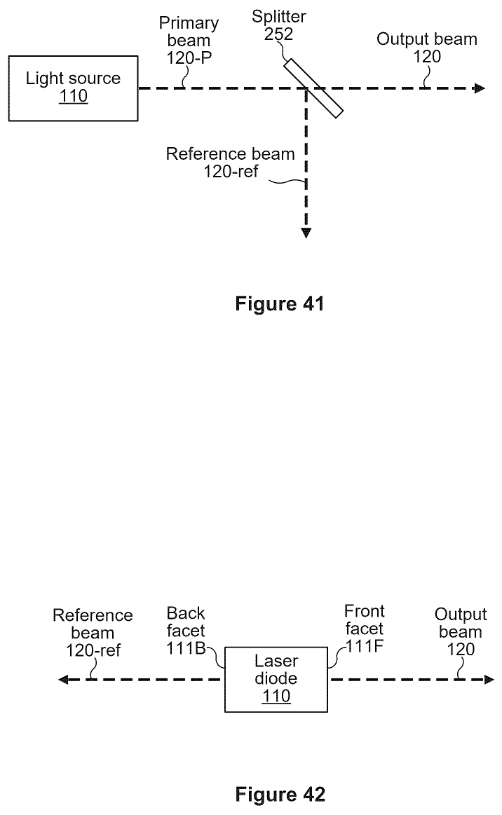

FIG. 41 illustrates an example light source 110 with an optical splitter 252 that produces an output beam 120 and a reference beam 120-ref. The light source 110 produces a primary beam of light 120-P, and the optical splitter 252 splits off a portion of the primary beam to produce the reference beam of light 120-ref. The remaining light from the primary beam 120-P that is not split off is transmitted through the splitter 252 to produce the output beam 120. The optical splitter 252 may be a free-space optical beamsplitter, a fiber-optic splitter, a waveguide-based splitter, a diffractive optical element, or a birefringent optical element (e.g., a Wollaston prism). The optical splitter 252 may split off any suitable portion of the primary beam of light 120-P to produce the reference beam of light 120-ref. For example, the optical splitter 252 may split off between approximately 1% and approximately 10% of the primary beam 120-P to produce the reference beam 120-ref, and the output beam 120 may include between approximately 90% and approximately 99% of the primary beam. If the optical splitter 252 splits off 2% of the primary beam 120-P, then the reference beam 120-ref may have approximately 2% of the optical power of the primary beam, and the output beam 120 may have approximately 98% of the optical power of the primary beam.

The light source 110 in FIG. 41 may be a Stokes light source 110S or a probe light source 110pr. For example, the light source 110 in FIG. 41 may be a Stokes light source 110S, where the output beam is the Stokes beam 120S, and the reference beam is the Stokes reference beam 120S-ref. As another example, the light source 110 in FIG. 41 may be a probe light source 110pr, where the output beam is the probe beam 120pr, and the reference beam is the probe reference beam 120pr-ref.

FIG. 42 illustrates an example reference beam 120-ref that is emitted from the back facet 111B of a laser diode 110. The laser diode 110 includes a back facet 111B and a front facet 111F, and the output beam 120 is emitted from the front facet. The laser diode 110 in FIG. 42 may be part of a Stokes light source 110S or part of a probe light source 110pr. For example, the laser diode 110 may be part of a Stokes light source 110S, where the Stokes beam 120S is emitted from the front facet 111F, and the Stokes reference beam 120S-ref is emitted from the back facet 111B. As another example, the laser diode 110 may be part of a probe light source 110pr, where the probe beam 120pr is emitted from the front facet 111F, and the probe reference beam 120pr-ref is emitted from the back facet 111B.

In each of FIGS. 41 and 42, the output beam 120 and the reference beam 120-ref may have the same optical frequency since they are derived from the same light source. Additionally, the two beams may each include approximately the same intensity noise, proportional to their respective powers. This common-mode noise that is present in both beams allows for an optical receiver 200 with balanced detection to provide an output signal or a subtraction signal having a reduced amount of noise. For example, the residual Stokes beam 120S′ and the Stokes reference beam 120S-ref in FIG. 40 may have approximately the same intensity noise, and subtracting two signals associated with the two beams may substantially remove the intensity noise associated with the Stokes and Stokes reference beams. Similarly, the probe beam 120pr and the probe reference beam 120pr-ref may have approximately the same intensity noise, and subtracting two signals associated with the two beams may substantially remove the intensity noise associated with the probe and probe reference beams.

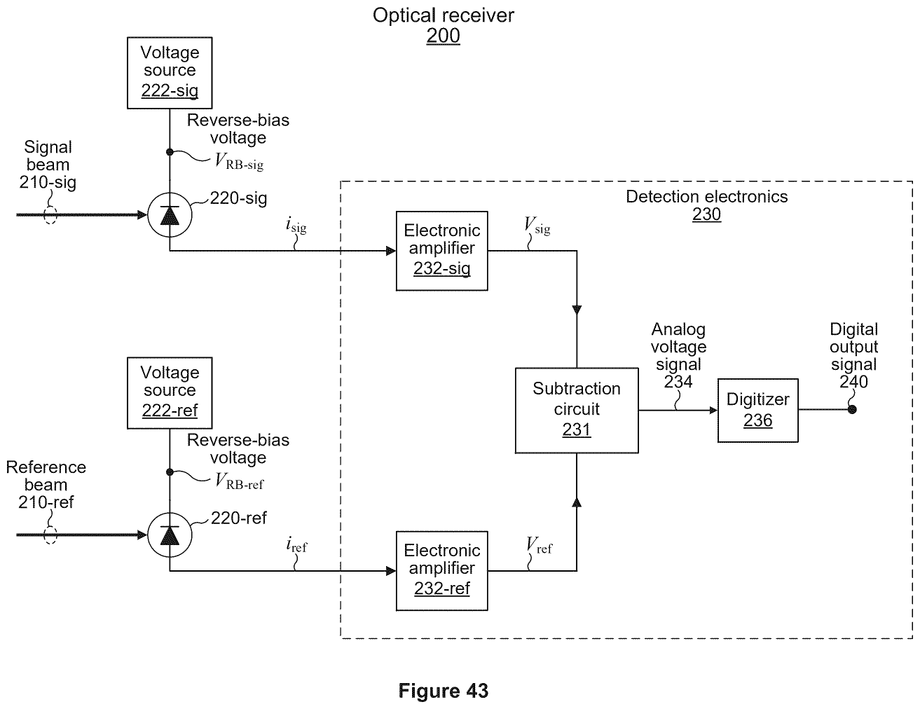

FIGS. 43-45 each illustrates an example optical receiver 200 of a Raman spectroscopy system 100 with balanced detection. Each optical receiver 200 includes a signal detector 220-sig and a reference detector 220-ref. The signal detector 220-sig receives a signal beam 210-sig (which includes a Raman signal 160, probe beam 120pr, and residual Stokes beam 120S′) and produces a signal photocurrent i_{sig} corresponding to the Raman signal, probe beam, and residual Stokes beam, where a portion of the signal photocurrent may correspond to coherent mixing between the Raman signal and the probe beam. The reference detector 220-ref receives a reference beam 210-ref (which includes a probe reference beam 120pr-ref and a Stokes reference beam 120S-ref) and produces a reference photocurrent i_{ref} corresponding to the probe and Stokes reference beams. The signal detector 220-sig and the reference detector 220-ref may each include an avalanche photodiode (APD), a PN photodiode, or a PIN photodiode. The voltage source 222-sig applies a reverse-bias voltage V_{RB-sig} to the signal detector 220-sig, and the voltage source 222-ref applies a reverse-bias voltage V_{RB-ref} to the reference detector 220-ref.

In each of FIGS. 43-45, the signal photocurrent i_{sig} produced by the signal detector 220-sig is directed to an electronic amplifier 232-sig, which may be referred to as a signal-photocurrent amplifier. The amplifier 232-sig receives the signal photocurrent i_{sig} and produces a signal-voltage output V_{sig} corresponding to the signal photocurrent i_{sig} (e.g., V_{sig} may be approximately proportional to i_{sig}). The signal-voltage output V_{sig} may be referred to as a signal voltage, a signal-voltage signal, or a signal-voltage output signal. The reference photocurrent i_{ref} produced by the reference detector 220-ref is directed to an electronic amplifier 232-ref, which may be referred to as a reference-photocurrent amplifier. The amplifier 232-ref receives the reference photocurrent i_{ref} and produces a reference-voltage output V_{ref} corresponding to the reference photocurrent i_{ref}. The reference-voltage output V_{ref} may be referred to as a reference voltage, a reference-voltage signal, or a reference-voltage output signal.

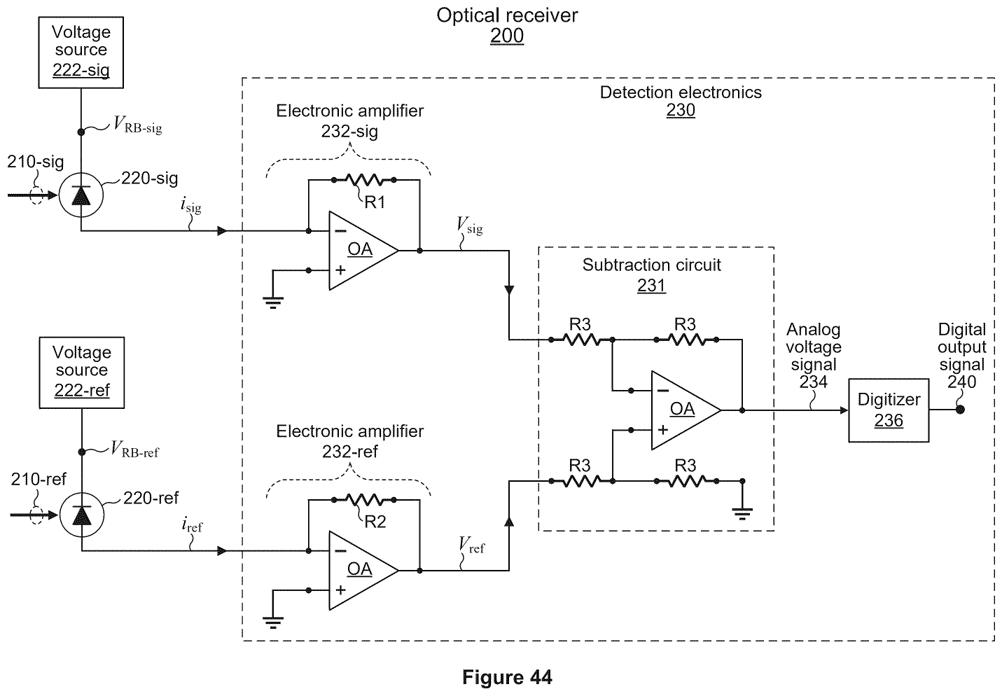

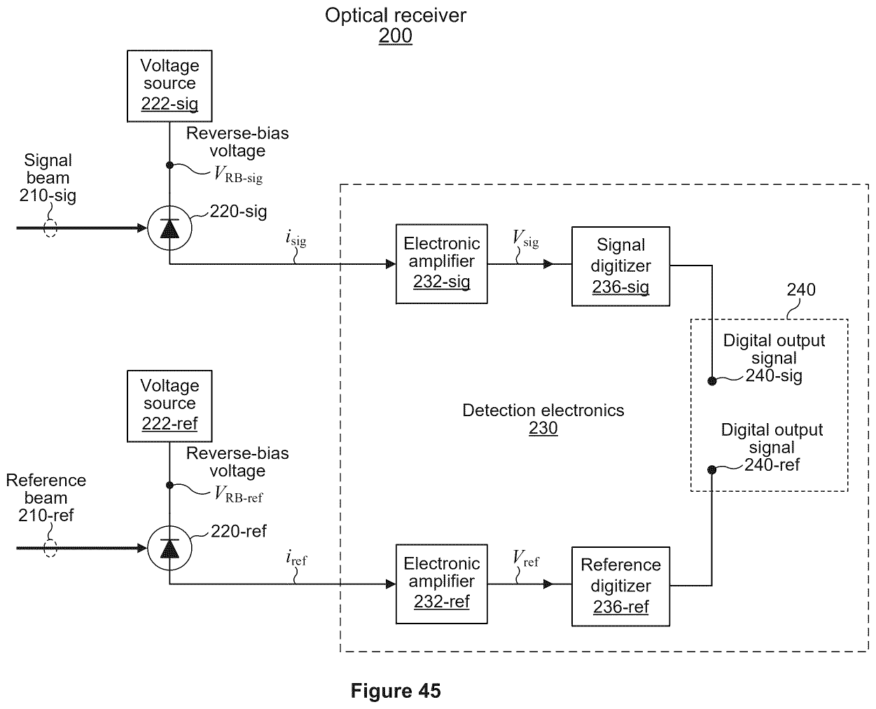

Each of the electronic amplifiers 232-sig and 232-ref in FIGS. 43 and 45 may be similar to the electronic amplifier 232 in FIG. 2. For example, the electronic amplifier 232-sig in FIG. 43 or 45 may include a transimpedance amplifier that amplifies the signal photocurrent i_{sig} to produce the signal-voltage output V_{sig}. As another example, the electronic amplifier 232-sig in FIG. 43 or 45 may include (i) a voltage amplifier that further amplifies an intermediate voltage signal produced by a transimpedance amplifier to produce the signal-voltage output V_{sig} or (ii) an electronic filter that filters the photocurrent signal, the intermediate voltage signal, or the voltage signal V_{sig}. Each of the electronic amplifiers 232-sig and 232-ref in FIG. 44 is a transimpedance amplifier that includes an operational amplifier OA (which may be referred to as an op amp) and a feedback resistor. Electronic amplifier 232-sig has a feedback resistor R1, and electronic amplifier 232-ref has a feedback resistor R2. The value of the feedback resistor sets the gain of the transimpedance amplifier in units of ohms (or, volts/ampere). For example, the feedback resistor R1 may have a value of 100) (which corresponds to a transimpedance gain of 100 V/A), and the signal-voltage output V_{sig} may be related to the signal photocurrent i_{sig} by the expression V_{sig}=R₁×i_{sig}. The transimpedance gain values R1 and R2 may be the same or may be different. For example, the electronic amplifier 232-sig may have a resistor R1 with a value of 100) (which corresponds to a transimpedance gain of 100 V/A), and the electronic amplifier 232-ref may have a resistor R2 with a value of 1000) (which corresponds to a 10-times higher transimpedance gain of 1000 V/A).

In FIG. 43, the subtraction circuit 231 (which may be referred to as a subtraction module) produces an analog voltage signal 234 (which may be referred to as a subtraction signal). The subtraction signal 234 may correspond to or may be equal to the difference between (i) a signal corresponding to the signal photocurrent i_{sig} and (ii) a signal corresponding to the reference photocurrent i_{ref}. For example, the subtraction circuit 231 may subtract the reference-voltage output V_{ref} from the signal-voltage output V_{sig} to produce the voltage signal 234. The voltage signals V_{sig} and V_{ref} may correspond to or may be proportional to the respective photocurrents i_{sig} and i_{ref}, and the subtraction signal 234 may be equal to or proportional to V_{sig}−V_{ref}. For example, the subtraction circuit 231 in FIG. 43 may include an analog voltage-subtraction circuit, and the voltage signal 234 may be equal to V_{sig}−V_{ref}. Alternatively, the subtraction circuit 231 may include an analog voltage-subtraction circuit followed by a voltage amplifier that produces a voltage signal 234 that is equal to g(V_{sig}−V_{ref}), where g is the gain of the voltage-amplifier stage. The subtraction circuit 231 in FIG. 43 may include an electronic filter that filters the voltage signal 234. For example, the subtraction circuit 231 may include a low-pass electronic filter that removes high-frequency components (e.g., frequency components above 5 GHz) from the voltage signal 234. The subtraction circuit 231 in FIG. 44 includes an op amp with four resistors R3 and is configured as a unity-gain subtraction circuit, and the analog voltage signal 234 produced by the subtraction circuit 231 is approximately equal to V_{sig}−V_{ref}.

In FIGS. 43-44, the analog voltage signal 234 is sent to a digitizer 236 that digitizes the voltage signal to produce a digital output signal 240. The digital output signal 240 may include a digital representation of the analog voltage signal 234 (which may be referred to as a digital representation of the subtraction signal). The digital output signal 240 is sent to a processor, and the processor determines a characteristic of the analog voltage signal 234 based on the digital output signal 240. The characteristic of the analog voltage signal 234 may be referred to as a characteristic of the subtraction signal. The characteristic of the subtraction signal determined by the processor may include one or more of: a peak amplitude, an average amplitude, an amplitude at a particular frequency, an amplitude at a particular time, an amplitude at a frequency center, an amplitude at a temporal center, a DC offset, an area, a frequency, a phase, and a polarization.

In each of FIGS. 43 and 44, the detection electronics 230 includes one digitizer 236 that digitizes a subtraction signal 234 to produce a digital output signal 240 that includes a digital representation of the subtraction signal. In FIG. 45, the detection electronics 230 includes two digitizers: a signal digitizer 236-sig and a reference digitizer 236-ref. The signal-photocurrent amplifier 232-sig receives the signal photocurrent i_{sig} and produces a corresponding signal-voltage output V_{sig} that is sent to the signal digitizer 236-sig. The digitizer 236-sig produces a first digital output signal 240-sig that includes a digital representation of the signal-voltage output V_{sig}. Similarly, the reference-photocurrent amplifier 232-ref receives the reference photocurrent i_{ref} and produces a corresponding reference-voltage output V_{ref} that is sent to the reference digitizer 236-ref. The digitizer 236-ref produces a second digital output signal 240-ref that includes a digital representation of the reference-voltage output V_{ref}. The signal detector 220-sig together with the signal-photocurrent amplifier 232-sig and the signal digitizer 236-sig may be referred to as a signal-detection channel. Similarly, the reference detector 220-ref together with the reference-photocurrent amplifier 232-ref and the reference digitizer 236-ref may be referred to as a reference-detection channel.

In FIG. 45, the digital output signal 240 that is sent to a processor includes the two digital output signals 240-sig and 240-ref. The processor may determine a subtraction signal from the digital representations of the signal-voltage output V_{sig} and the reference-voltage output V_{ref}, and a characteristic 162 of the subtraction signal may be determined from the digital subtraction signal. For example, the processor may subtract the digital representation of the reference-voltage output (which is part of the digital output signal 240-ref) from the digital representation of the signal-voltage output (which is part of the digital output signal 240-sig) to determine the subtraction signal. In this embodiment, the subtraction of signals corresponding to the signal photocurrent and reference photocurrent occurs at the processor, and the subtraction module may be referred to as being part of the processor. In some embodiments, a portion of the processor may be located in the detection electronics 230, and that portion of the processor may include a subtraction module that performs the subtraction operation.

In FIGS. 43-45, the photocurrent i from each detector 220 is sent to an electronic amplifier 232 that produces a corresponding voltage signal. In other embodiments, the signal detector 220-sig and the reference detector 220-ref may be coupled together so that their photocurrents are subtracted (e.g., similar to the detector configuration in FIG. 36). The two photocurrents i_{sig} and i_{ref} may be subtracted to produce a subtraction photocurrent signal equal to i_{sig}−i_{ref}. The subtraction photocurrent signal may be sent to an electronic amplifier 232 that produces a corresponding subtraction signal (which may be a voltage signal), and the subtraction signal may be sent to a digitizer 236.

A subtraction signal 234 that equals the difference between (i) a signal corresponding to the signal photocurrent i_{sig} and (ii) a signal corresponding to the reference photocurrent i_{ref} may be expressed as g(g₁R₁i_{sig}−g₂R₂i_{ref}) or as g(V_{sig}−V_{ref}). In these expressions for the subtraction signal, the parameter g may represent the gain (in units V/V) of a voltage-amplifier stage that amplifies the difference between the voltage signals V_{sig} and V_{ref}. The signal-voltage output V_{sig} (which may be referred to as corresponding to the signal photocurrent i_{sig}) may be expressed as g₁R₁i_{sig}, where R₁ is the transimpedance gain (in units V/A) of a signal transimpedance amplifier that amplifies the signal photocurrent, and g₁ is the gain (in units V/V) of a voltage-amplifier stage that further amplifies an intermediate voltage signal produced by the signal transimpedance amplifier. Similarly, the reference-voltage output V_{ref} (which may be referred to as corresponding to the reference photocurrent i_{ref}) is expressed as g₂R₂i_{ref}, where R₂ is the transimpedance gain of a reference transimpedance amplifier that amplifies the reference photocurrent, and g₂ is the gain (in units V/V) of a voltage-amplifier stage that further amplifies an intermediate voltage signal produced by the reference transimpedance amplifier. In a system without a voltage-amplifier stage that amplifies the difference between the voltage signals V_{sig} and V_{ref}, the gain parameter g equals one, and the subtraction signal may be expressed as g₁R₁i_{sig}−g₂R₂i_{ref}. In a system without voltage-amplifier stages that amplify intermediate voltage signals, the gain parameters g₁ and g₂ are equal to one, and the subtraction signal may be expressed as g(R₁i_{sig}−R₂i_{ref}). In a system without voltage-amplifier stages, the gain parameters g, g₁, and g₂ are equal to one, and the subtraction signal may be expressed as R₁i_{sig}−R₂i_{ref}.

A subtraction signal may be an analog signal or a digital signal, and a subtraction signal may be produced using analog electronics, digital electronics, or a combination of analog and digital electronics. For example, the analog voltage signal 234 in FIG. 44 is an analog subtraction signal that is produced using analog electronics, and the digitizer 236 produces a digital representation of the subtraction signal that may be sent to a processor as part of the digital output signal 240. As another example, the digital output signals 240-sig and 240-ref in FIG. 45 may include digital representations of the analog voltage signals V_{sig} and V_{ref}, and a processor may determine a digital subtraction signal based on the digital output signals 240-sig and 240-ref. The processor may additionally apply a gain value g₁ or g₂ to the digital representation of the analog voltage signal V_{sig} or V_{ref} prior to determining the digital subtraction signal. For example, the digital subtraction signal may be determined digitally from the expression g₁V_{sig}−g₂V_{ref}, where in this expression, V_{sig} and V_{ref} are the digital representations of the corresponding analog voltage signals, and the gain values g₁ and g₂ may be referred to as calibration factors. As another example, the digital subtraction signal may be determined digitally from the expression V_{sig}−g₂V_{ref}, where g₂ is a calibration factor that scales the digital signal V_{ref} before it is subtracted from the digital signal V_{sig}.

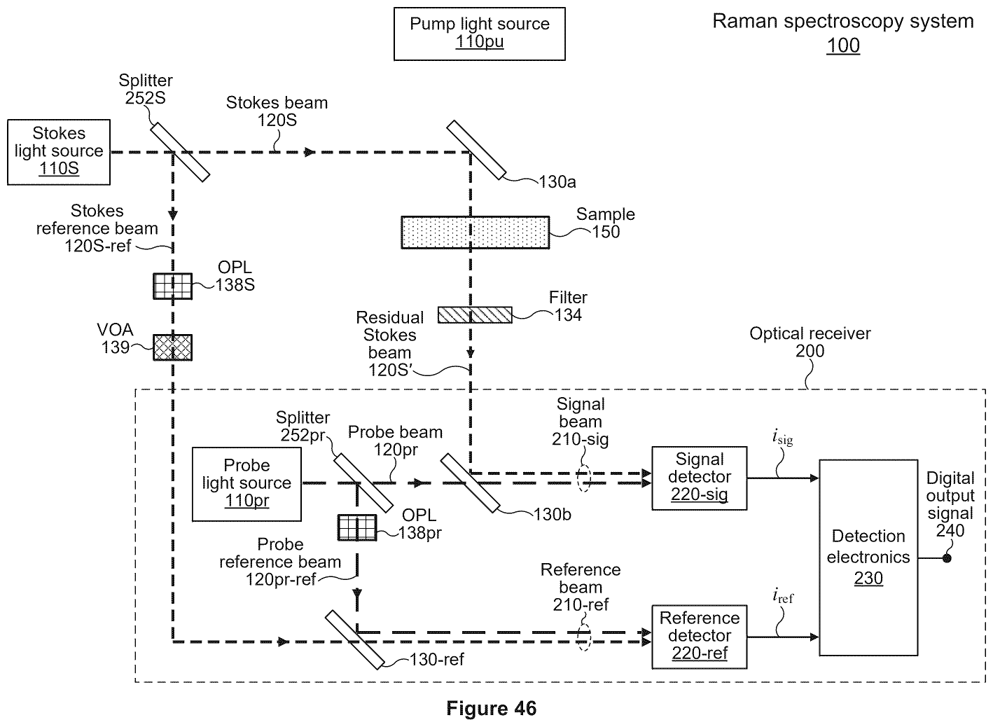

FIG. 46 illustrates the example Raman spectroscopy system 100 of FIG. 40 operating in a calibration mode. A calibration procedure may be performed by a Raman spectroscopy system with balanced detection and may include an amplitude calibration or a temporal calibration. An amplitude calibration may be performed to balance the relative gain associated with the signal and reference detectors. A temporal calibration may be performed to (i) adjust a time delay between the Stokes beam 120S and the Stokes reference beam 120S-ref or (ii) adjust a time delay between the probe beam 120pr and the probe reference beam 120pr-ref.

During a calibration procedure, the pump beam 120pu may be turned off or blocked. For example, a processor may send an instruction to turn off the pump light source 110pu or to block the pump beam of light 120pu. The pump beam 120pu may be turned off or blocked so that little or no light from the pump light source 110pu reaches the sample 150 or reaches the signal or reference detector. For example, if the average optical power of the pump beam 120pu in FIG. 40 is Pₚᵤₘₚ, then when the pump beam 120pu is turned off or blocked, the amount of power from the pump light source 110pu that reaches the sample 150 or either of the detectors may be less than 1% of the pump-beam power Pₚᵤₘₚ. If the pump light source 110pu includes a laser diode, then the pump laser diode may be turned off by instructing an electronic driver 112 to supply little or no drive current to the pump laser diode. Alternatively, the processor may send an instruction to block the pump beam by inserting a mechanical beam blocker into the path of the pump beam or by switching an optical switch into a state that prevents the pump beam from reaching the sample. Since a calibration procedure may primarily involve the Stokes light source 110S or the probe light source 110pr, the pump beam 120pu may be turned off or blocked to prevent unnecessary pump light from reaching the signal and reference detectors. Additionally, since a Raman signal 160 may not be needed for a calibration procedure, turning off or blocking the pump beam 120pu prevents the sample 150 from producing a Raman signal 160 by coherent Raman scattering of the pump and Stokes beams. After a calibration procedure is performed, the pump beam 120pu may be turned on or unblocked, and a measurement of the resulting Raman signal 160 may be performed (e.g., as illustrated in FIG. 40).

A calibration procedure for a Raman spectroscopy system 100 with balanced detection may be performed at any suitable time and any suitable number of times. For example, a calibration procedure may be performed as a factory calibration before a system is shipped to a customer. Additionally or alternatively, a calibration procedure may be performed multiple times during operation of a Raman spectroscopy system 100 with balanced detection. For example, an amplitude calibration may be performed (i) each time a new sample 150 is inserted into the system, (ii) each time the frequency offset Ω between the pump and Stokes beams is changed, or (iii) prior to the measurement of a signal characteristic 162. As another example, an amplitude calibration may be performed each time the frequency of the probe beam 120pr is changed and prior to the measurement of a signal characteristic 162 (e.g., in FIG. 11, an amplitude calibration may be performed prior to the measurement of each of the signal characteristics 162-1, 162-2, 162-3, . . . 162-n). As another example, a temporal calibration may be performed each time a new sample 150 is inserted into a Raman spectroscopy system 100 with balanced detection.

To perform an amplitude calibration, the pump beam of light 120pu may first be turned off or blocked so that little or no light from the pump light source 110pu reaches the sample 150 or reaches the signal or reference detector. An amplitude calibration may be performed with both the Stokes light source 110S and probe light source 110pr operating so that the residual Stokes beam 120S′, Stokes reference beam 120S-ref, probe beam 120pr, and probe reference beam 120pr-ref are present and are directed to the associated signal or reference detector. In other embodiments, in addition to turning off or blocking the pump beam 120pu, an amplitude calibration may be performed with (i) the probe light source 110pr turned off (or the probe and probe reference beams blocked) and (ii) the Stokes light source 110S operating so that the residual Stokes beam 120S′ is directed to the signal detector 220-sig and the Stokes reference beam 120S-ref is directed to the reference detector 220-ref. Alternatively, an amplitude calibration may be performed with (i) the Stokes light source 110S turned off (or the Stokes and Stokes reference beams blocked) and (ii) the probe light source 110pr operating so that the probe beam 120pr is directed to the signal detector 220-sig and the probe reference beam 120pr-ref is directed to the reference detector 220-ref.

The amplitude calibration illustrated in FIG. 46 is performed with both the Stokes light source 110S and probe light source 110pr operating. Additionally, the pump light source 110pu is turned off so that no pump beam is produced. The Stokes beam 120S is directed to the sample 150, and the residual Stokes beam 120S′ is produced after the Stokes beam has interacted with the sample. The signal beam 210-sig, which includes the probe beam 120pr and the residual Stokes beam 120S′, is directed to the signal detector 220-sig, and the signal detector produces a signal calibration photocurrent i_{sig} corresponding to the probe and residual Stokes beams. The reference beam 210-ref, which includes the probe reference beam 120pr-ref and the Stokes reference beam 120S-ref, is directed to the reference detector 220-ref, and the reference detector produces a reference calibration photocurrent i_{ref} corresponding to the probe and Stokes reference beams.

The detection electronics 240 in FIG. 46 may produce a digital output signal 240 that corresponds to the signal and reference calibration photocurrents. The digital output signal 240 is sent to a processor, and based on the digital output signal, the processor may adjust a gain associated with the signal or reference detector to balance the signal and reference detectors. The digital output signal 240 may include a digital representation of a subtraction calibration signal that corresponds to the difference between (i) a signal corresponding to the signal calibration photocurrent i_{sig} and (ii) a signal corresponding to the reference calibration photocurrent i_{ref} (e.g., as produced by the detection electronics 230 in FIGS. 43-44). Alternatively, the digital output signal 240 may include two digital output signals 240-sig and 240-ref that correspond to the respective signal and reference calibration photocurrents (e.g., as produced by the detection electronics 230 in FIG. 45).

The signal and reference detectors may be balanced by adjusting a gain associated with the signal detector or a gain associated with the reference detector. For example, the signal and reference detectors may be balanced so that a signal-voltage output V_{sig} corresponding to the signal calibration photocurrent i_{sig} is approximately equal to a reference-voltage output V_{ref} corresponding to the reference calibration photocurrent i_{ref}. Additionally or alternatively, the signal and reference detectors may be balanced so that a subtraction calibration signal corresponding to a difference between the signal calibration photocurrent i_{sig} and the reference calibration photocurrent i_{ref} is approximately zero, has an average value of approximately zero, or is minimized. A subtraction calibration signal corresponding to a difference between the signal and reference calibration photocurrents may include a difference between a signal-voltage output V_{sig} corresponding to the signal calibration photocurrent i_{sig} and a reference-voltage output V_{ref} corresponding to the reference calibration photocurrent i_{ref} (e.g., the subtraction calibration signal may be expressed as V_{sig}−V_{ref}).

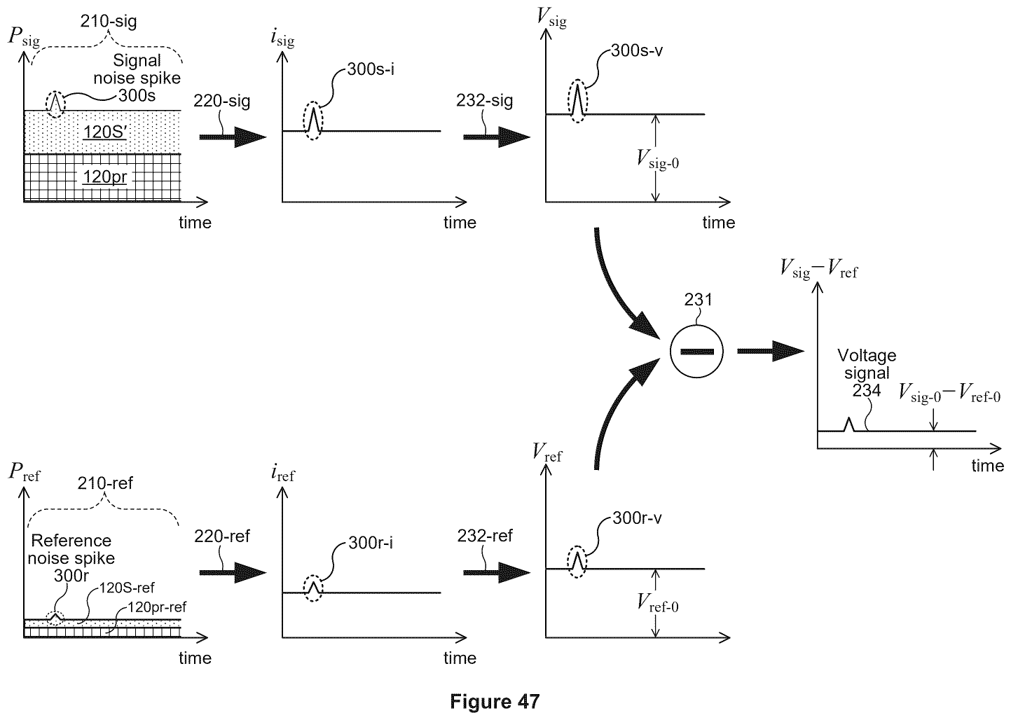

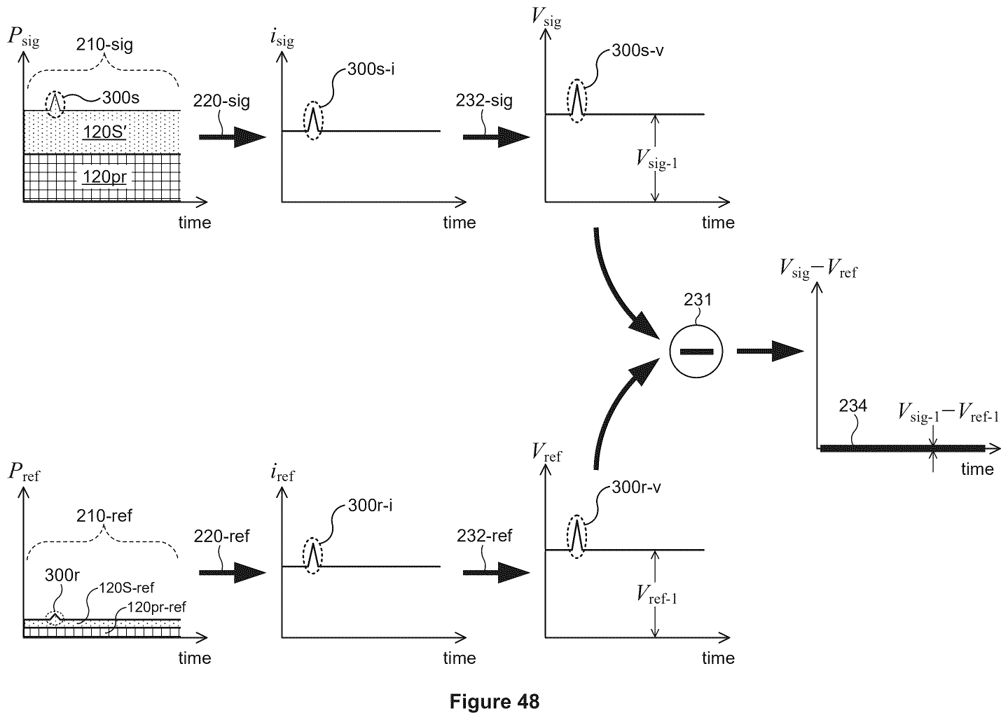

FIGS. 47-48 illustrate example plots of optical power, photocurrent, and voltage before (FIG. 47) and after (FIG. 48) an amplitude calibration has been performed. Before calibration (in FIG. 47) the subtraction signal V_{sig}−V_{ref} has a DC offset and a noise spike, while after calibration (in FIG. 48) the subtraction signal is approximately zero. The plots of P_{sig} in each of FIGS. 47 and 48 illustrate the optical power of the signal beam 210-sig in FIG. 46, and the plots of P_{ref} illustrate the optical power of the reference beam 210-ref in FIG. 46. The P_{sig} plots indicate that the signal beam 210-sig includes light from the residual Stokes beam 120S′ and light from the probe beam 120pr. Similarly, the P_{ref} plots indicate that the reference beam 210-ref includes light from the Stokes reference beam 120S-ref and light from the probe reference beam 120pr-ref. The optical power of the signal and reference beams may not be equal. In FIGS. 47-48, the optical power of the signal beam 210-sig is approximately five times greater than the optical power of the reference beam 210-ref.

The P_{sig} plot includes a signal noise spike 300s, and the P_{ref} plot includes a corresponding reference noise spike 300r. The two noise spikes 300s and 300r may originate from the same noise spike in the light produced by the Stokes light source 110S, and this noise spike may appear in both the Stokes beam 120S (as well as the residual Stokes beam 120S′) and the Stokes reference beam 120S-ref. The light produced by both the Stokes light source 110S and the probe light source 110pr may each include intensity noise that appears in the signal and reference beams, and the intensity noise may have any suitable amplitude and frequency distribution. For example, intensity noise may include multiple noise spikes of varying amplitude, width, or frequency occurring over time. For ease of illustration and discussion, the signal and reference beams in FIGS. 47-48 are shown as including a single noise spike. For a Raman spectroscopy system 100 with balanced detection in which the signal and reference detectors are balanced, intensity noise (e.g., including the noise spikes 300s and 300r) may be substantially removed from a subtraction signal (e.g., as illustrated by the subtraction signal V_{sig}−V_{ref} in FIG. 48).

The plots of i_{sig} in each of FIGS. 47 and 48 illustrate the signal calibration photocurrents produced by the signal detector 220-sig in FIG. 46 in response to the signal beam 210-sig. The noise spike 300s from the signal beam 210-sig results in a corresponding current noise spike 300s-i in the signal photocurrent i_{sig}. Similarly, the plots of i_{ref} in each of FIGS. 47 and 48 illustrate the reference calibration photocurrents produced by the reference detector 220-ref in FIG. 46 in response to the reference beam 210-ref. The noise spike 300r from the reference beam 210-ref results in a corresponding current noise spike 300r-i in the reference photocurrent i_{ref}.

The plots of V_{sig} in each of FIGS. 47 and 48 illustrate a signal-voltage output corresponding to the signal calibration photocurrent i_{sig}, and each plot of V_{sig} includes a voltage noise spike 300s-v corresponding to the current noise spike 300s-i. Similarly, the plots of V_{ref} in each of FIGS. 47 and 48 illustrate a reference-voltage output corresponding to the reference calibration photocurrent i_{ref}, and each plot of V_{ref} includes a voltage noise spike 300r-v corresponding to the current noise spike 300r-i. The signal-voltage output V_{sig} and the reference-voltage output V_{ref} may each be produced by an electronic amplifier 232 (e.g., as illustrated in FIGS. 43-45). The output signals V_{sig} and V_{ref} in each of FIGS. 47 and 48 are sent to a subtraction module 231, which produces a voltage signal 234 (which may be referred to as a subtraction calibration signal) that is equal to V_{sig}−V_{ref}.

As discussed with respect to FIGS. 43-44, a digitizer 236 may digitize the voltage signal 234 to produce a digital output signal 240 that is sent to a processor. This digital output signal 240 may include a digitized representation of the subtraction calibration signal V_{sig}−V_{ref} in FIGS. 47-48. Alternatively, as discussed with respect to FIG. 45, two digitizers 236 may be used to digitize the two output signals V_{sig} and V_{ref}, and the digital output signal 240 that is sent to a processor may include digital representations of the signal-voltage output V_{sig} and the reference-voltage output V_{ref}. In this case, the processor may subtract the two digital signals to determine a subtraction calibration signal, or the processor may instead analyze the two digital signals separately without subtracting them. In either case, the processor receives a digital signal 240 (which may include a digitized representation of a subtraction signal V_{sig}−V_{ref} or digitized representations of two output signals V_{sig} and V_{ref}), and based on the digital signal, the processor determines an amount of gain adjustment to apply to the signal or reference detector to balance the detectors.

The signal and reference detectors may be referred to as being balanced when the amplitude of a subtraction calibration signal is less than 10%, 5%, or 1% of the amplitude of a signal corresponding to the signal calibration photocurrent or the reference calibration photocurrent. In FIGS. 47-48, the voltage signals V_{sig} and V_{ref} correspond to the signal calibration photocurrent and the reference calibration photocurrent, respectively. Additionally, the subtraction calibration signal (which equals the difference between a signal corresponding to the signal calibration photocurrent and a signal corresponding to the reference calibration photocurrent) may be expressed as V_{sig}−V_{ref}. The signal and reference detectors may be balanced when the amplitude of the subtraction calibration signal |V_{sig}−V_{ref}| is less than 10%, 5%, or 1% of V_{sig} or when |V_{sig}−V_{ref}| is less than 10%, 5%, or 1% of V_{ref}. For example, to balance the signal and reference detectors, the gain associated with the signal or reference detector may be adjusted so that the amplitude of the subtraction calibration signal |V_{sig}−V_{ref}| is less than 10% of V_{sig} or V_{ref}. As another example, the signal and reference detectors may be balanced when |V_{sig}−V_{ref}|<(0.1) V_{sig} or |V_{sig}−V_{ref}|<(0.1)V_{ref}. The voltage signals V_{sig} and V_{ref} have respective amplitudes of approximately V_{sig-0} and V_{ref-0} in FIG. 47 and respective amplitudes of approximately V_{sig-1} and V_{ref-1} in FIG. 48. In FIG. 47, the amplitude of the subtraction calibration signal V_{sig-0}−V_{ref-0} is greater than 10% of both V_{sig-0} and V_{ref-0}, and the signal and reference detectors may be referred to as not being balanced. In FIG. 48, the amplitude of the subtraction calibration signal V_{sig-1}−V_{ref-1} is less than 10% of both V_{sig-1} and V_{ref-1}, and the signal and reference detectors may be referred to as being balanced.

A signal detector 220-sig or a reference detector 220-ref may include an avalanche photodiode (APD), and adjusting the gain associated with the signal or reference detector may include adjusting the reverse-bias voltage applied to the APD. For example, the signal detector 220-sig and the reference detector 220-ref in each of FIGS. 43-45 may be an APD. The voltage source 222-sig may be an adjustable voltage source that can adjust the reverse-bias voltage V_{RB-sig} applied to the signal detector 220-sig. Additionally or alternatively, the voltage source 222-ref may be an adjustable voltage source that can adjust the reverse-bias voltage V_{RB-ref} applied to the reference detector 220-ref. As another example, the reference detector 220-ref in each of FIGS. 43-45 may be an APD, and the gain associated with the reference detector may be adjusted by changing the reverse-bias voltage V_{RB-ref}. For the reference-signal plots in FIG. 47, the reverse-bias voltage V_{RB-ref} may be set to 40 V, and in FIG. 48, the reverse-bias voltage may be increased to 50 V to increase the gain of the reference detector 220-ref and to balance the signal and reference detectors.

Each of the signal and reference detectors in a balanced optical receiver 200 may be coupled to an electronic amplifier 232. In FIGS. 43-45, the electronic amplifier 232-sig produces a signal-voltage output V_{sig} corresponding to the signal calibration photocurrent i_{sig}, and the electronic amplifier 232-ref produces a reference-voltage output V_{ref} corresponding to the reference calibration photocurrent i_{ref}. Adjusting the gain associated with the signal or reference detector to balance the detectors may include adjusting the gain of one or both of the electronic amplifiers 232-sig and 232-ref. For example, the electronic amplifier 232-sig or 232-ref in FIG. 43 or 45 may include a transimpedance amplifier or a voltage amplifier with an adjustable gain, and adjusting the gain associated with the signal detector 220-sig or the reference detector 220-ref may include adjusting the gain of the transimpedance amplifier or voltage amplifier. As another example, the gain of the amplifier 232-ref that produces the reference-voltage output V_{ref} in FIG. 47 may be increased to produce the reference-voltage output V_{ref} in FIG. 48, which results in balanced signal and reference detectors.

The digital output signal 240 in FIG. 45 includes digital output signal 240-sig (which corresponds to signal photocurrent i_{sig}) and digital output signal 240-ref (which corresponds to reference photocurrent i_{sig}). The digital output signals 240-sig and 240-ref may be sent to a processor, and the processor may adjust a gain associated with the signal detector 220-sig or the reference detector 220-ref by setting the value of a calibration factor that is applied to one of the digital output signals 240-sig and 240-ref. The calibration factor (which may be referred to as a gain value) may be a multiplier, and to balance the signal and reference detectors, the processor may multiply the values of a subsequent digital output signal 240-sig or 240-ref by the calibration factor. For example, the calibration factor may be determined as a ratio of values of the calibration voltage signals V_{sig} and V_{ref} (e.g., the calibration factor may be g₂=V_{sig}/V_{ref}, where V_{sig} and V_{ref} are average values or DC values of the calibration voltage signals). In the example of FIG. 47, V_{sig-0} and V_{ref-0} may have values of 5 volts and 4 volts, respectively, and the calibration factor g₂ may be determined to be 5/4 (or, 1.25). The reference-voltage output V_{ref} in FIG. 48 may correspond to the reference-voltage output V_{ref} in FIG. 47 after being multiplied by the calibration factor 1.25. Additionally, when the Raman spectroscopy system is operating to measure a Raman signal, the values of a subsequently acquired digital output signal 240-ref may be multiplied by 1.25 before the digital output signal 240-ref is subtracted from or compared to a corresponding digital output signal 240-sig. For example, a processor may determine a digital subtraction signal from the expression V_{sig}−g₂V_{ref}, where the calibration factor g₂ equals 1.25.

In FIGS. 40 and 46, the Stokes reference beam 120S-ref travels through a variable optical attenuator (VOA) 139. The VOA 139 is an optical component that decreases the optical power of light that is transmitted through the VOA. The VOA 139 may provide a fixed amount of optical attenuation, or the amount of attenuation may be mechanically or electronically adjustable to increase or decrease the amount of attenuation. For example, a processor may send an instruction to the VOA 139 to adjust the optical attenuation provided by the VOA. In FIG. 46, the VOA 139 may be adjusted to change the amount of optical power in the Stokes reference beam 120S-ref that is transmitted through the VOA and directed to the reference detector 220-ref. Additionally or alternatively, a Raman spectroscopy system 100 with balanced detection may include a VOA (not illustrated in FIG. 46) configured to change the optical power of the probe reference beam of light 120pr-ref. Adjusting the gain associated with the signal or reference detector to balance the detectors may include using a VOA 139 to change the optical power of the probe reference beam of light 120pr-ref or the Stokes reference beam of light 120S-ref. For example, the optical attenuation provided to the Stokes reference beam 120S-ref by the VOA 139 in FIG. 46 may be adjusted until the voltage signal 234 in FIG. 47 is minimized, is approximately zero, or has an average value of approximately zero (e.g., as illustrated by the voltage signal 234 in FIG. 48). As another example, a Raman spectroscopy system 100 with balanced detection may include a VOA configured to change the amount of power in the reference beam 210-ref (which includes both the Stokes and probe reference beams), and the optical attenuation of the VOA may be adjusted until a subtraction calibration signal V_{sig}− V_{ref} is minimized, is approximately zero, or has an average value of approximately zero. In some embodiments, a Raman spectroscopy system 100 with balanced detection may include a VOA 139 configured to change the optical power of the Stokes beam 120S, residual Stokes beam 120S′, or probe beam 120pr.

In some embodiments, an amplitude calibration may be performed with (i) the pump light source 110pu turned off or the pump beam 120pu blocked, (ii) the probe light source 110pr turned off or the probe and probe reference beams blocked, and (iii) the Stokes light source 110S operating so that the residual Stokes beam 120S′ is directed to the signal detector 220-sig and the Stokes reference beam 120S-ref is directed to the reference detector 220-ref. In this embodiment, the residual Stokes beam 120S′ comprises most or all of the light that reaches the signal detector 220-sig, and the Stokes reference beam 120S-ref comprises most or all of the light that reaches the reference detector 220-ref (e.g., little or no light from the probe beam 120pr or probe reference beam 120pr-ref reaches either detector). The signal detector 220-sig produces a signal calibration photocurrent i_{sig} corresponding to the residual Stokes beam 120S′, and the reference detector 220-ref produces a reference calibration photocurrent i_{ref} corresponding to the Stokes reference beam 120S-ref. The detection electronics 240 may produce a digital output signal 240 that corresponds to the signal and reference calibration photocurrents, and based on the digital output signal, the processor may adjust the gain associated with the signal or reference detector to balance the signal and reference detectors.

In some embodiments, an amplitude calibration may be performed with (i) the pump light source 110pu turned off or the pump beam 120pu blocked, (ii) the Stokes light source 110S turned off or the Stokes and Stokes reference beams blocked, and (iii) the probe light source 110pr operating so that the probe beam 120pr is directed to the signal detector 220-sig and the probe reference beam 120pr-ref is directed to the reference detector 220-ref. In this embodiment, the probe beam 120pr comprises most or all of the light that reaches the signal detector 220-sig, and the probe reference beam 120pr-ref comprises most or all of the light that reaches the reference detector 220-ref (e.g., little or no light from the residual Stokes beam 120S′ or the Stokes reference beam 120S-ref reaches either detector). The signal detector 220-sig produces a signal calibration photocurrent i_{sig} corresponding to the probe beam 120pr, and the reference detector 220-ref produces a reference calibration photocurrent i_{ref} corresponding to the probe reference beam 120pr-ref. The detection electronics 240 may produce a digital output signal 240 that corresponds to the signal and reference calibration photocurrents, and based on the digital output signal, the processor may adjust the gain associated with the signal or reference detector to balance the signal and reference detectors.

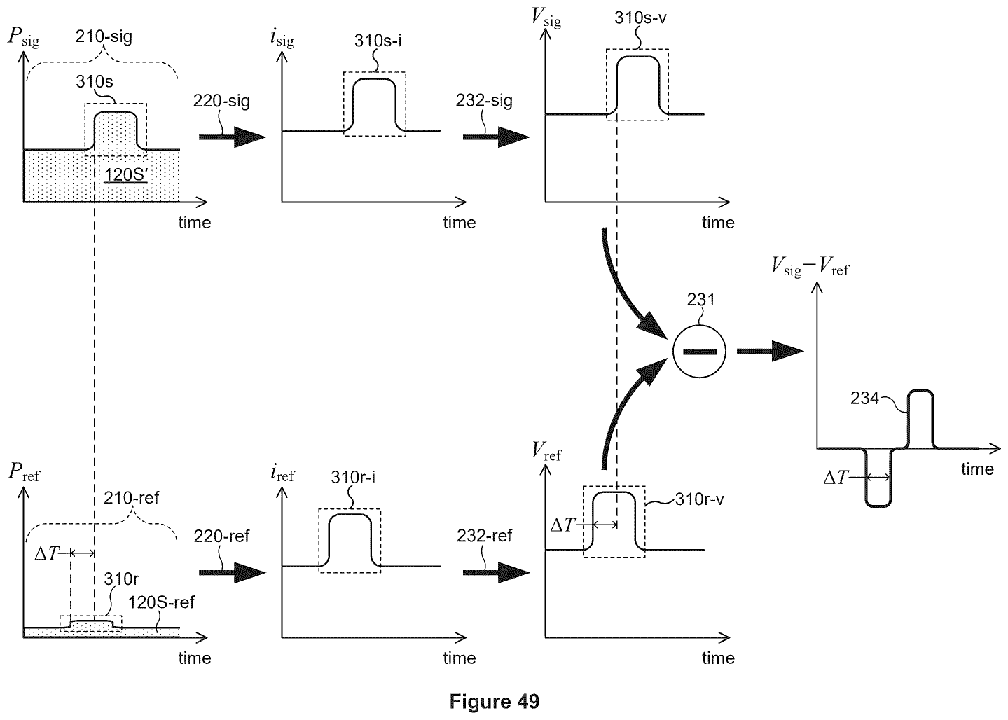

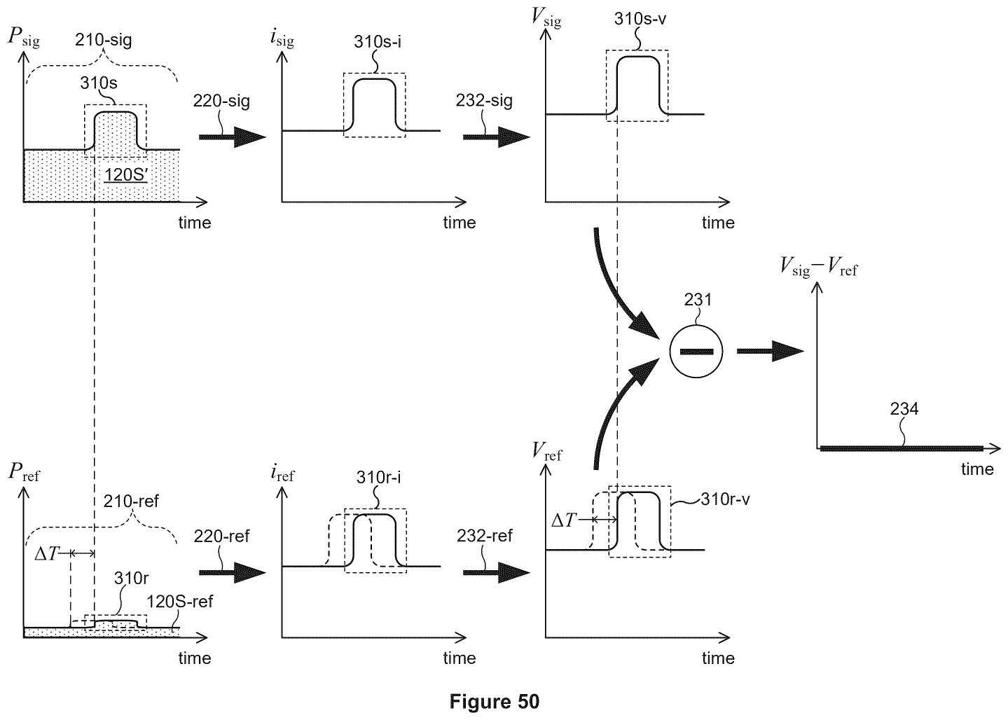

FIGS. 49-50 illustrate example plots of optical power, photocurrent, and voltage before (FIG. 49) and after (FIG. 50) a temporal calibration has been performed. The temporal calibration in FIGS. 49-50, which may be referred to as a Stokes-beam temporal calibration, is performed to adjust a time delay between the Stokes beam 120S and the Stokes reference beam 120S-ref. A similar temporal calibration (which may be referred to as a probe-beam temporal calibration) may be performed to adjust a time delay between the probe beam 120pr and the probe reference beam 120pr-ref. A temporal calibration may be performed with the pump light source 110pu turned off or the pump beam 120pu blocked, or a temporal calibration may be performed with the pump light source 110pu operating and the pump beam unblocked. A Stokes-beam temporal calibration may be performed with the probe light source 110pr turned off or the probe and probe reference beams blocked, or the temporal calibration may be performed with the probe light source 110pr operating and the probe and probe reference beams unblocked. A probe-beam temporal calibration may be performed with the Stokes light source 110S turned off or the Stokes and Stokes reference beams blocked, or the temporal calibration may be performed with the Stokes light source 110pr operating and the Stokes and Stokes reference beams unblocked. In FIGS. 49-50, the Stokes-beam temporal calibration is shown with only the Stokes light source 110S operating, and both the pump light source 110pu and probe light source 110pr are turned off (or their respective beams are blocked).

The plots of P_{sig} in each of FIGS. 49 and 50 illustrate the optical power of the signal beam 210-sig, and the plots of P_{ref} illustrate the optical power of the reference beam 210-ref. Since the pump and probe light sources are turned off (or their respective beams are blocked), the residual Stokes beam 120S′ makes up most or all of the signal beam 210-sig, and the Stokes reference beam 120S-ref makes up most or all of the reference beam 210-ref. A processor may instruct the Stokes light source 110S to produce a transient optical signal so that the Stokes beam 120S (as well as the residual Stokes beam 120S′) and the Stokes reference beam 120S-ref each includes a portion of the transient optical signal. The transient optical signal may include a pulse of light, a step-change in the power of light produced by the Stokes light source 110S, or any other suitable time-dependent change in the optical power of light produced by the Stokes light source. For example, the Stokes light source 110S may include a laser diode, and an electronic driver 112 may supply a pulse or a step-change in the laser drive current supplied to the laser diode so that the laser diode produces a corresponding pulse of light or a step-change in the power of light produced by the laser diode.

In FIGS. 49-50, the residual Stokes beam 120S′ includes a pulse of light 310s, and the Stokes reference beam 120S-ref includes a corresponding pulse of light 310r. The two pulses 310s and 310r in each of FIGS. 49 and 50 may originate from the same pulse of light produced by the Stokes light source 110S, and a portion of this pulse of light appears in both the Stokes beam 120S (as well as the residual Stokes beam 120S′) and the Stokes reference beam 120S-ref. Due to differences in the optical path lengths traveled by the Stokes beam and the Stokes reference beam, the two pulses may arrive at the detectors 220-sig and 220-ref at different times. In FIG. 49, the arrival times of the two pulses are offset by a time delay of ΔT, and after the temporal calibration procedure is performed, the time delay between the pulses may be reduced to approximately zero (as illustrated in FIG. 50). The plots in FIG. 49 correspond to measurements performed with a first pulse of light produced by the Stokes light source 110S before the temporal calibration has been performed, and the plots in FIG. 50 correspond to measurements performed with a second pulse of light produced by the Stokes light source after the temporal calibration has been performed.

The plots of i_{sig} in each of FIGS. 49 and 50 illustrate signal calibration photocurrents produced by the signal detector 220-sig in response to the residual Stokes beam 120S′. The pulse of light 310s from the residual Stokes beam 120S′ results in a corresponding pulse of current 310s-i in the signal photocurrent i_{sig}. Similarly, the plots of i_{ref} in each of FIGS. 49 and 50 illustrate reference calibration photocurrents produced by the reference detector 220-ref in response to the Stokes reference beam 120S-ref. The pulse of light 310r from the Stokes reference beam 120S-ref results in a corresponding pulse of current 310r-i in the reference photocurrent i_{ref}.

The plots of V_{sig} in each of FIGS. 49 and 50 illustrate a signal-voltage output corresponding to the signal calibration photocurrent i_{sig}, and each plot of V_{sig} includes a voltage pulse 310s-v corresponding to the current pulse 310s-i. Similarly, the plots of V_{ref} in each of FIGS. 49 and 50 illustrate a reference-voltage output corresponding to the reference calibration photocurrent i_{ref}, and each plot of V_{ref} includes a voltage pulse 310r-v corresponding to the current pulse 310r-i. The signal-voltage output V_{sig} and the reference-voltage output V_{ref} may each be produced by an electronic amplifier 232 (e.g., as illustrated in FIGS. 43-45). The output signals V_{sig} and V_{ref} in each of FIGS. 49 and 50 are sent to a subtraction module 231, which produces a voltage signal 234 (which may be referred to as a subtraction calibration signal) that is equal to V_{sig}−V_{ref}.

As discussed with respect to FIGS. 43-44, a digitizer 236 may digitize the voltage signal 234 to produce a digital output signal 240 that is sent to a processor. This digital output signal 240 may include a digitized representation of the subtraction calibration signal V_{sig}−V_{ref} in FIGS. 49-50. Alternatively, as discussed with respect to FIG. 45, two digitizers 236 may be used to digitize the two output signals V_{sig} and V_{ref}, and the digital output signal 240 that is sent to a processor may include digital representations of the signal-voltage output V_{sig} and the reference-voltage output V_{ref}. In this case, the processor may subtract the two digital signals to determine a subtraction calibration signal, or the processor may instead analyze the two digital signals separately without subtracting them. In either case, the processor receives a digital signal 240 (which may include a digitized representation of a subtraction signal V_{sig}−V_{ref} or digitized representations of two output signals V_{sig} and V_{ref}), and based on the digital signal, the processor determines a temporal offset between the Stokes beam of light 120S and the Stokes reference beam of light 120S-ref to minimize a time delay between the Stokes beam of light 120S and the Stokes reference beam of light 120S-ref.

The time delay between the Stokes beam of light 120S and the Stokes reference beam of light 120S-ref may represent or may originate from a time difference between (i) the time T_{S} for the Stokes beam 120S to travel from the Stokes light source 110S to the signal detector 220-sig and (ii) the time T_{S-ref} for the Stokes reference beam 120S-ref to travel from the Stokes light source 110S to the reference detector 220-ref. The time delay ΔT may be expressed as ΔT=T_{S}−T_{S-ref} or as ΔT=(D_{S}−D_{S-ref})/c, where D_{S} is the optical distance that the Stokes beam 120S travels from the Stokes light source 110S to the signal detector 220-sig, D_{S-ref} is the optical distance that the Stokes reference beam 120S-ref travels from the Stokes light source 110S to the reference detector 220-ref, and c is the speed of light (approximately 3.0×10⁸ m/s). For example, if Ds is 630 mm and D_{S-ref} is 600 mm, then T_{S} is 2.1 ns, T_{S-ref} is 2.0 ns, and the time delay ΔT is 0.1 ns, which indicates that the Stokes beam 120S takes 0.1 ns longer than the Stokes reference beam 120S-ref to travel from the Stokes light source 110S to the respective detector (e.g., ΔT in FIG. 49 may be 0.1 ns). A temporal calibration may be performed to determine that the time delay ΔT is 0.1 ns, and a temporal offset of +0.1 ns or −0.1 ns may be applied to the Stokes beam 120S or the Stokes reference beam 120S-ref so that resulting the time delay ΔTis approximately 0.0 ns. For example, a +0.1-ns temporal offset may be applied to the Stokes reference beam 120S-ref to delay the Stokes reference beam by an additional 0.1 ns so that each of the times T_{S} and T_{S-ref} has a value of approximately 2.1 ns (which then results in a time delay of approximately 0.0 ns).

The time delay between the Stokes beam 120S and the Stokes reference beam 120S-ref may be minimized so that common-mode intensity noise present in both beams is substantially minimized by subtraction. For example, a signal-voltage output V_{sig} associated with the Stokes beam 120S may have substantially the same intensity noise as a reference-voltage output V_{ref} associated with the Stokes reference beam 120S-ref. Since the intensity noise may vary substantially randomly with time, the two signals may need to be overlapped temporally before subtracting them. By temporally calibrating the beams, the intensity noise in the two output signals V_{sig} and V_{ref} may be substantially overlapped temporally, and subtracting the two signals may produce a subtraction signal 234 that is substantially free from the intensity noise. For example, in FIG. 48, the Stokes and Stokes reference beams may be temporally calibrated so that the noise spikes 300s-v and 300r-v are temporally overlapped. When the output signals V_{sig} and V_{ref} are subtracted to produce the subtraction signal 234, the noise spikes 300s-v and 300r-v may be substantially removed.

In FIG. 49, before the temporal calibration has been performed, the Stokes pulse of light 310s is delayed by the time delay ΔT with respect to the Stokes reference pulse of light 310r. The resulting subtraction calibration signal 234 in FIG. 49 includes a negative pulse followed by a positive pulse, and these transient features in the subtraction calibration signal result from the nonzero time delay ΔT between the pulses 310r and 310s. Based on a digitized representation of the subtraction calibration signal 234 (or based on digitized representations of the two output signals V_{sig} and V_{ref}), a processor may determine a temporal offset to apply to the Stokes beam of light 110S or to the Stokes reference beam of light 120S-ref. For example, the processor may measure times associated with rising or falling edges in the digitized signals to determine the time delay between the two signals V_{sig} and V_{ref}. In FIG. 49, the time delay ΔT may be determined based on the temporal width of one of the pulses in the subtraction calibration signal 234 (e.g., based on a time difference between the first falling edge and the second rising edge).

The plots in FIG. 50 correspond to measurements performed with another pulse of light produced by the Stokes light source after the temporal calibration has been performed. In FIG. 50, a temporal offset of ΔT has been applied to the Stokes reference pulse of light 310r to delay the pulse by approximately ΔT so that the two pulses 310r and 310s reach their respective detectors at approximately the same time. The dashed-line pulses in FIG. 50 represent the reference pulses from FIG. 49 before the temporal calibration. In FIG. 50, after the temporal calibration has been performed, the time delay between the Stokes reference pulse of light 310r and the Stokes pulse of light 310s is approximately zero, and the subtraction calibration signal 234 does not include any significant pulses or other transients.

A temporal offset may be applied to a Stokes beam 120S or a Stokes reference beam 120S-ref to minimize the time delay between the Stokes beam 120S and the Stokes reference beam 120S-ref. For example, a temporal offset may be configured to produce a time delay that is less than 10% of 1/Δf, where Δf is the electronic bandwidth of the signal detector 220-sig or the reference detector 220-ref. If the electronic bandwidth of the signal and reference detectors is 5 GHz, then the temporal offset may be configured to produce a time delay that is less than 0.02 ns (which corresponds to a path-length difference between D_{S} and D_{S-ref} of less than 6 mm). As another example, a temporal offset may be configured to produce a time delay that is less than 4Δt, where Δt is the time interval between successive samples of a digitizer 236 that produces a digital representation of a subtraction signal 234 or produces a digital representation of output signal V_{sig} or V_{ref}. For example, a digitizer 236 with a sample frequency of 4 GHz corresponds to a time interval between samples Δt of 0.25 ns, and the temporal offset may produce a time delay between the Stokes and Stokes reference beams that is less than 1.0 ns.

The time delay between a Stokes beam 120S and a Stokes reference beam 120S-ref may be changed using an optical-path-length (OPL) adjuster. An OPL adjuster 138 (which may be referred to as a variable optical delay line) may include an opto-mechanical stage that is moved back and forth to increase or decrease the optical path length traveled by a beam of light, which results in a corresponding temporal offset applied to the beam of light. For example, increasing the optical path length of a beam of light by 10 mm results in a temporal offset of approximately 0.033 ns added to the travel time of the beam of light. A processor may send an instruction to an OPL adjuster 138 to increase or decrease the optical path length of the Stokes beam 120S or the Stokes reference beam 120S-ref in accordance with a determined time delay ΔT between the Stokes and Stokes reference beams. For example, if the time delay ΔTin FIG. 49 is determined to be 0.1 ns, a processor may send an instruction to the OPL adjuster 138S in FIG. 46 to increase the optical path length of the Stokes reference beam 120S-ref by approximately 30 mm to add a 0.1-ns temporal offset to the Stokes reference beam. The OPL adjuster 138pr in FIG. 46 may be used in a similar manner for temporal calibration of the probe and probe reference beams.

The time delay between a Stokes beam 120S and a Stokes reference beam 120S-ref may be changed digitally. For example, a processor may receive a digital signal corresponding to a signal photocurrent i_{sig} and a digital signal corresponding to a reference photocurrent i_{ref} (e.g., as illustrated in FIG. 45), and the processor may apply a temporal offset to one of the digital signals with respect to the other digital signal. The temporal offset may be applied by shifting one of the digital signals in time with respect to the other digital signal prior to subtracting the signals to determine a subtraction signal. In this case, instead of applying an optical-path-length adjustment to the Stokes beam or Stokes reference beam, the temporal offset is applied digitally by a processor. For example, a temporal offset may be determined based on the temporal calibration illustrated in FIG. 49, and the temporal offset may be applied to subsequently acquired output signals V_{sig} and V_{ref}. The temporal offset may be applied by digitally shifting V_{sig} or V_{ref} by a ΔT delay prior to subtracting the signals. In FIG. 50, instead of increasing the optical path length traveled by the Stokes reference beam 120S-ref so that the two pulses 310s and 310r arrive at their respective detectors at approximately the same time, the V_{ref} signal may be digitally shifted to add a delay of ΔT to the V_{ref} signal prior to determining the subtraction signal 234. Alternatively, the V_{sig} signal in FIG. 50 may be digitally shifted to the left by ΔT to decrease the delay associated with the V_{sig} signal.

A temporal calibration similar to that illustrated in FIGS. 49-50 may be performed to adjust a time delay between a probe beam 120pr and a probe reference beam 120pr-ref. Such a probe-beam temporal calibration may be performed (i) with the pump light source 110pu turned off or operating and (ii) with the Stokes light source 120S turned off or operating. A processor may instruct the probe light source 110pr to produce a transient optical signal so that the probe beam 120pr and the probe reference beam 120pr-ref each includes a portion of the transient optical signal. The transient optical signal from the probe beam 120pr may produce a corresponding current transient in the signal calibration photocurrent i_{sig}, and the V_{sig} signal may include a corresponding voltage transient. Similarly, the transient optical signal from the probe reference beam 120pr-ref may produce a corresponding current transient in the reference calibration photocurrent i_{ref}, and the V_{ref} signal may include a corresponding voltage transient. Based on signals corresponding to the calibration photocurrents (e.g., based on a subtraction signal or based on the voltage signals V_{sig} and V_{ref}), a processor may determine a temporal offset ΔT between the probe beam 120pr and the probe reference beam 120pr-ref. The temporal offset may be applied to the probe beam or the probe reference beam (e.g., using the OPL adjuster 138pr in FIG. 46), or the temporal offset may be applied digitally to digital signals corresponding to subsequently received voltage signals V_{sig} and V_{ref}. The temporal offset may minimize the effect of a difference between (i) the time for the probe beam 120pr to travel from the probe light source 110pr to the signal detector 220-sig and (ii) the time for the probe reference beam 120pr-ref to travel from the probe light source 110pr to the reference detector 220-ref.

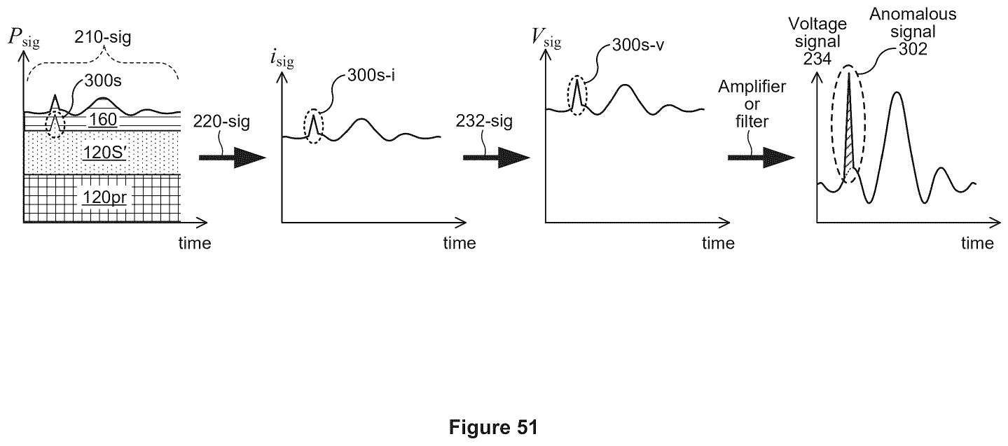

FIG. 51 illustrates example signals produced by an optical receiver without balanced detection. The signals in FIG. 51 may be produced by an optical receiver with a single detector 220 (e.g., similar to the optical receiver 200 in FIG. 2). While there is no reference beam in FIG. 51, the signal beam 210-sig in FIG. 51 may be similar to the signal beam 210-sig in FIG. 40. The plot of P_{sig} in FIG. 51 illustrates the optical power of the signal beam 210-sig and indicates that the signal beam 210-sig includes light from a Raman signal 160, probe beam 120pr, and residual Stokes beam 120S′. The signal detector 220-sig receives the signal beam 210-sig and produces a signal photocurrent i_{sig} corresponding to the Raman signal, probe beam, and residual Stokes beam. A portion of the Raman signal 160 may be coherently mixed at the detector 220-sig with at least a portion of the probe beam 120pr, and a portion of the signal photocurrent i_{sig} may correspond to the coherent mixing between the Raman signal and probe beam. Additionally, the signal photocurrent may include one or more portions that correspond to the Raman signal 160, the probe beam 120pr, or the residual Stokes beam 120S′. An electronic amplifier 232-sig amplifies the signal photocurrent i_{sig} to produce the signal-voltage output V_{sig}. The signal-voltage output V_{sig} may be sent through a voltage amplifier or an electronic filter (e.g., to filter out high-frequency or low-frequency components) to produce the voltage signal 234, which may be digitized and sent to a processor.

The P_{sig} plot in FIG. 51 includes a signal noise spike 300s, which may originate from intensity noise produced by the Stokes light source 110S. The signal noise spike 300s results in a corresponding current noise spike 300s-i in the signal photocurrent i_{sig}, which in turn results in a voltage noise spike 300s-v in the signal-voltage output V_{sig}. The voltage noise spike 300s-v produces a corresponding noise spike in the voltage signal 234, which may be referred to as an anomalous signal 302. While the anomalous signal 302 may arise from intensity noise in one of the light sources 110, a processor may not be able to distinguish the anomalous signal 302 from an actual peak in the voltage signal 234. As a result, an anomalous signal 302 produced by a detector in an optical receiver without balanced detection may result in a false peak being identified as a valid signal. A Raman spectroscopy system 100 with balanced detection may substantially attenuate or remove this type of anomalous signal, and as a result, the occurrence of identifying anomalous signals as valid signals may be significantly reduced in a Raman spectroscopy system with balanced detection.

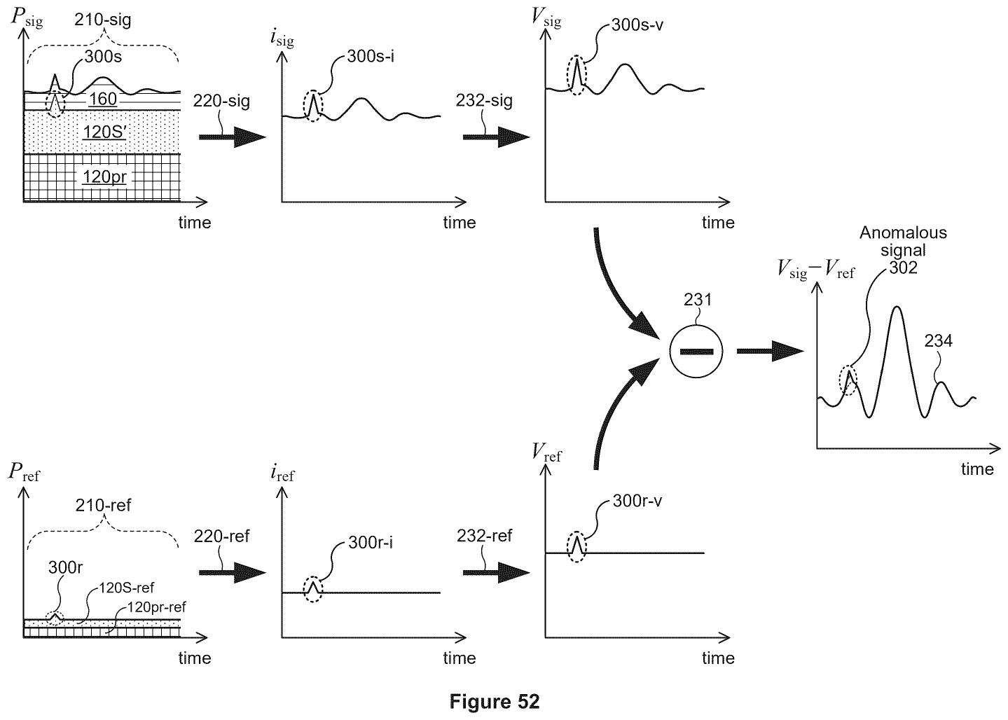

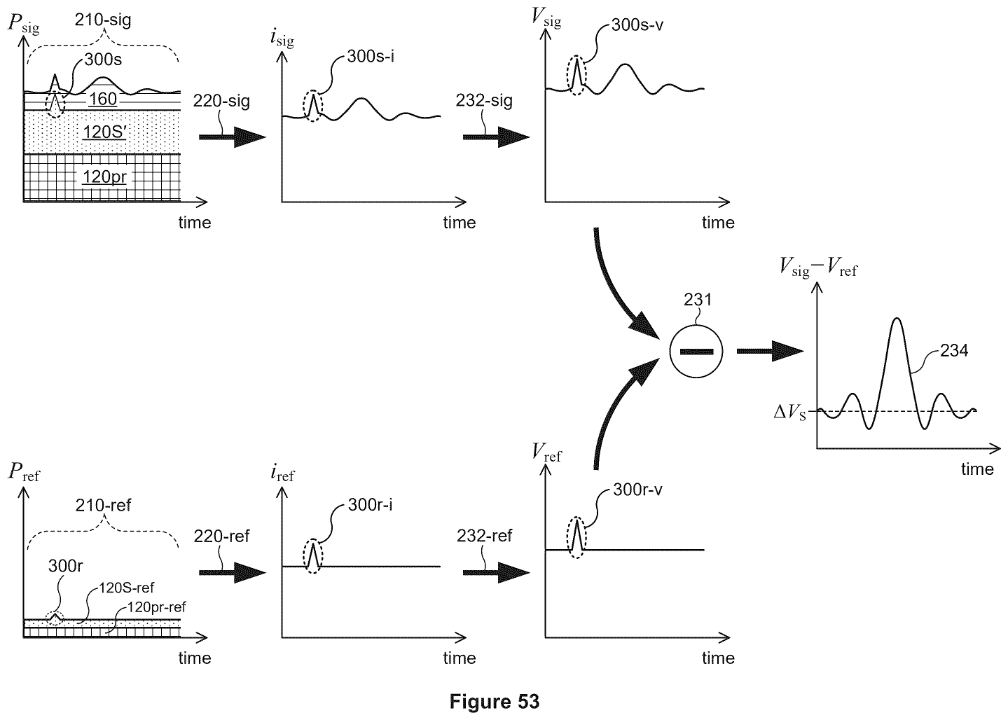

FIGS. 52-53 illustrate example signals produced by an optical receiver with balanced detection before (FIG. 52) and after (FIG. 53) a calibration has been performed. The signals in FIGS. 52-53 may be produced by a balanced optical receiver 200 similar to the optical receiver in FIG. 40, 43, 44, or 45. The signal plots of P_{sig}, i_{sig}, and V_{sig} in FIGS. 52-53 are similar to the corresponding plots in FIG. 51. The P_{ref} plots in FIGS. 52-53 indicate that the reference beam 210-ref includes light from a probe reference beam 120pr-ref and a Stokes reference beam 120S-ref. The reference detector 220-ref receives the reference beam 210-ref and produces a reference photocurrent i_{ref} corresponding to the probe and Stokes reference beams, and an electronic amplifier 232-ref amplifies the reference photocurrent i_{ref} to produce the reference-voltage output V_{ref}. A subtraction module 231 produces a subtraction signal 234 that equals the difference between the signal-voltage output V_{sig} and the reference-voltage output V_{ref}.

In FIGS. 52-53, the P_{sig} plot includes a signal noise spike 300s, and the P_{ref} plot includes a corresponding reference noise spike 300r. The two noise spikes 300s and 300r may originate from the same noise spike in the light produced by the Stokes light source 110S. The noise spikes 300s and 300r result in corresponding current noise spikes 300s-i and 300r-i, which in turn result in corresponding voltage noise spikes 300s-v and 300r-v. In FIGS. 52-53, the reference-voltage output V_{ref} is subtracted from the signal-voltage output V_{sig} to produce the subtraction signal 234. The subtraction signal 234 in FIG. 52 includes an anomalous signal 302 which may be caused by the signal and reference detectors not being balanced. However, because of the subtraction operation, the amplitude of the anomalous signal 302 in FIG. 52 is significantly reduced compared to the amplitude of the anomalous signal 302 in FIG. 51. The signal and reference detectors in FIG. 53 are balanced, and as a result, the voltage noise spikes 300s-v and 300r-v are substantially removed by the subtraction operation, and the subtraction signal 234 in FIG. 53 includes little or no anomalous signal.

The subtraction signal 234 (or the voltage signals V_{sig} and V_{ref}) in FIG. 53 may be digitized and sent to a processor, and the processor may determine a characteristic 162 of the subtraction signal. For example, the characteristic 162 of the subtraction signal 234 in FIG. 53 may include a peak amplitude or an average amplitude of the subtraction signal or an amplitude of the subtraction signal at a particular frequency or time. As another example, the characteristic 162 of the subtraction signal 234 in FIG. 53 may include a DC offset of the subtraction signal. The DC offset ΔV_{S} of the subtraction signal in FIG. 53 may result from energy transfer from the pump beam 120pu to the Stokes beam 120S. After the signal and reference detectors are balanced, there may be little or no DC offset in the subtraction signal 234 (e.g., as illustrated in FIGS. 48 and 50). When the pump beam 120pu is turned on and the Raman signal 160 is produced, there may be energy transferred from the pump beam to the Stokes beam. This energy transfer may result in an increase in the optical power of the residual Stokes beam 120S′, which in turn may result in a DC offset ΔV_{S} in the subtraction signal 234.

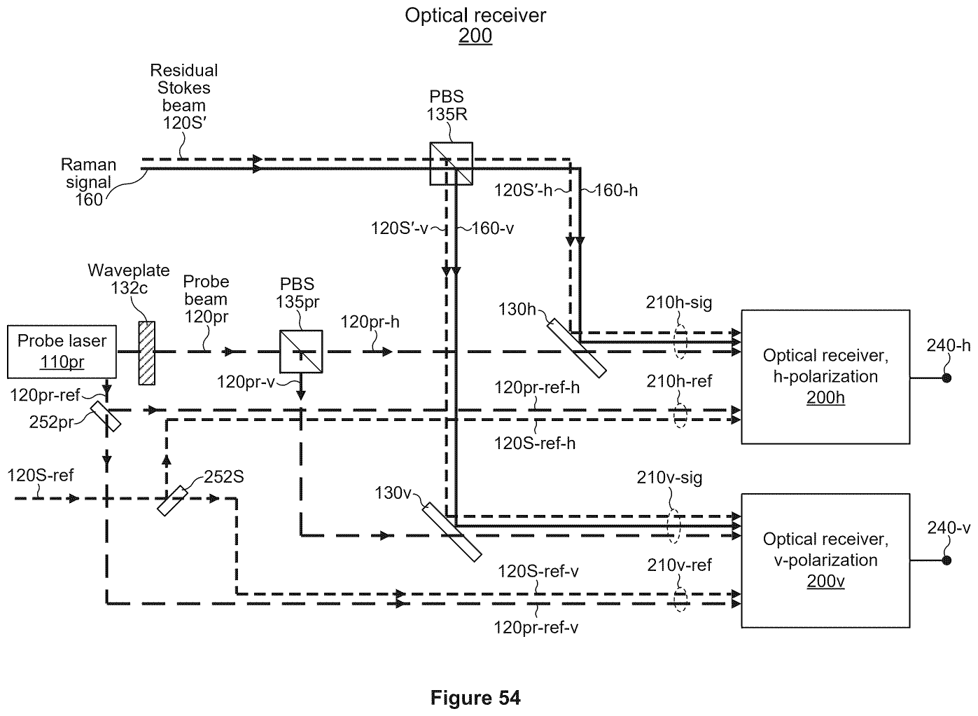

FIG. 54 illustrates an example optical receiver 200 of a Raman spectroscopy system 100 with balanced detection and configured for polarization-sensitive detection of a Raman signal. The polarization-sensitive optical receiver 200 in FIG. 54 is similar to that illustrated in FIG. 37, except the horizontal-polarization optical receiver 200h and the vertical-polarization optical receiver 200v in FIG. 54 are balanced optical receivers. The h-polarization and v-polarization optical receiver may each be similar to the balanced optical receiver 200 illustrated in FIG. 40, 43, 44, or 45, and the h-polarization and v-polarization optical receiver may each include a signal detector and a reference detector configured for balanced detection. The h-polarization balanced optical receiver 200h produces a digital output signal 240-h that may correspond to a horizontal-polarization subtraction signal, and the v-polarization balanced optical receiver 200v produces a digital output signal 240-v that may correspond to a vertical-polarization subtraction signal. The digital output signals 240-h and 240-v may be sent to a processor, and in addition to determining one or more characteristics of the h-polarization and v-polarization subtraction signals, the processor may determine a polarization of the Raman signal 160 based on the h-polarization and v-polarization subtraction signals.

In FIG. 54, the PBS 135R splits the Raman signal 160 and the residual Stokes beam 120S′ into (i) a horizontally polarized Raman signal 160-h and residual Stokes beam 120S′-h and (ii) a vertically polarized Raman signal 160-v and residual Stokes beam 120S′-v. The waveplate 132c may be a quarter-wave plate or a half-wave plate that converts the probe beam into a circularly polarized beam or a beam polarized at 45 degrees. The PBS 135pr splits the probe beam 120pr into a horizontally polarized probe beam 120pr-h and a vertically polarized probe beam 120pr-v. The optical combiner 130h combines the horizontally polarized beams to produce a horizontally polarized signal beam 210h-sig, and the optical combiner 130v combines the vertically polarized beams to produce a vertically polarized signal beam 210v-sig.

One optical splitter 252pr splits the probe reference beam 120pr-ref to produce the probe reference beams 120pr-ref-h and 120pr-ref-v. Another optical splitter 252S splits the Stokes reference beam 120S-ref to produce the Stokes reference beams 120S-ref-h and 120S-ref-v. The optical splitters 252pr and 252S may be polarization beamsplitters or may be non-polarization splitters (e.g., 50/50 beamsplitters), and the probe and Stokes reference beams produced by the splitters may or may not have particular polarizations.

The horizontal-polarization balanced optical receiver 200h receives the horizontally polarized signal beam 210h-sig and the reference beam 210h-ref. The h-polarization signal beam 210h-sig is directed to a signal detector and includes the horizontally polarized components: Raman signal 160-h, residual Stokes beam 120S′-h, and probe beam 120pr-h. The reference beam 210h-ref is directed to a reference detector and includes the Stokes reference beam 120S-ref-h and probe reference beam 120pr-ref-h.

The vertical-polarization balanced optical receiver 200v receives the vertically polarized signal beam 210v-sig and the reference beam 210v-ref. The v-polarization signal beam 210v-sig is directed to a signal detector and includes the vertically polarized components: Raman signal 160-v, residual Stokes beam 120S′-v, and probe beam 120pr-v. The reference beam 210v-ref is directed to a reference detector and includes the Stokes reference beam 120S-ref-v and probe reference beam 120pr-ref-v.

An optical receiver 200 of a Raman spectroscopy system 100 with balanced detection may include one or more 90-degree optical hybrids 250 (e.g., similar to that illustrated in FIG. 38). Optical signals, including a Raman signal 160, may be directed to the optical hybrid 250, and the detectors 220 coupled to the optical hybrid 250 may produce photocurrent signals corresponding to the received optical signals. The optical receiver 200 may produce a digital output signal 240 corresponding to the photocurrent signals, and based on the digital output signal 240, a processor may determine an in-phase portion and a quadrature portion associated with the Raman signal 160.

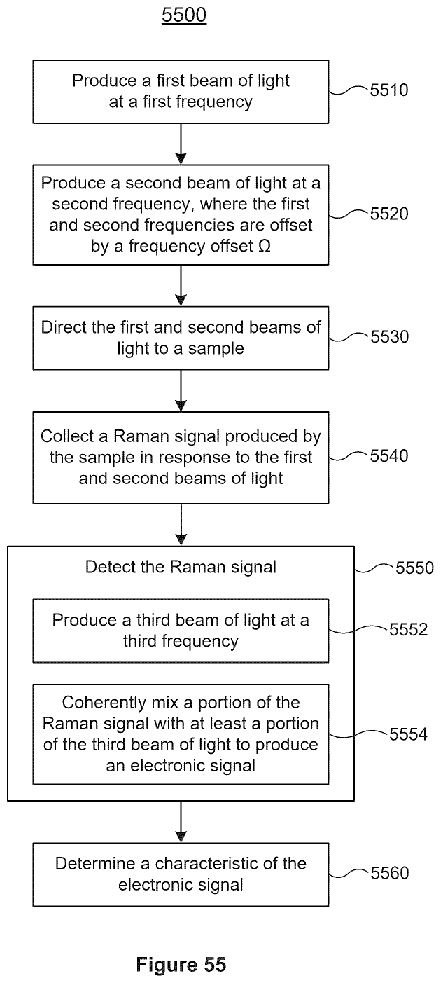

FIG. 55 illustrates an example method 5500 for measuring a Raman signal 160. The method may be performed by a Raman spectroscopy system as described herein. For example, the method may be performed by the Raman spectroscopy system 100 illustrated in FIG. 1 or 2 and may be used to measure a Raman signal 160. The method may begin at step 5510 by producing a first beam of light at a first frequency (v₁). At step 5520, a second beam of light at a second frequency (v₂) is produced. The first beam of light may be referred to as a pump beam of light 120pu, and the second beam of light may be referred to as a Stokes beam of light 120S. The first and second frequencies may be offset by a frequency offset Ω, where Ω=v₁−v₂. For example, the first and second frequencies may each correspond to a wavelength between approximately 300 nm and approximately 5,000 nm, and the frequency offset Ω may be between approximately 5 THz and approximately 100 THz. The first and second beams of light may each be produced by a light source that includes one or more laser diodes, where each laser diode is a fixed-wavelength laser diode or a wavelength-tunable laser diode.

At step 5530, the first and second beams of light are directed to a sample 150, and at step 5540, a Raman signal 160 is collected, where the Raman signal is produced by the sample in response to the first and second beams of light. For example, the Raman signal may be produced by coherent Raman scattering of the first and second beams of light within the sample. The first and second beams of light may be directed to the sample by one or more optical elements that include a free-space optical element, an optical fiber, or an optical waveguide. Similarly, one or more optical elements (which may include a free-space optic, an optical fiber, or an optical waveguide) may collect the Raman signal and direct the Raman signal to an optical receiver.

At step 5550, the Raman signal is detected. Detection of the Raman signal 160, which may be performed by an optical receiver 200, includes steps 5552 and 5554. At step 5552, a third beam of light at a third frequency v₃ is produced. The third beam of light (which may be referred to as a probe beam of light 120pr) may be produced by a wavelength-tunable laser, where the third frequency is adjustable by changing a wavelength of light produced by the wavelength-tunable laser. At step 5554, a portion of the Raman signal is coherently mixed with at least a portion of the third beam of light to produce an electronic signal (e.g., a photocurrent signal J). The Raman signal and the third beam of light may be coherently mixed at a detector of an optical receiver. The portion of the Raman signal that is coherently mixed with the third beam of light may include optical frequency components of the Raman signal that are within a particular frequency range of the third frequency, and the particular frequency range may depend on the electronic bandwidth of the detector. For example, the particular frequency range may extend from approximately v₃−Δf to approximately v₃+Δf, where v₃ is the third frequency, and Δf is the electronic bandwidth of the detector.

At step 5560, a characteristic of the electronic signal is determined, at which point the method may end. For example, a processor may receive a digital signal corresponding to the electronic signal, and the processor may determine the characteristic of the electronic signal based on the digital signal. The characteristic of the electronic signal may be associated with the Raman signal 160 and may include a peak amplitude, an average amplitude, an amplitude at a particular frequency, an amplitude at a particular time, an amplitude at a frequency center, an amplitude at a temporal center, an area, a frequency, a phase, or a polarization. Additionally, the characteristic of the electronic signal may be associated with a Raman shift at a frequency v₁−v₃, where v₁ is the first frequency, and v₃ is the third frequency. Based on one or more determined signal characteristics 162, a processor may determine (i) whether a particular material is present in a sample or (ii) an amount or a concentration of the particular material in the sample.

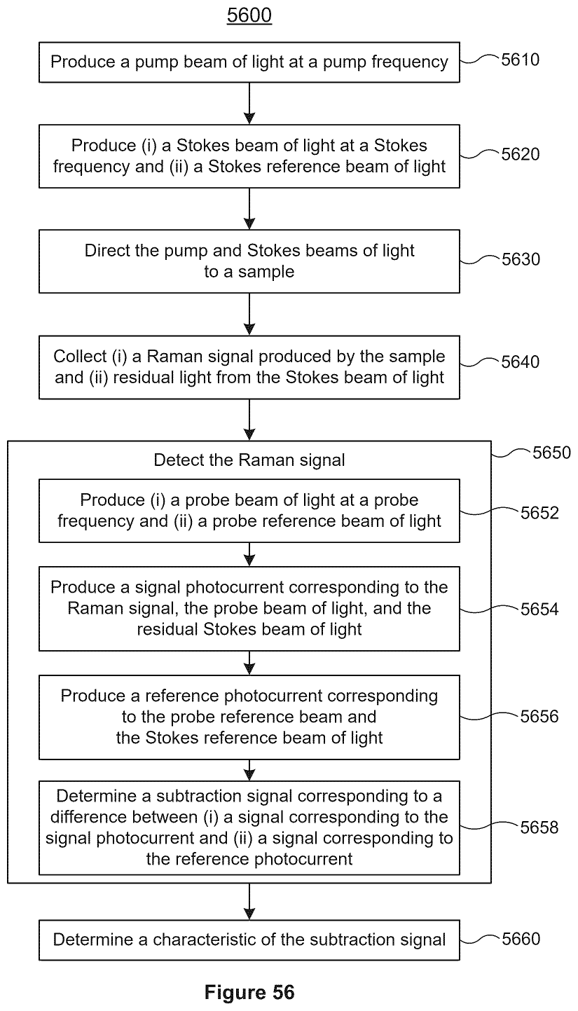

FIG. 56 illustrates an example method 5600 for measuring a Raman signal 160 using balanced detection. The method may be performed by a Raman spectroscopy system 100 with balanced detection as described herein. At step 5610, a pump light source 110pu produces a pump beam of light 120pu at a pump frequency (vₚᵤ). At step 5620, a Stokes light source 110S produces (i) a Stokes beam of light 120S at a Stokes frequency (v_{S}) and (ii) a Stokes reference beam of light 120S-ref. The Stokes beam of light and the Stokes reference beam of light may have the same optical frequency v_{S}, and the pump and Stokes frequencies may be offset by a frequency offset Ω, where Ω=vₚᵤ−v_{S}. For example, the pump and Stokes frequencies may each correspond to a wavelength between approximately 300 nm and approximately 5,000 nm, and the frequency offset Ω may be between approximately 5 THz and approximately 100 THz. The pump beam of light may be referred to as a first beam of light at a first frequency (v₁), and the Stokes beam of light may be referred to as a second beam of light at a second frequency (v₂).

At step 5630, the pump and Stokes beams of light are directed to a sample 150, and at step 5640, a Raman signal 160 and a residual Stokes beam of light 120S′ are collected from the sample. The Raman signal is produced by the sample in response to the pump and Stokes beams of light. For example, the Raman signal may be produced by coherent Raman scattering of the pump and Stokes beams of light within the sample. The residual Stokes beam of light 120S′ includes light from the Stokes beam of light 120S after the Stokes beam of light has interacted with the sample.

At step 5650, an optical receiver 200 detects the Raman signal 160 using balanced detection. Balanced detection of the Raman signal includes steps 5652, 5654, 5656, and 5658. At step 5652, a probe light source 110pr produces (i) a probe beam of light 120pr at a probe frequency vₚᵣ and (ii) a probe reference beam of light 120pr-ref. The probe light source 110pr may include a wavelength-tunable laser, where the probe frequency vₚᵣ is adjustable by changing the wavelength of light produced by the wavelength-tunable laser. The probe beam of light and the probe reference beam of light may have the same optical frequency vₚᵣ. The probe beam of light may be referred to as a third beam of light at a third frequency (v₃). At step 5654, a signal detector 220-sig produces a signal photocurrent i_{sig} that corresponds to the Raman signal, the probe beam of light, and the residual Stokes beam of light. The Raman signal and the probe beam of light may be coherently mixed at the signal detector, and a portion of the signal photocurrent may correspond to the coherent mixing between the Raman signal and the probe beam of light. At step 5656, a reference detector 220-ref produces a reference photocurrent i_{ref} that corresponds to the probe reference beam of light and the Stokes reference beam of light. At step 5658, a subtraction module determines a subtraction signal, where the subtraction signal corresponds to a difference between (i) a signal corresponding to the signal photocurrent and (ii) a signal corresponding to the reference photocurrent.

At step 5660, a processor determines a characteristic of the subtraction signal, at which point the method may end. For example, the processor may receive a digital signal corresponding to the subtraction signal, and the processor may determine the characteristic of the subtraction signal based on the digital signal. Alternatively, the processor may receive a first digital signal corresponding to the signal photocurrent and a second digital signal corresponding to the reference photocurrent. The processor may then determine a digital subtraction signal from the two digital signals, and the characteristic of the subtraction signal may be determined from the digital subtraction signal. The characteristic of the subtraction signal may be associated with the Raman signal 160 and may include a peak amplitude, an average amplitude, an amplitude at a particular frequency, an amplitude at a particular time, an amplitude at a frequency center, an amplitude at a temporal center, a DC offset ΔVₛ, an area, a frequency, a phase, or a polarization. Additionally, the characteristic of the subtraction signal may be associated with a Raman shift at a frequency vₚᵤ−vₚᵣ. Based on one or more determined signal characteristics 162, a processor may determine (i) whether a particular material is present in a sample or (ii) an amount or a concentration of the particular material in the sample.

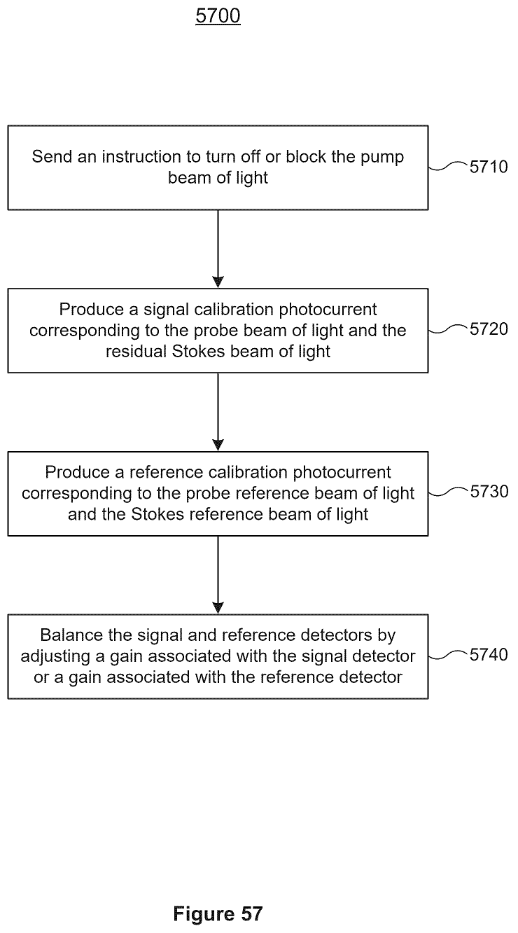

FIG. 57 illustrates an example method 5700 for performing an amplitude calibration. The amplitude calibration may be performed by a Raman spectroscopy system 100 with balanced detection and may be used to balance the signal and reference detectors. At step 5710, a processor sends an instruction to turn off or block the pump beam of light 120pu so that little or no light produced by the pump light source 110pu reaches the sample 150. The other beams of light (Stokes residual beam, Stokes reference beam, probe beam, and probe reference beam) may remain unblocked and may be directed to the detectors. At step 5720, the signal detector 220-sig produces a signal calibration photocurrent that corresponds to the probe beam of light 120pr and the residual Stokes beam of light 120S′. At step 5730, the reference detector 220-ref produces a reference calibration photocurrent that corresponds to the probe reference beam of light 120pr-ref and the Stokes reference beam of light 120S-ref. At step 5740, the processor balances the signal and reference detectors by adjusting a gain associated with the signal detector or a gain associated with the reference detector based on the signal and reference calibration photocurrents, at which point the method may end. The gain may be adjusted so that electronic signals corresponding to the signal and reference calibration photocurrents are approximately equal. The gain associated with the signal or reference detector may be adjusted by: adjusting the reverse-bias voltage applied to a signal or reference APD; adjusting the gain of an electronic amplifier; setting the value of a calibration factor applied to a digitized signal corresponding to the signal or reference photocurrent; or using a VOA to change the optical power of one of the beams of light.

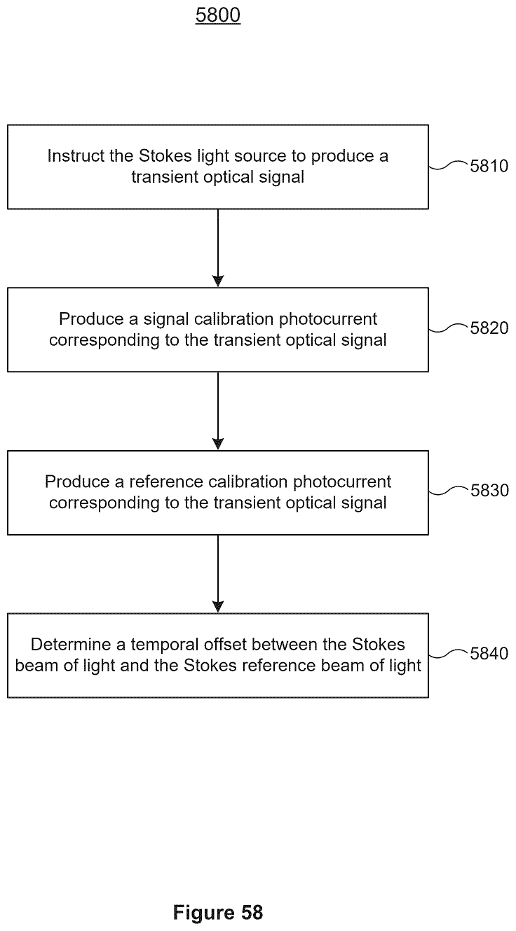

FIG. 58 illustrates an example method 5800 for performing a temporal calibration. The temporal calibration may be performed by a Raman spectroscopy system 100 with balanced detection and may be used to adjust the time delay between the Stokes beam of light 120S and the Stokes reference beam of light 120S-ref. At step 5810, a processor instructs the Stokes light source 110S to produce a transient optical signal so that the Stokes beam of light 120S and the Stokes reference beam of light 120S-ref each includes a portion of the transient optical signal. The transient optical signal may include a pulse of light or a step-change in the power of light produced by the Stokes light source. At step 5820, the signal detector 220-sig produces a signal calibration photocurrent that corresponds to the transient optical signal, and at step 5830, the reference detector produces a reference calibration photocurrent that corresponds to the transient optical signal. At step 5840, the processor determines a temporal offset between the Stokes beam of light and the Stokes reference beam of light to minimize the time delay between the Stokes beam of light and the Stokes reference beam of light, at which point the method may end.

The method 5800 illustrated in FIG. 58 may also be applied to a probe beam of light to adjust the time delay between the probe beam of light 120pr and the probe reference beam of light 120pr-ref. To perform a temporal calibration of the probe beam of light, a processor may instruct the probe light source 110pr to produce a transient optical signal so that the probe beam of light and the probe reference beam of light each includes a portion of the transient optical signal. The signal and reference detectors may each produce calibration photocurrents that correspond to the transient optical signal, and the processor may determine a temporal offset between the probe beam of light and the probe reference beam of light to minimize the time delay between the two beams of light.

Various example aspects directed to a Raman spectroscopy system are described below.

Aspect 1. A system comprising: a first light source configured to produce a first beam of light at a first frequency; a second light source configured to produce a second beam of light at a second frequency, wherein the first and second frequencies are offset by a frequency offset Ω; one or more optical elements configured to: direct the first and second beams of light to a sample; and collect a Raman signal produced by the sample in response to the first and second beams of light; an optical receiver configured to detect the Raman signal, the optical receiver comprising: a third light source configured to produce a third beam of light at a third frequency, wherein the third light source comprises a wavelength-tunable laser, wherein the third frequency is adjustable by changing a wavelength of light produced by the wavelength-tunable laser; and an optical detector configured to coherently mix a portion of the Raman signal with at least a portion of the third beam of light to produce an electronic signal; and a processor configured to determine a characteristic of the electronic signal.

Aspect 2. The system of aspect 1, wherein: the third frequency is v₃; the third light source is further configured to change the frequency of the third beam of light by a frequency change ΔF to a frequency v₃+ΔF; the detector is further configured to coherently mix another portion of the Raman signal with at least a portion of the third beam of light at the frequency v₃+ΔF to produce another electronic signal; and the processor is further configured to determine a characteristic of the another electronic signal.

Aspect 3. The system of aspect 2, wherein: the characteristic of the electronic signal is associated with a Raman shift at a frequency v₁−v₃, wherein v₁ is the first frequency; and the characteristic of the another electronic signal is associated with another Raman shift at a frequency v₁−(v₃+ΔF).

Aspect 4. The system of aspect 2, wherein the frequency change ΔF is between approximately 10 megahertz (MHz) and approximately 10 gigahertz (GHz).

Aspect 5. The system of aspect 1, wherein: the frequency offset Ω is approximately equal to a vibrational frequency of a particular material; and the processor is further configured to determine an amount or a concentration of the particular material in the sample based on the characteristic of the electronic signal.

Aspect 6. The system of aspect 1, wherein the frequency offset Ω is between approximately 5 terahertz (THz) and approximately 100 THz.

Aspect 7. The system of aspect 1, wherein the first light source or the second light source comprises a wavelength-tunable laser, wherein the frequency offset Ω is adjustable by changing a wavelength of the wavelength-tunable laser.

Aspect 8. The system of aspect 1, wherein the first light source or the second light source comprises two or more fixed-wavelength lasers, each of the fixed-wavelength lasers having a different operating wavelength, wherein the frequency offset Ω is adjustable by selecting one of the fixed-wavelength lasers for operation.

Aspect 9. The system of aspect 1, wherein: the frequency offset Ω is a first frequency offset Ω₁, and the Raman signal is a first Raman signal; subsequent to the optical receiver detecting the first Raman signal: the first light source is further configured to change the first frequency to produce a second frequency offset Ω₂ different from the first frequency offset Ω₁; and the optical receiver is further configured to detect a second Raman signal produced by the sample in response to the first and second beams of light with the second frequency offset Ω₂, wherein the detector is configured to coherently mix a portion of the second Raman signal with at least a portion of the third beam of light to produce a second electronic signal; and the processor is further configured to determine a characteristic of the second electronic signal.

Aspect 10. The system of aspect 1, wherein: the frequency offset Ω is a first frequency offset Ω₁, and the Raman signal is a first Raman signal; subsequent to the optical receiver detecting the first Raman signal: the second light source is further configured to change the second frequency to a new second frequency to produce a second frequency offset Ω₂ different from the first frequency offset Ω₁; the third light source is further configured to change the third frequency to a new third frequency, wherein the new third frequency is within 200 GHz of the new second frequency; and the optical receiver is further configured to detect a second Raman signal produced by the sample in response to the first and second beams of light with the second frequency offset Ω₂, wherein the detector is configured to coherently mix a portion of the second Raman signal with at least a portion of the third beam of light to produce a second electronic signal; and the processor is further configured to determine a characteristic of the second electronic signal.

Aspect 11. The system of aspect 1, wherein the wavelength of light produced by the wavelength-tunable laser is adjustable over a wavelength range having a width between approximately 10 nanometers (nm) and approximately 100 nm.

Aspect 12. The system of aspect 1, wherein the wavelength-tunable laser comprises a wavelength-tunable laser diode having a wavelength-tuning range with a width between approximately 10 nanometers (nm) and approximately 100 nm.

Aspect 13. The system of aspect 1, wherein the wavelength-tunable laser comprises a sampled-grating distributed Bragg reflector (SG-DBR) laser.

Aspect 14. The system of aspect 1, wherein the wavelength of light produced by the wavelength-tunable laser is between approximately 1490 nanometers (nm) and approximately 1570 nm.

Aspect 15. The system of aspect 1, wherein the wavelength of light produced by the wavelength-tunable laser is between approximately 1000 nanometers (nm) and approximately 1100 nm.

Aspect 16. The system of aspect 1, wherein the third light source comprises: two or more laser diodes, wherein each of the laser diodes is a fixed-wavelength laser diode or a wavelength-tunable laser diode; and an optical multiplexer configured to combine light produced by each of the laser diodes into a single output beam of light.

Aspect 17. The system of aspect 16, wherein the third light source is configured to operate only one laser diode at a time, wherein: the third light source comprises N laser diodes, wherein N is an integer greater than or equal to 2; during a first measurement period, a first one of the N laser diodes is configured to produce light, and N−1 of the laser diodes, excluding the first one, are configured to not produce light; and during a second measurement period, a second one of the N laser diodes is configured to produce light, and N−1 of the laser diodes, excluding the second one, are configured to not produce light.

Aspect 18. The system of aspect 1, wherein the third light source comprises N wavelength-tunable laser diodes, wherein Nis an integer greater than or equal to 2, and the third light source is configured to tune over one or more wavelength ranges having a total width between (0.7)N·Δλₐᵥ and N·Δλₐᵥ, wherein Δλₐᵥ is an average wavelength-tuning range of the N laser diodes.

Aspect 19. The system of aspect 1, wherein the second frequency and the third frequency differ by greater than 100 megahertz (MHz) and less than 200 gigahertz (GHz).

Aspect 20. The system of aspect 1, wherein the first or second light source is a wavelength-tunable light source, wherein the respective first or second frequency is adjustable over a frequency range corresponding to a wavelength range having a width between approximately 10 nanometers (nm) and approximately 100 nm.

Aspect 21. The system of aspect 1, wherein the first frequency corresponds to a wavelength between approximately 1220 nanometers (nm) and approximately 1450 nm, and the second frequency corresponds to a wavelength between approximately 1490 nm and approximately 1570 nm.

Aspect 22. The system of aspect 1, wherein each of the first, second, and third beams of light has a spectral linewidth of less than 200 megahertz (MHz).

Aspect 23. The system of aspect 1, wherein one or more of the first, second, and third beams of light have a spectral linewidth of less than 1 megahertz (MHz).

Aspect 24. The system of aspect 1, wherein each of the first light source, the second light source, and the third light source comprises one or more laser diodes, wherein each laser diode is a fixed-wavelength laser diode or a wavelength-tunable laser diode.

Aspect 25. The system of aspect 1, wherein the first light source, the second light source, or the third light source comprises a seed laser configured to produce seed light and an optical amplifier configured to amplify the seed light to produce an output beam of light, wherein the optical amplifier comprises a semiconductor optical amplifier (SOA) or a fiber-optic amplifier.

Aspect 26. The system of aspect 1, wherein the portion of the Raman signal that is coherently mixed with the third beam of light comprises optical frequency components of the Raman signal within a particular frequency range of the third frequency, wherein the particular frequency range is based on an electronic bandwidth of the optical detector.

Aspect 27. The system of aspect 1, wherein the detector has an electronic bandwidth of approximately Δf, and the electronic signal produced by the detector comprises one or more electronic frequency components, each electronic frequency component having a frequency less than or equal to approximately Δf.

Aspect 28. The system of aspect 1, wherein the characteristic of the electronic signal comprises one or more of: a peak amplitude, an average amplitude, an amplitude at a particular frequency, an amplitude at a particular time, an amplitude at a frequency center, an amplitude at a temporal center, an area, a frequency, a phase, and a polarization.

Aspect 29. The system of aspect 1, wherein the frequency offset Ω equals v₁−v₂, wherein v₁ is the first frequency, and v₂ is the second frequency.

Aspect 30. The system of aspect 1, wherein each of the first, second, and third frequencies corresponds to a wavelength between approximately 300 nanometers (nm) and approximately 5,000 nm.

Aspect 31. The system of aspect 1, wherein the first frequency corresponds to a wavelength between approximately 1300 nanometers (nm) and approximately 1400 nm.

Aspect 32. The system of aspect 1, wherein the first frequency corresponds to a wavelength between approximately 890 nanometers (nm) and approximately 920 nm.

Aspect 33. The system of aspect 1, wherein the first frequency corresponds to a wavelength between approximately 700 nanometers (nm) and approximately 850 nm.

Aspect 34. The system of aspect 1, wherein the third frequency corresponds to a wavelength between approximately 1500 nanometers (nm) and approximately 1600 nm.

Aspect 35. The system of aspect 1, wherein the detector has an electronic bandwidth between approximately 100 megahertz (MHz) and approximately 50 gigahertz (GHz).

Aspect 36. The system of aspect 1, wherein the first light source, the second light source, or the third light source comprises a distributed feedback (DFB) laser diode.

Aspect 37. The system of aspect 1, wherein the first light source, the second light source, or the third light source comprises a wavelength-tunable laser diode comprising an external-cavity laser diode, a thermally tuned laser diode, or a sampled-grating distributed Bragg reflector (SG-DBR) laser.

Aspect 38. The system of aspect 1, wherein the first light source, the second light source, or the third light source comprises a light-emitting diode (LED), super-luminescent light source, short-pulse laser, broadband light source, fiber laser, or solid-state laser.

Aspect 39. The system of aspect 1, wherein the Raman signal is produced by coherent Raman scattering of the first and second beams of light within the sample.

Aspect 40. The system of aspect 1, wherein the sample comprises a biological material.

Aspect 41. The system of aspect 1, wherein the sample comprises an inorganic material.

Aspect 42. The system of aspect 1, wherein the sample comprises a crystalline material.

Aspect 43. The system of aspect 1, further comprising a half-wave plate configured to rotate a polarization of the first or second beam of light prior to being directed to the sample.

Aspect 44. The system of aspect 1, further comprising a quarter-wave plate configured to convert a polarization of the first or second beam of light to a circular or elliptical polarization prior to being directed to the sample.

Aspect 45. The system of aspect 1, further comprising a half-wave plate configured to rotate a polarization of the third beam of light.

Aspect 46. The system of aspect 1, further comprising an optical filter located between the sample and the optical receiver, the optical filter configured to transmit one or more wavelengths associated with the Raman signal and block one or more wavelengths associated with the first or second beam of light.

Aspect 47. The system of aspect 1, further comprising an optical polarizer located between the sample and the optical receiver, wherein the optical polarizer is oriented to transmit light with a polarization associated with the Raman signal.

Aspect 48. A method for measuring a Raman signal, the method comprising: producing a first beam of light at a first frequency; producing a second beam of light at a second frequency, wherein the first and second frequencies are offset by a frequency offset Ω; directing the first and second beams of light to a sample; collecting a Raman signal produced by the sample in response to the first and second beams of light; detecting the Raman signal, comprising: producing a third beam of light at a third frequency, wherein the third beam of light is produced by a wavelength-tunable laser, wherein the third frequency is adjustable by changing a wavelength of light produced by the wavelength-tunable laser; and coherently mixing a portion of the Raman signal with at least a portion of the third beam of light to produce an electronic signal; and determining a characteristic of the electronic signal.

Aspect 50. One or more computer-readable non-transitory storage media embodying software that is operable when executed to: produce a first beam of light at a first frequency; produce a second beam of light at a second frequency, wherein the first and second frequencies are offset by a frequency offset Ω; direct the first and second beams of light to a sample; collect a Raman signal produced by the sample in response to the first and second beams of light; detect the Raman signal, comprising: produce a third beam of light at a third frequency, wherein the third beam of light is produced by a wavelength-tunable laser, wherein the third frequency is adjustable by changing a wavelength of light produced by the wavelength-tunable laser; and coherently mix a portion of the Raman signal with at least a portion of the third beam of light to produce an electronic signal; and determine a characteristic of the electronic signal.

Various example aspects directed to another Raman spectroscopy system are described below.

Aspect 1. A system comprising: a first light source configured to produce a first beam of light at a first frequency; a second light source configured to produce a second beam of light at a second frequency, wherein the first and second frequencies are offset by a frequency offset Ω; one or more optical elements configured to: direct the first and second beams of light to a sample; and collect a Raman signal produced by coherent Raman scattering of the first and second beams of light within the sample; an optical receiver configured to detect the Raman signal, the optical receiver comprising: a third light source configured to produce a third beam of light at a third frequency; and an optical detector configured to coherently mix a portion of the Raman signal with at least a portion of the third beam of light to produce an electronic signal, wherein the portion of the Raman signal that is coherently mixed with the third beam of light comprises optical frequency components of the Raman signal within a particular frequency range of the third frequency, wherein the particular frequency range is based on an electronic bandwidth of the detector; and a processor configured to determine a characteristic of the electronic signal.

Aspect 2. The system of aspect 1, wherein the particular frequency range extends from approximately v₃−Δf to approximately v₃+Δf, wherein v₃ is the third frequency, and Δf is the electronic bandwidth of the detector.

Aspect 3. The system of aspect 1, wherein the electronic signal produced by the detector comprises one or more electronic frequency components, each electronic frequency component having a frequency less than or equal to Δf, wherein Δf is the electronic bandwidth of the detector.

Aspect 4. The system of aspect 1, wherein the detector has an electronic bandwidth between approximately 100 megahertz (MHz) and approximately 10 gigahertz (GHz).

Aspect 5. The system of aspect 1, wherein the electronic signal comprises one or more electronic frequency components less than or equal to approximately 10 gigahertz (GHz).

Aspect 6. The system of aspect 1, wherein the detector comprises a PN photodiode, PIN photodiode, avalanche photodiode (APD), single-photon avalanche diode (SPAD), silicon photomultiplier (SiPM), or photomultiplier tube (PMT).

Aspect 7. The system of aspect 1, wherein: the electronic signal comprises a photocurrent signal produced by the detector; and the optical receiver further comprises: an electronic amplifier configured to amplify the photocurrent signal to produce a voltage signal corresponding to the photocurrent signal; and a digitizer configured to produce a digital representation of the voltage signal.

Aspect 8. The system of aspect 7, wherein the processor is configured to determine the characteristic of the electronic signal based on the digital representation of the voltage signal, wherein the characteristic of the electronic signal comprises one or more of: a peak amplitude, an average amplitude, an amplitude at a particular frequency, an amplitude at a particular time, an amplitude at a frequency center, an amplitude at a temporal center, an area, a frequency, a phase, and a polarization.

Aspect 9. The system of aspect 7, wherein the voltage signal is a time-domain signal, and the processor is further configured to determine a Fourier transform of the digital representation of the voltage signal to determine a frequency-domain representation of the voltage signal.

Aspect 10. The system of aspect 1, wherein the processor is further configured to associate a Raman frequency shift with the determined characteristic of the electronic signal, wherein the Raman frequency shift equals v₁−v₃, wherein v₁ is the first frequency, and v₃ is the third frequency.

Aspect 11. The system of aspect 1, wherein the electronic signal comprises a photocurrent signal corresponding to the coherent mixing of the portion of the Raman signal and the third beam of light.

Aspect 12. The system of aspect 1, wherein the electronic signal comprises a coherent-mixing term that is proportional to a product of (i) an amplitude of an electric field of the Raman signal and (ii) an amplitude of an electric field of the third beam of light.

Aspect 13. The system of aspect 12, wherein the coherent-mixing term is proportional to E_{R}·E₃·cos[2πc(ν_{R}−ν₃)t+Δϕ], wherein: E_{R} is the amplitude of the electric field of the Raman signal; E₃ is the amplitude of the electric field of the third beam of light; v_{R} is a frequency of the electric field of the Raman signal; v₃ is a frequency of the electric field of the third beam of light; and Δϕ is a phase difference between the electric field of the Raman signal and the electric field of the third beam of light.

Aspect 14. The system of aspect 1, wherein the first, second, or third light source is a wavelength-tunable light source, wherein the first, second, or third frequency is adjustable over a frequency range corresponding to a wavelength range having a width between approximately 10 nanometers (nm) and approximately 100 nm.

Aspect 15. The system of aspect 1, wherein the second frequency and the third frequency differ by greater than 100 megahertz (MHz) and less than 200 gigahertz (GHz).

Aspect 16. The system of aspect 1, wherein: the third frequency is v₃; the third light source is further configured to change the frequency of the third beam of light by a frequency change ΔF to a frequency v₃+ΔF; the detector is further configured to coherently mix another portion of the Raman signal with at least a portion of the third beam of light at the frequency v₃+ΔF to produce another electronic signal; and the processor is further configured to determine a characteristic of the another electronic signal.

Aspect 17. The system of aspect 1, wherein: the third light source comprises a wavelength-tunable laser, wherein the third light source is further configured to sequentially change the frequency of the third beam of light to a plurality of different frequencies; the detector is further configured to coherently mix another portion of the Raman signal with at least a portion of one of the different frequencies of the third beam of light to produce a corresponding one of a plurality of electronic signals; and the processor is further configured to determine a characteristic of each of the plurality of electronic signals.

Aspect 18. The system of aspect 17, wherein the processor is further configured to determine, based on the determined characteristics of the electronic signals, (i) whether a particular material is present in the sample or (ii) an amount or a concentration of the particular material in the sample.

Aspect 19. The system of aspect 17, wherein each of the different frequencies to which the third light source is changed is offset from an adjacent one of the different frequencies by between approximately 10 megahertz (MHz) and approximately 10 gigahertz (GHz).

Aspect 20. The system of aspect 17, wherein the processor is further configured to determine a Raman spectrum based on the determined characteristics of the electronic signals.

Aspect 21. The system of aspect 20, wherein: the frequency offset Ω is approximately equal to a vibrational frequency of a particular material; and the processor is further configured to determine an amount or a concentration of the particular material in the sample based on the determined Raman spectrum.

Aspect 22. The system of aspect 1, wherein the first light source or the second light source comprises a wavelength-tunable laser, wherein the frequency offset Ω is adjustable by changing a wavelength of the wavelength-tunable laser.

Aspect 23. The system of aspect 1, wherein the frequency offset Ω is between approximately 5 terahertz (THz) and approximately 100 THz.

Aspect 24. The system of aspect 1, wherein the frequency offset C is approximately equal to a vibrational frequency of a particular material.

Aspect 25. The system of aspect 24, wherein the processor is further configured to determine whether the particular material is present in the sample based on the characteristic of the electronic signal.

Aspect 26. The system of aspect 24, wherein the processor is further configured to determine an amount or a concentration of the particular material in the sample based on the characteristic of the electronic signal.

Aspect 27. The system of aspect 1, wherein the Raman signal is an optical signal having a spectral linewidth between approximately 30 gigahertz (GHz) and approximately 300 GHz.

Aspect 28. The system of aspect 1, wherein the Raman signal is an optical signal having a center frequency approximately equal to 2v₁−v₂, wherein v₁ is the first frequency, and v₂ is the second frequency.

Aspect 29. The system of aspect 1, wherein the Raman signal is an optical signal having a center frequency within 200 gigahertz (GHz) of the first frequency or the second frequency.

Aspect 30. The system of aspect 1, wherein: the optical receiver is further configured to detect residual light from the first beam of light after the first beam of light has interacted with the sample, wherein the optical receiver further comprises: a fourth light source configured to produce a fourth beam of light at a fourth frequency, wherein the fourth frequency is within 50 GHz of the first frequency; and an additional optical detector configured to coherently mix at least a portion of the residual light with at least a portion of the fourth beam of light to produce an additional electronic signal; and the processor is further configured to determine a characteristic of the additional electronic signal.

Aspect 31. A method for measuring a Raman signal, the method comprising: producing a first beam of light at a first frequency; producing a second beam of light at a second frequency, wherein the first and second frequencies are offset by a frequency offset Ω; directing the first and second beams of light to a sample; collecting a Raman signal produced by coherent Raman scattering of the first and second beams of light within the sample; detecting the Raman signal, comprising: producing a third beam of light at a third frequency; and coherently mixing, by an optical detector, a portion of the Raman signal with at least a portion of the third beam of light to produce an electronic signal, wherein the portion of the Raman signal that is coherently mixed with the third beam of light comprises optical frequency components of the Raman signal within a particular frequency range of the third frequency, wherein the particular frequency range is based on an electronic bandwidth of the detector; and determining a characteristic of the electronic signal.

Aspect 32. One or more computer-readable non-transitory storage media embodying software that is operable when executed to: produce a first beam of light at a first frequency; produce a second beam of light at a second frequency, wherein the first and second frequencies are offset by a frequency offset Ω; direct the first and second beams of light to a sample; collect a Raman signal produced by coherent Raman scattering of the first and second beams of light within the sample; detect the Raman signal, comprising: produce a third beam of light at a third frequency; and coherently mix, by an optical detector, a portion of the Raman signal with at least a portion of the third beam of light to produce an electronic signal, wherein the portion of the Raman signal that is coherently mixed with the third beam of light comprises optical frequency components of the Raman signal within a particular frequency range of the third frequency, wherein the particular frequency range is based on an electronic bandwidth of the detector; and determine a characteristic of the electronic signal.

Various example aspects directed to another Raman spectroscopy system are described below.

Aspect 1. A system comprising: a first light source configured to produce a first beam of light at a first frequency; a second light source configured to produce a second beam of light at a second frequency, wherein the first and second frequencies are offset by a frequency offset Ω; one or more optical elements configured to: direct the first and second beams of light to a sample; and collect a Raman signal produced by the sample in response to the first and second beams of light; an optical receiver configured to detect the Raman signal, the optical receiver comprising: a third light source configured to produce a third beam of light at a third frequency; and one or more optical detectors, wherein each detector is configured to coherently mix a portion of the Raman signal with at least a portion of the third beam of light to produce an electronic signal; and a processor configured to determine a characteristic of the electronic signal.

Aspect 2. The system of aspect 1, wherein the processor is further configured to determine a phase difference between the Raman signal and the third beam of light.

Aspect 3. The system of aspect 1, wherein the processor is further configured to determine an in-phase portion and a quadrature portion associated with the Raman signal.

Aspect 4. The system of aspect 1, wherein the optical receiver further comprises a 90-degree optical hybrid configured to: combine the Raman signal with the third beam of light to produce four combined beams, the four combined beams comprising two in-phase combined beams and two quadrature combined beams, wherein each combined beam comprises a portion of the Raman signal and a portion of the third beam of light; and direct each of the combined beams to one of four detectors of the optical receiver.

Aspect 5. The system of aspect 4, wherein: prior to combining the Raman signal with the third beam of light, the 90-degree optical hybrid is configured to split the Raman signal or the third beam of light into a first part and a second part; and the 90-degree optical hybrid comprises a phase shifter configured to impart a 90-degree phase change to the first part with respect to the second part. Aspect 6. The system of aspect 4, wherein: the four detectors are each configured to coherently mix the portion of the Raman signal and the portion of the third beam of light to produce one of four electronic signals; and the processor is further configured to determine a phase difference between the Raman signal and the third beam of light.

Aspect 7. The system of aspect 1, wherein the processor is further configured to determine a polarization of the Raman signal.

Aspect 8. The system of aspect 1, wherein the optical receiver further comprises: a Raman-signal polarization beamsplitter configured to split the Raman signal into a horizontal-polarization Raman signal and a vertical-polarization Raman signal; a third-beam polarization beamsplitter configured to split the third beam into a horizontal-polarization third beam and a vertical-polarization third beam; a horizontal-polarization optical receiver comprising one or more of the optical detectors, wherein each detector is configured to coherently mix at least a portion of the horizontal-polarization Raman signal and horizontal-polarization third beam to produce a horizontal-polarization electronic signal; and a vertical-polarization optical receiver comprising another one or more of the optical detectors, wherein each detector is configured to coherently mix at least a portion of the vertical-polarization Raman signal and vertical-polarization third beam to produce a vertical-polarization electronic signal.

Aspect 9. The system of aspect 8, wherein determining the characteristic of the electronic signal comprises determining one or more characteristics of the horizontal-polarization and vertical-polarization electronic signals.

Aspect 10. The system of aspect 9, wherein the processor is further configured to determine a polarization of the Raman signal based on the characteristics of the horizontal-polarization and vertical-polarization electronic signals.

Aspect 11. The system of aspect 8, wherein: the horizontal-polarization optical receiver comprises: four optical detectors; and a first 90-degree optical hybrid configured to: combine the horizontal-polarization Raman signal with the horizontal-polarization third beam to produce four combined horizontal-polarization beams, each combined horizontal-polarization beam comprising a portion of the horizontal-polarization Raman signal and a portion of the horizontal-polarization third beam; and direct each of the combined horizontal-polarization beams to one of the four detectors; and the vertical-polarization optical receiver comprises: another four optical detectors; and a second 90-degree optical hybrid configured to: combine the vertical-polarization Raman signal with the vertical-polarization third beam to produce four combined vertical-polarization beams, each combined vertical-polarization beam comprising a portion of the vertical-polarization Raman signal and a portion of the vertical-polarization third beam; and direct each of the combined vertical-polarization beams to one of the another four optical detectors.

Aspect 12. The system of aspect 11, wherein: the four detectors of the horizontal-polarization optical receiver are each configured to coherently mix the portion of the horizontal-polarization Raman signal and the portion of the horizontal-polarization third beam to produce one of four horizontal-polarization electronic signals; the four detectors of the vertical-polarization optical receiver are each configured to coherently mix the portion of the vertical-polarization Raman signal and the portion of the vertical-polarization third beam to produce one of four vertical-polarization electronic signals; and based on the four horizontal-polarization electronic signals and the four vertical-polarization electronic signals, the processor is further configured to determine (i) a polarization of the Raman signal and (ii) a phase difference between the Raman signal and the third beam of light.

Aspect 13. The system of aspect 1, wherein the optical elements comprise an optical combiner configured to combine the first and second beams of light to produce a combined beam that is directed to the sample.

Aspect 14. The system of aspect 13, wherein the optical combiner is part of a photonic integrated circuit (PIC), wherein the first and second beams of light are combined into an optical waveguide of the PIC.

Aspect 15. The system of aspect 13, wherein the optical combiner is a fiber-optic combiner, wherein the first and second beams of light are combined into an optical fiber.

Aspect 16. The system of aspect 1, wherein the optical receiver further comprises an optical combiner configured to combine the Raman signal and the third beam of light to produce one or more combined beams that are each directed to one of the optical detectors.

Aspect 17. The system of aspect 16, wherein the optical combiner is part of a photonic integrated circuit (PIC), wherein the portion of the Raman signal and the portion of the third beam of light are combined into an optical waveguide of the PIC.

Aspect 18. The system of aspect 16, wherein the optical combiner is a fiber-optic combiner, wherein the portion of the Raman signal and the portion of the third beam of light are combined into an optical fiber.

Aspect 19. The system of aspect 1, wherein the optical elements comprise a photonic integrated circuit (PIC) comprising one or more optical waveguides, wherein: one or more optical waveguides are configured to direct the first and second beams of light to the sample; and one or more other optical waveguides are configured to direct the Raman signal and the third beam of light to the one or more of the detectors.

Aspect 20. The system of aspect 1, wherein the first, second, or third light source is a wavelength-tunable light source, wherein the first, second, or third frequency is adjustable over a frequency range corresponding to a wavelength range having a width between approximately 10 nanometers (nm) and approximately 100 nm.

Aspect 21. The system of aspect 1, wherein the frequency offset Ω is between approximately 5 terahertz (THz) and approximately 100 THz.

Aspect 22. The system of aspect 1, wherein: the frequency offset Ω is approximately equal to a vibrational frequency of a particular material; and the processor is further configured to determine, based on the characteristic of the electronic signal, (i) whether the particular material is present in the sample or (ii) an amount or a concentration of the particular material in the sample.

Aspect 23. The system of aspect 1, wherein: the electronic signal comprises a photocurrent signal produced by the detector; and the optical receiver further comprises: an electronic amplifier configured to amplify the photocurrent signal to produce a voltage signal corresponding to the photocurrent signal; and a digitizer configured to produce a digital representation of the voltage signal.

Aspect 24. The system of aspect 23, wherein the processor is configured to determine the characteristic of the electronic signal based on the digital representation of the voltage signal, wherein the characteristic of the electronic signal comprises one or more of: a peak amplitude, an average amplitude, an amplitude at a particular frequency, an amplitude at a particular time, an amplitude at a frequency center, an amplitude at a temporal center, an area, a frequency, a phase, and a polarization.

Aspect 25. The system of aspect 1, wherein each detector has an electronic bandwidth of approximately Δf, and the electronic signal produced by each detector comprises one or more electronic frequency components, each electronic frequency component having a frequency less than or equal to Δf.

Aspect 26. The system of aspect 1, wherein the one or more detectors comprise a PN photodiode, PIN photodiode, avalanche photodiode (APD), single-photon avalanche diode (SPAD), silicon photomultiplier (SiPM), or photomultiplier tube (PMT).

Aspect 27. A method for measuring a Raman signal, the method comprising: producing a first beam of light at a first frequency; producing a second beam of light at a second frequency, wherein the first and second frequencies are offset by a frequency offset Ω; directing the first and second beams of light to a sample; collecting a Raman signal produced by the sample in response to the first and second beams of light; detecting the Raman signal, comprising: producing a third beam of light at a third frequency; and coherently mixing a portion of the Raman signal with at least a portion of the third beam of light to produce an electronic signal; and determining a characteristic of the electronic signal.

Aspect 28. One or more computer-readable non-transitory storage media embodying software that is operable when executed to: produce a first beam of light at a first frequency; produce a second beam of light at a second frequency, wherein the first and second frequencies are offset by a frequency offset Ω; direct the first and second beams of light to a sample; collect a Raman signal produced by the sample in response to the first and second beams of light; detect the Raman signal, comprising: produce a third beam of light at a third frequency; and coherently mix a portion of the Raman signal with at least a portion of the third beam of light to produce an electronic signal; and determine a characteristic of the electronic signal.

Various example aspects directed to another Raman spectroscopy system are described below.

Aspect 1. A system comprising: a pump light source configured to produce a pump beam of light at a pump frequency; one or more optical elements configured to: direct the pump beam to a sample; and collect a Raman signal produced by the sample in response to the pump beam, wherein the Raman signal is produced by spontaneous Raman scattering of the pump beam within the sample; an optical receiver configured to detect the Raman signal, the optical receiver comprising: a probe light source configured to produce a probe beam of light at a probe frequency; and one or more optical detectors, wherein each detector is configured to coherently mix a portion of the Raman signal with at least a portion of the probe beam of light to produce an electronic signal; and a processor configured to determine a characteristic of the electronic signal.

Aspect 2. The system of aspect 1, wherein the probe light source comprises a wavelength-tunable laser configured to tune the probe frequency of the probe beam of light to a plurality of frequencies across at least a portion of the Raman signal.

FIG. 59 illustrates an example computer system 5900. One or more computer systems 5900 may perform one or more steps of one or more methods described or illustrated herein. One or more computer systems 5900 may provide functionality described or illustrated herein. Software running on one or more computer systems 5900 may perform one or more steps of one or more methods described or illustrated herein or may provide functionality described or illustrated herein. A computer system 5900 may include or may be referred to as a processor, a controller, a computing device, a computing system, a computer, or a data-processing apparatus. Herein, reference to a computer system may encompass one or more computer systems, where appropriate.

Computer system 5900 may take any suitable physical form. As an example, computer system 5900 may be an embedded computer system, a system-on-chip (SOC), an application-specific integrated circuit (ASIC), a field-programmable gate array (FPGA), a single-board computer system (SBC), a desktop computer system, a laptop or notebook computer system, a graphics processing unit (GPU), a mainframe, a mesh of computer systems, a server, a tablet computer system, or any suitable combination of two or more of these. As another example, all or part of computer system 5900 may be combined with, coupled to, or integrated into a variety of devices, including, but not limited to, a medical device, wearable device, camera, camcorder, personal digital assistant (PDA), mobile telephone, smartphone, electronic reading device (e.g., an e-reader), game console, smart watch, clock, calculator, television monitor, flat-panel display, computer monitor, eyewear, or head-mounted display. Where appropriate, computer system 5900 may include one or more computer systems 5900; be unitary or distributed; span multiple locations; span multiple machines; span multiple data centers; or reside in a cloud, which may include one or more cloud components in one or more networks. Where appropriate, one or more computer systems 5900 may perform without substantial spatial or temporal limitation one or more steps of one or more methods described or illustrated herein. As an example, one or more computer systems 5900 may perform in real time or in batch mode one or more steps of one or more methods described or illustrated herein. One or more computer systems 5900 may perform at different times or at different locations one or more steps of one or more methods described or illustrated herein, where appropriate.

As illustrated in the example of FIG. 59, computer system 5900 may include a processor 5910, memory 5920, storage 5930, an input/output (I/O) interface 5940, a communication interface 5950, or a bus 5960. Computer system 5900 may include any suitable number of any suitable components in any suitable arrangement.

Processor 5910 may include hardware for executing instructions, such as those making up a computer program. As an example, to execute instructions, processor 5910 may retrieve (or fetch) the instructions from an internal register, an internal cache, memory 5920, or storage 5930; decode and execute them; and then write one or more results to an internal register, an internal cache, memory 5920, or storage 5930. A processor 5910 may include one or more internal caches for data, instructions, or addresses. A processor 5910 may include one or more internal registers for data, instructions, or addresses. Processor 5910 may include any suitable number of any suitable internal registers, where appropriate. Where appropriate, processor 5910 may include one or more arithmetic logic units (ALUs); may be a multi-core processor; or may include one or more processors 5910.

Memory 5920 may include main memory for storing instructions for processor 5910 to execute or data for processor 5910 to operate on. As an example, computer system 5900 may load instructions from storage 5930 or another source (such as, for example, another computer system 5900) to memory 5920. Processor 5910 may then load the instructions from memory 5920 to an internal register or internal cache. To execute the instructions, processor 5910 may retrieve the instructions from the internal register or internal cache and decode them. During or after execution of the instructions, processor 5910 may write one or more results (which may be intermediate or final results) to the internal register or internal cache. Processor 5910 may then write one or more of those results to memory 5920. One or more memory buses (which may each include an address bus and a data bus) may couple processor 5910 to memory 5920. Bus 5960 may include one or more memory buses. Memory 5920 may include random access memory (RAM). This RAM may be volatile memory, where appropriate. Where appropriate, this RAM may be dynamic RAM (DRAM) or static RAM (SRAM). Memory 5920 may include one or more memories 5920, where appropriate.

Storage 5930 may include mass storage for data or instructions. As an example, storage 5930 may include a hard disk drive (HDD), a floppy disk drive, flash memory, an optical disc, a magneto-optical disc, magnetic tape, or a Universal Serial Bus (USB) drive or a combination of two or more of these. Storage 5930 may include removable or non-removable (or fixed) media, where appropriate. Storage 5930 may be internal or external to computer system 5900, where appropriate. Storage 5930 may be non-volatile, solid-state memory. Storage 5930 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 5930 may include one or more storage control units facilitating communication between processor 5910 and storage 5930, where appropriate. Where appropriate, storage 5930 may include one or more storages 5930.

I/O interface 5940 may include hardware, software, or both, providing one or more interfaces for communication between computer system 5900 and one or more I/O devices. Computer system 5900 may include one or more of these I/O devices, where appropriate. One or more of these I/O devices may enable communication between a person and computer system 5900. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 5940 may include one or more device or software drivers enabling processor 5910 to drive one or more of these I/O devices. I/O interface 5940 may include one or more I/O interfaces 5940, where appropriate.

Communication interface 5950 may include hardware, software, or both providing one or more interfaces for communication (such as, for example, packet-based communication) between computer system 5900 and one or more other computer systems 5900 or one or more networks. As an example, communication interface 5950 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 5900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 5900 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 5900 may communicate using fiber-optic communication based on 100 Gigabit Ethernet (100 GbE), 10 Gigabit Ethernet (10 GbE), or Synchronous Optical Networking (SONET). Computer system 5900 may include any suitable communication interface 5950 for any of these networks, where appropriate. Communication interface 5950 may include one or more communication interfaces 5950, where appropriate.

Bus 5960 may include hardware, software, or both coupling components of computer system 5900 to each other. As an example, bus 5960 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 5960 may include one or more buses 5960, where appropriate.

Various modules, circuits, systems, methods, or algorithm steps described in connection with the implementations disclosed herein may be implemented as electronic hardware, computer software, or any suitable combination of hardware and software. Computer software (which may be referred to as software, computer-executable code, computer code, a computer program, computer instructions, or instructions) may be used to perform various functions described or illustrated herein, and computer software may be configured to be executed by or to control the operation of computer system 5900. As an example, computer software may include instructions configured to be executed by processor 5910. Owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

A computing device may be used to implement various modules, circuits, systems, methods, or algorithm steps disclosed herein. As an example, all or part of a module, circuit, system, method, or algorithm disclosed herein may be implemented or performed by a general-purpose single- or multi-chip processor, a digital signal processor (DSP), an ASIC, a FPGA, a GPU, any other suitable programmable-logic device, discrete gate or transistor logic, discrete hardware components, or any suitable combination thereof. A general-purpose processor may be a microprocessor, or, any conventional processor, controller, microcontroller, GPU, or state machine. A processor may also be implemented as a combination of computing devices, e.g., a combination of a DSP and a microprocessor, a plurality of microprocessors, one or more microprocessors in conjunction with a DSP core, or any other such configuration.

One or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. A computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), Blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layout of the devices illustrated.

One or more of the figures described herein may include example data that is prophetic. For example, the graphs illustrated FIGS. 3-16, 19, and 47-53 may include or may be referred to as prophetic examples.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B, or C” means at least one of the following: A; B; C; A and B; A and C; B and C; A, B, and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, 1%, 2%, 3%, 4%, 5%, 10%, 12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 104 s, 103 s, 10² s, 10 s, 1 s, 100 ms, 10 ms, 1 ms, 100 μs, 10 μs, or 1 μs. The term “substantially constant” may be applied to any suitable value, such as for example, an optical power, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Various example aspects included in this disclosure may be presented in a range format. It should be understood that a description in range format is merely for convenience and brevity and should not be construed as an inflexible limitation on the scope of a disclosed aspect. Accordingly, the description of a range should be considered to have specifically disclosed all suitable sub-ranges as well as individual numerical values within that range, unless expressly indicated otherwise or indicated otherwise by context. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual values within that range, for example, 1.1, 2, 2.3, 5, and 5.9.

Although the foregoing embodiments have been described in some detail for purposes of clarity of understanding, the invention is not limited to the details provided. There may be numerous alternative ways of implementing the invention. The disclosed embodiments are illustrative and not restrictive.

1. A system comprising:
a pump light source configured to produce a pump beam of light at a pump frequency;
a Stokes light source configured to produce:
a Stokes beam of light at a Stokes frequency, wherein the pump and Stokes frequencies are offset by a frequency offset Ω; and
a Stokes reference beam of light;
one or more optical elements configured to:
direct the pump and Stokes beams of light to a sample; and
collect (i) a Raman signal produced by the sample in response to the pump and Stokes beams of light and (ii) residual light from the Stokes beam of light after the Stokes beam of light has interacted with the sample;
an optical receiver configured to detect the Raman signal, the optical receiver comprising:
a probe light source configured to produce:
a probe beam of light at a probe frequency; and
a probe reference beam of light;
a signal detector configured produce a signal photocurrent corresponding to the Raman signal, the probe beam of light, and the residual Stokes beam of light, wherein a portion of the signal photocurrent corresponds to coherent mixing between the Raman signal and the probe beam of light;
a reference detector configured to produce a reference photocurrent corresponding to the probe reference beam of light and the Stokes reference beam of light; and
a subtraction module configured to determine a subtraction signal that equals a difference between a signal corresponding to the signal photocurrent and a signal corresponding to the reference photocurrent; and
a processor configured to determine a characteristic of the subtraction signal.

2. The system of claim 1, wherein:
the processor is further configured to perform an amplitude calibration to balance the signal and reference detectors, the amplitude calibration comprising sending an instruction to turn off or block the pump beam of light so that little or no light from the pump light source reaches the sample;
the signal detector is further configured to produce a signal calibration photocurrent corresponding to the probe beam of light and the residual Stokes beam of light;
the reference detector is further configured to produce a reference calibration photocurrent corresponding to the probe reference beam of light and the Stokes reference beam of light; and
the processor is further configured to balance the signal and reference detectors by adjusting a gain associated with the signal detector or a gain associated with the reference detector based on the signal and reference calibration photocurrents.

3. The system of claim 2, wherein the gain associated with the signal detector or the reference detector is adjusted to produce a subtraction calibration signal having an amplitude of less than 10% of an amplitude of a signal corresponding to the signal calibration photocurrent or a signal corresponding to the reference calibration photocurrent, wherein the subtraction calibration signal equals a difference between the signal corresponding to the signal calibration photocurrent and the signal corresponding to the reference calibration photocurrent.

4. The system of claim 2, wherein the signal or reference detector comprises an avalanche photodiode (APD), and adjusting the gain associated with the signal or reference detector comprises adjusting a reverse-bias voltage applied to the APD.

5. The system of claim 2, wherein:
the optical receiver further comprises an electronic amplifier configured to produce a voltage signal corresponding to the signal calibration photocurrent or the reference calibration photocurrent; and
adjusting the gain associated with the signal or reference detector comprises adjusting a gain of the electronic amplifier.

6. The system of claim 2, wherein:
the processor is further configured to receive a digitized signal corresponding to the signal photocurrent and a digitized signal corresponding to the reference photocurrent; and
adjusting the gain associated with the signal or reference detector comprises setting a value of a calibration factor that is applied to one of the digitized signals.

7. The system of claim 2, wherein:
the system further comprises a variable optical attenuator (VOA) configured to change an optical power of the probe reference beam of light or the Stokes reference beam of light; and
adjusting the gain associated with the signal or reference detector comprises using the VOA to change the optical power of the probe or Stokes reference beam of light.

8. The system of claim 1, wherein:
the processor is further configured to perform an amplitude calibration to balance the signal and reference detectors, the amplitude calibration comprising:
sending an instruction to turn off or block the pump beam of light so that little or no light from the pump light source reaches the sample; and
sending an instruction to turn off or block light from the probe light source so that little or no light from the probe beam of light reaches the signal detector and little or no light from the probe reference beam of light reaches the reference detector;
the signal detector is further configured to produce a signal calibration photocurrent corresponding to the residual Stokes beam of light;
the reference detector is further configured to produce a reference calibration photocurrent corresponding to the Stokes reference beam of light; and
the processor is further configured to balance the signal and reference detectors by adjusting a gain associated with the signal detector or a gain associated with the reference detector based on the signal and reference calibration photocurrents.

9. The system of claim 1, wherein:
the processor is further configured to perform a temporal calibration to adjust a time delay between the Stokes beam of light and the Stokes reference beam of light, the temporal calibration comprising instructing the Stokes light source to produce a transient optical signal so that the Stokes beam of light and the Stokes reference beam of light each includes a portion of the transient optical signal;
the signal detector is further configured to produce a signal calibration photocurrent corresponding to the transient optical signal;
the reference detector is further configured to produce a reference calibration photocurrent corresponding to the transient optical signal; and
the processor is further configured to determine a temporal offset between the Stokes beam of light and the Stokes reference beam of light to minimize a time delay between the Stokes beam of light and the Stokes reference beam of light.

10. The system of claim 9, wherein the temporal offset is configured to produce a time delay between the Stokes beam of light and the Stokes reference beam of light that is less than 10% of 1/Δf, wherein Δf is an electronic bandwidth of the signal detector or the reference detector.

11. The system of claim 9, wherein the temporal offset is configured to produce a time delay between the Stokes beam of light and the Stokes reference beam of light that is less than 4Δt, wherein Δt is a time interval between successive samples of a digitizer configured to produce a digital representation of a signal produced by the optical receiver.

12. The system of claim 9, wherein the time delay represents a difference between (i) a time for the Stokes beam of light to travel from the Stokes light source to the signal detector and (ii) a time for the Stokes reference beam of light to travel from the Stokes light source to the reference detector.

13. The system of claim 9, wherein the processor is further configured to send an instruction to an optical-path-length adjuster to change an optical path length of the Stokes beam of light or the Stokes reference beam of light in accordance with the determined temporal offset.

14. The system of claim 9, wherein the processor is further configured to apply the temporal offset to a subsequently received digital signal corresponding to a signal photocurrent or a reference photocurrent prior to determining a subtraction signal.

15. The system of claim 9, wherein the transient optical signal comprises a pulse of light or a step-change in a power of light produced by the Stokes light source.

16. The system of claim 1, wherein:
the processor is further configured to perform a temporal calibration to adjust a time delay between the probe beam of light and the probe reference beam of light, the temporal calibration comprising instructing the probe light source to produce a transient optical signal so that the probe beam of light and the probe reference beam of light each includes a portion of the transient optical signal;
the signal detector is further configured to produce a signal calibration photocurrent corresponding to the transient optical signal;
the reference detector is further configured to produce a reference calibration photocurrent corresponding to the transient optical signal; and
the processor is further configured to determine a temporal offset between the probe beam of light and the probe reference beam of light to minimize a time delay between the probe beam of light and the probe reference beam of light.

17. The system of claim 1, wherein:
the optical receiver further comprises:
a signal-photocurrent amplifier configured to produce a signal-voltage output (V_{sig}) corresponding to the signal photocurrent;
a reference-photocurrent amplifier configured to produce a reference-voltage output (V_{ref}) corresponding to the reference photocurrent; and
the subtraction module is configured to subtract the reference-voltage output from the signal-voltage output to produce the subtraction signal, wherein the subtraction signal is proportional to V_{sig}−V_{ref}.

18. The system of claim 17, wherein the optical receiver further comprises a digitizer configured to produce a digital representation of the subtraction signal, wherein the digital representation of the subtraction signal is sent to the processor.

19. The system of claim 18, wherein the processor is configured to determine the characteristic of the subtraction signal based on the digital representation of the subtraction signal, wherein the characteristic of the subtraction signal comprises one or more of: a peak amplitude, an average amplitude, an amplitude at a particular frequency, an amplitude at a particular time, an amplitude at a frequency center, an amplitude at a temporal center, a DC offset, an area, a frequency, a phase, and a polarization.

20. The system of claim 1, wherein the optical receiver further comprises:
a signal-photocurrent amplifier configured to produce a signal-voltage output corresponding to the signal photocurrent;
a signal digitizer configured to produce a digital representation of the signal-voltage output;
a reference-photocurrent amplifier configured to produce a reference-voltage output corresponding to the reference photocurrent; and
a reference digitizer configured to produce a digital representation of the reference-voltage output.

21. The system of claim 20, wherein the subtraction module is part of the processor, wherein the processor determines the subtraction signal from the digital representations of the signal-voltage output and the reference-voltage output.

22. The system of claim 1, wherein the signal detector and the reference detector each comprises an avalanche photodiode (APD), a PN photodiode, or a PIN photodiode.

23. The system of claim 1, wherein:
the signal and reference detectors are part of a horizontal-polarization optical receiver, and the subtraction signal is a horizontal-polarization subtraction signal;
the optical receiver further comprises a vertical-polarization optical receiver configured to produce a vertical-polarization subtraction signal; and
the processor is further configured to determine a polarization of the Raman signal based on the horizontal-polarization and vertical-polarization subtraction signals.

24. The system of claim 1, wherein:
the optical receiver further comprises a 90-degree optical hybrid; and
the processor is further configured to determine an in-phase portion and a quadrature portion associated with the Raman signal.

25. The system of claim 1, wherein the Stokes light source comprises:
a light source configured to produce a primary beam of light; and
an optical splitter configured to split off a portion of the beam of light to produce the Stokes reference beam of light.

26. The system of claim 1, wherein the Stokes light source comprises a laser diode comprising a front facet and a back facet, wherein the Stokes reference beam of light is emitted from the back facet.

27. The system of claim 1, wherein the probe light source comprises a wavelength-tunable laser, wherein the probe frequency is adjustable by changing a wavelength of light produced by the wavelength-tunable laser.

28. The system of claim 1, wherein the pump light source or the Stokes light source comprises a wavelength-tunable laser, wherein the frequency offset Ω is adjustable by changing a wavelength of the wavelength-tunable laser.

29. The system of claim 1, wherein the processor is further configured to associate a Raman frequency shift with the determined characteristic of the subtraction signal, wherein the Raman frequency shift equals vₚᵤ−vₚᵣ, wherein vₚᵤ is the pump frequency, and vₚᵣ is the probe frequency.

30. The system of claim 1, wherein:
the frequency offset Ω is approximately equal to a vibrational frequency of a particular material; and
the processor is further configured to determine, based on the characteristic of the subtraction signal, (i) whether the particular material is present in the sample or (ii) an amount or a concentration of the particular material in the sample.

31. The system of claim 1, wherein the portion of the signal photocurrent corresponding to coherent mixing between the Raman signal and the probe beam of light results from coherent mixing of a portion of the Raman signal with at least a portion of the probe beam of light, wherein the portion of the Raman signal that is coherently mixed with the probe beam of light comprises optical frequency components of the Raman signal within a particular frequency range of the probe frequency, wherein the particular frequency range is based on an electronic bandwidth of the signal detector.

32. The system of claim 31, wherein the particular frequency range extends from approximately vₚᵣ−Δf to approximately vₚᵣ+Δf, wherein vₚᵣ is the probe frequency, and Δf is the electronic bandwidth of the signal detector.

33. The system of claim 1, wherein the characteristic of the subtraction signal comprises one or more of: a peak amplitude, an average amplitude, an amplitude at a particular frequency, an amplitude at a particular time, an amplitude at a frequency center, a DC offset, an amplitude at a temporal center, an area, a frequency, a phase, and a polarization.

34. The system of claim 1, wherein the Raman signal is an optical signal having a center frequency within 200 gigahertz (GHz) of the Stokes frequency.

35. The system of aspect 1, wherein the Raman signal is produced by coherent Raman scattering of the first and second beams of light within the sample.

36. The system of claim 1, wherein:
the probe frequency is vₚᵣ;
the probe light source is further configured to change the probe frequency by a frequency change ΔF to a frequency vₚᵣ+ΔF;
the signal detector is further configured to produce another signal photocurrent, wherein a portion of the another signal photocurrent corresponds to coherent mixing between the Raman signal and the probe beam of light at the frequency vₚᵣ+ΔF;
the reference detector is further configured to produce another reference photocurrent;
the subtraction module is further configured to determine another subtraction signal that equals a difference between a signal corresponding to the another signal photocurrent and a signal corresponding to the another reference photocurrent; and
the processor is further configured to determine a characteristic of the another subtraction signal.

37. A method for measuring a Raman signal, the method comprising:
producing, by a pump light source, a pump beam of light at a pump frequency;
producing, by a Stokes light source:
a Stokes beam of light at a Stokes frequency, wherein the pump and Stokes frequencies are offset by a frequency offset Ω; and
a Stokes reference beam of light;
directing the pump and Stokes beams of light to a sample;
collecting (i) a Raman signal produced by the sample in response to the pump and Stokes beams of light and (ii) residual light from the Stokes beam of light after the Stokes beam of light has interacted with the sample;
detecting the Raman signal, comprising:
producing, by a probe light source:
a probe beam of light at a probe frequency; and
a probe reference beam of light;
producing, by a signal detector, a signal photocurrent corresponding to the Raman signal, the probe beam of light, and the residual Stokes beam of light, wherein a portion of the signal photocurrent corresponds to coherent mixing between the Raman signal and the probe beam of light;
producing, by a reference detector, a reference photocurrent corresponding to the probe reference beam of light and the Stokes reference beam of light; and
determining, by a subtraction module, a subtraction signal that equals a difference between a signal corresponding to the signal photocurrent and a signal corresponding to the reference photocurrent; and
determining, by a processor, a characteristic of the subtraction signal.

38. The method of claim 37, further comprising performing an amplitude calibration to balance the signal and reference detectors, comprising:
sending, by the processor, an instruction to turn off or block the pump beam of light so that little or no light from the pump light source reaches the sample;
producing, by the signal detector, a signal calibration photocurrent corresponding to the probe beam of light and the residual Stokes beam of light;
producing, by the reference detector, a reference calibration photocurrent corresponding to the probe reference beam of light and the Stokes reference beam of light; and
balancing, by the processor, the signal and reference detectors by adjusting a gain associated with the signal detector or a gain associated with the reference detector based on the signal and reference calibration photocurrents.

39. The method of claim 37, further comprising performing a temporal calibration to adjust a time delay between the Stokes beam of light and the Stokes reference beam of light, comprising:
instructing, by the processor, the Stokes light source to produce a transient optical signal so that the Stokes beam of light and the Stokes reference beam of light each includes a portion of the transient optical signal;
producing, by the signal detector, a signal calibration photocurrent corresponding to the transient optical signal;
producing, by the reference detector, a reference calibration photocurrent corresponding to the transient optical signal; and
determining, by the processor, a temporal offset between the Stokes beam of light and the Stokes reference beam of light to minimize a time delay between the Stokes beam of light and the Stokes reference beam of light.

40. One or more computer-readable non-transitory storage media embodying software that is operable when executed to:
produce a pump beam of light at a pump frequency;
produce (i) a Stokes beam of light at a Stokes frequency, wherein the pump and Stokes frequencies are offset by a frequency offset Ω and (ii) a Stokes reference beam of light;
direct the pump and Stokes beams of light to a sample;
collect (i) a Raman signal produced by the sample in response to the pump and Stokes beams of light and (ii) residual light from the Stokes beam of light after the Stokes beam of light has interacted with the sample;
detect the Raman signal, comprising:
produce (i) a probe beam of light at a probe frequency and (ii) a probe reference beam of light;
produce a signal photocurrent corresponding to the Raman signal, the probe beam of light, and the residual Stokes beam of light, wherein a portion of the signal photocurrent corresponds to coherent mixing between the Raman signal and the probe beam of light;
produce a reference photocurrent corresponding to the probe reference beam of light and the Stokes reference beam of light; and
determine a subtraction signal that equals a difference between a signal corresponding to the signal photocurrent and a signal corresponding to the reference photocurrent; and
determine a characteristic of the subtraction signal.

41. A system comprising:
a pump light source configured to produce a pump beam of light at a pump frequency;
a Stokes light source configured to produce:
a Stokes beam of light at a Stokes frequency, wherein the pump and Stokes frequencies are offset by a frequency offset Ω; and
a Stokes reference beam of light;
one or more optical elements configured to:
direct the pump and Stokes beams of light to a sample; and
collect (i) a Raman signal produced by the sample in response to the pump and Stokes beams of light and (ii) residual light from the Stokes beam of light after the Stokes beam of light has interacted with the sample;
an optical receiver configured to detect the Raman signal, the optical receiver comprising:
a probe light source configured to produce:
a probe beam of light at a probe frequency; and
a probe reference beam of light;
a signal-detection channel comprising:
a signal detector configured produce a signal photocurrent corresponding to the Raman signal, the probe beam of light, and the residual Stokes beam of light;
a signal-photocurrent amplifier configured to produce a signal-voltage output corresponding to the signal photocurrent; and
a signal digitizer configured to produce a digital representation of the signal-voltage output; and
a reference-detection channel comprising:
a reference detector configured to produce a reference photocurrent corresponding to the probe reference beam of light and the Stokes reference beam of light;
a reference-photocurrent amplifier configured to produce a reference-voltage output corresponding to the reference photocurrent; and
a reference digitizer configured to produce a digital representation of the reference-voltage output; and
a processor configured to:
determine a subtraction signal corresponding to a difference between a signal corresponding to the digital representation of the signal-voltage output and a signal corresponding to the digital representation of the reference-voltage output; and
determine a characteristic of the subtraction signal.
